(19) United States
(12) Patent Application Publication
(10) Pub. No.: US 2020/0100442 A1
(43) Pub. Date: Apr. 2, 2020

(54) SCALABLE, BIOREGENERATIVE CROP AND ENERGY PRODUCTION SYSTEM FOR TERRESTRIAL AND NON-TERRESTRIAL USE

(71) Applicant: Jeffrey Lee Raymond, White Salmon, WA (US)

(72) Inventor: Jeffrey Lee Raymond, White Salmon, WA (US)

(21) Appl. No.: 16/445,528

(22) Filed: Jun. 19, 2019

Related U.S. Application Data
(60) Provisional application No. 62/688,450, filed on Jun. 22, 2018.

(51) Int. Cl. A01G 31/02; A01G 33/00; A01K 63/04; A01K 63/06; A01M 31/00; C02F 3/00; C02F 3/32; C12P 5/02

(52) U.S. Cl. CPC A01G 31/02; A01G 33/00; A01K 63/045; A01K 63/047; A01K 63/065; A01G 2031/006; A01M 31/002; C02F 3/006; C02F 3/327; C12P 5/023; A01K 63/042

(57) ABSTRACT

A method and system for self-contained growth and harvesting of plant and animal foodstuffs and energy generation for terrestrial and non-terrestrial uses. The system can be self-contained and sealed from an ambient atmosphere wherein sufficient oxygen and carbon dioxide levels are maintained (bio-regenerative) to support human life. The system and method may utilize aquaculture and hydroponic plant growth with a digester for converting waste into nutrients. Water may circulate among the digester, aquaculture tanks and hydroponic growth tanks. The method may be scalable to support varying quantities of human life. The system and method may generate energy and consume greater quantities of carbon dioxide than generated. The system may be energy self-sufficient utilizing solar, wind or other energy sources such as generated methane gas.

### RELATED APPLICATION

This provisional application claims priority to and herein incorporates by reference in its entirety the application entitled “Provisional Patent Application by Jeffrey Lee Raymond for Scalable, Bioregenerative Crop and Energy Production System for Terrestrial and Non-Terrestrial Use” filed Jun. 19, 2018, application No. 62/688,450.

### FIELD OF USE

This disclosure pertains to an essentially self-contained plant growth system which also generates its own power. The system utilizes waste produced by animals contained within the system as plant nutrients. The plants are grown in a hydroponic system wherein nutrient enriched water is circulated among the plant roots. The plant root systems may be suspended in the water, supported by inert material such as perlite, vermiculite, or lava rock, or the roots may be hanging freely and sprayed with nutrient solution.

### RELATED TECHNOLOGY

The system may utilize aquaponic plant growth systems. Note containerized growth systems have been suggested. However, none has incorporated containerization of growth of animal protein. Also, none has provided the range of species or types of plants grown, thereby improving achievable diet. Also, there is no system that incorporates energy generation to achieve “off the grid” operation or waste recycling.

It will appreciated that prior art has demonstrated containerized growth systems. However, such systems have grown only limited varieties of plant food and no animal protein. Further such prior art systems have not contained any capability for power generation. Therefore, such systems have required connection to commercial electrical power grids. Monthly power costs of such prior art systems are approximately over 16,000 kwhr per month. The applicant's disclosure may be power self-sufficient. The prior art also does not provide any mechanism for waste recycling.

### BRIEF SUMMARY OF DISCLOSURE

This disclosure pertains to an energy production and plant and animal growing system wherein animals of differing species may be bred and harvested for food and the system is combined with growing plants, also of differing species, utilizing the animal wastes as a plant nutrient source. The plants may also be used as a source of oxygen (hereinafter “O₂”) wherein carbon dioxide (hereinafter “CO₂”) produced by the living animals, the humans operating the system, or from outside the system is converted to O₂ by photosynthesis. The plants (as well as the animals) may be harvested for food. Plant waste produced from harvesting of plant growth may also be composted and used as a nutrient source. Further, plants may be used as a food source.

The system allows for portions of the animals and plants grown within the system to be harvested for food for human consumption. The size of the system may be matched to produce food from the plants and animal population to feed a specified number of humans.

The system may be a closed system wherein the animal and plant components produce both adequate food and O₂ to support a specified number of humans without input of additional nutrients, food stuffs or oxygen as well as consume the necessary amount of CO2 to support the specified number of humans.

In other systems, the plants positioned in the grow tanks (discussed below) consume the CO₂ produced by the animals in the aquaculture tanks and generate O₂ that may be dissolved in circulating water and consumed by the animals or human operators.

The size of the aquaculture tanks, supporting the animal organisms, e.g., aquaculture, and animal food source, e.g., duck weed, may be sized in a relationship to the size of the hydroponic tank(s) in which plant food is grown. As stated above, the plants utilize composted/processed aquaculture waste as a nutrient source. The aquaculture is also a source of CO₂ which is utilized by the plants to in photosynthesis to produce O₂. This O₂ (dissolved in the circulating water) is utilized by the aquaculture.

As stated, the system can be sized to create a system operating in equilibrium between production of plant nutrients and O₂. The system also can comprise sensors controlling components that may be employed to maintain the equilibrium, e.g., addition of buffers to maintain proper pH, pump flow controls to maintain adequate water circulation, supplemental aerators to maintain adequate O₂ levels, water intake and outflow components to maintain required water levels, etc.

The system subject of this disclosure is also scalable, i.e., multiple systems may be combined to increase the quantity of aquaculture produced (and available for harvesting) and plant production (also available for harvesting for consumption). Alternatively, the size of the aquaculture tanks and hydroponic tanks may each be increased wherein a size ratio is maintained. It will be appreciated that the size ratio may be conducive to maintaining system equilibrium.

### BRIEF DESCRIPTION OF THE DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 System Use Cases summarizing aspects of the disclosure that are detailed in the below listed figures.

FIGS. 2A, 2B, 2C, 2D illustrate the System Hierarchy Overview. Illustrated is an embodiment consisting of a 02_Food Growing System, 03_Organic Waste Recycling System, 04_Pest Management System, 05_Environmental Control System, 06_Automated Monitoring and Control System, a 07_Facilities and Security System, and a 08_Power Generation System.

FIGS. 3A, 3B illustrate the system overview utilizing the following external resources to operate: External Organic Waste (optional), Plant Seeds (for initial setup), Solar Radiation, Water Supply, and a Wind Supply. Illustrated are both system inputs and system outputs. Illustrated components are Environmental Control, Power Generation, Waste Recycling, Facilities, Food Growth, Automation and Pest Management.

The disclosure can be understood by review of the accompanying figure with reference to the following text.

System Level Hierarchy Definition

### System Level Interfaces

System Level focus diagrams focused on one system and the relationships to that system
   Sub-System use cases
      Sub-System Level Hierarchy Definition
         Sub-System Level Interfaces
         Sub-System Level focus diagrams showing one system, and only interfaces to that system to make it easier to read

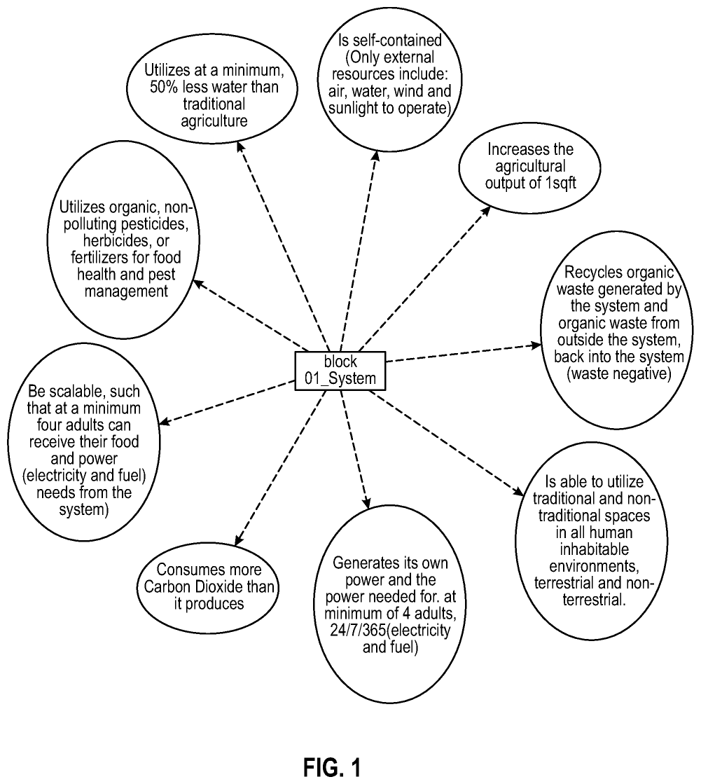

The disclosure contains suffixes A, B and C with each drawing or Figure Number, e.g., FIG. 01.01A, FIG. 01.01B, etc. The figure numbers listed below denote what part of the system is being referenced and the letter designation is the type of figure. An A type are all use cases for that component. B types are hierarchy diagrams showing what makes up that part of the system. C types are interface diagrams showing how everything in the B type connects together and shares information.

FIGS. 4A, 4B illustrate the Food Growing System Overview.

FIG. 5 illustrates the Organic Waste Recycling System Overview.

FIG. 6 illustrates the Pest Management System Overview.

FIGS. 7A, 7B illustrate the Environmental Control System Overview.

FIGS. 8A, 8B illustrate the Automation System Overview.

FIG. 9 illustrates the Facilities System Overview.

FIG. 10 illustrates the Power Generation System Overview.

FIG. 11 illustrates the Food Growing System Use Cases.

FIG. 12A, 12B illustrate the Food Growing System Hierarchy Overview.

FIG. 13A, 13B, 13C, 13D illustrate the Food Growing System.

FIG. 14 illustrates the Grow Area Use Cases.

FIG. 15 illustrates the Grow Area Hierarchy Overview.

FIGS. 16A, 16B illustrate the Grow Area System Overview.

FIG. 17 illustrates the Aquaculture Tank Use Cases.

FIGS. 18A, 18B illustrate the Aquaculture Tank System Overview.

FIG. 19 illustrates the Aquaculture Feed Production System Use Cases.

FIG. 20A, 20B illustrate the Aquaculture Feed Production System Overview.

FIG. 21 illustrate the Aquaculture Breeding System Use Cases.

FIG. 22 illustrates the Aquaculture Breeding System Overview.

FIG. 23 illustrates the Aquaponics Pump System Use Cases.

FIG. 24 illustrates an aquaponics pump system

FIG. 25 illustrates the Water Waste Management System Use Cases.

FIG. 26 illustrates the Aquaculture Waste Management System Hierarchy Overview.

FIG. 27 illustrates the Water Waste Management System.

FIG. 28 illustrates the Fresh Water Management System Use Cases.

FIG. 29 illustrates the Fresh Water Management System Hierarchy Overview.

FIG. 30 illustrates the Fresh Water Management System Overview.

FIG. 31 illustrates the Germination System Use Cases.

FIG. 32 illustrates the Germination System.

FIG. 33 illustrates the Pollination System Use Cases.

FIG. 34 illustrates the Pollination System Overview.

FIG. 35 illustrates the Organic Waste Recycling System Use Cases.

FIG. 36 illustrates the Organic Waste Recycling System Hierarchy Overview.

FIGS. 37A, 37B illustrate the Organic Waste Recycling System.

FIG. 38 illustrates the Anaerobic Digester Use Cases.

FIG. 39 illustrates the Anaerobic Digester System Overview.

FIG. 40 illustrates the Waste Processing System Use Cases.

FIG. 41 illustrates the Waste Processing System Overview.

FIG. 42 illustrates the Digestate Pumps Use Cases.

FIG. 43 illustrates the Digestate Pumps System Overview.

FIG. 44 illustrates the Human Waste Processing System—optional Use Cases.

FIG. 45 illustrates the Human Waste Processing System—optional.

FIG. 46 illustrates the Pest Management System Use Cases.

FIG. 47 illustrates the Pest Management System Hierarchy Overview.

FIG. 48 illustrates the Pest Management System.

FIG. 49 illustrates the Environmental Control System Use Cases.

FIGS. 50A, 50B illustrate the Environmental Control System Hierarchy Overview.

FIGS. 51A, 51B illustrate the Environmental Control System.

FIG. 52 illustrates the Air Circulation and CO2 introduction System Use Cases.

FIG. 53 illustrates the Air Circulation and CO2 Introduction System Overview.

FIG. 54 illustrates the Aquaculture Environmental Control System Use Cases.

FIG. 55 illustrates the Aquaculture Environmental Control System overview.

FIG. 56 illustrates the Cooling System Use Cases.

FIG. 57 illustrates the Cooling System Overview.

FIG. 58 illustrates the Heating System Use Cases.

FIG. 59 illustrates the Heating System Overview.

FIG. 60 illustrates the Light Management System Use Cases.

FIG. 61 illustrates the Light Management System Overview.

FIG. 62 illustrates the Plant Environmental Control Systems Use Cases.

FIG. 63 illustrates the Plant Environmental Control System.

FIG. 64 illustrates the Water Recapture and Humidity Control System Use Cases.

FIG. 65 illustrates the Water Recapture and Humidity Control System Hierarchy.

FIG. 66 illustrates the Water Recapture and Humidity Control System.

FIG. 67 illustrates the Automated Monitoring and Control System Use Cases.

FIGS. 68A, 68B illustrate the Automated Monitoring and Control System Hierarchy Overview.

FIGS. 69A, 69B, 69C, 69D illustrate the Automated Monitoring and Control System.

FIG. 70 illustrates the Aquaculture Feed Monitoring and Control System Use Cases.

FIG. 71 illustrates the Aquaculture Feed Monitoring and Control System Overview.

FIG. 72 illustrates the Aquaculture Health Monitoring Use Cases.

FIG. 73 illustrates the Aquaculture Health Monitoring System Overview.

FIG. 74 illustrates the Digester Monitoring and Control System Use Cases.

FIG. 75 illustrates the Digester Monitoring and Control System Overview.

FIG. 76 illustrates the Environmental Monitoring and Control System Use Cases.

FIG. 77 illustrates the Environmental Monitoring and Control System Overview.

FIG. 78 illustrates the Facility Monitoring and Control System Use Cases.

FIG. 79 illustrates the Facility Monitoring and Control System Overview.

FIG. 80 illustrates the Methane Generation System Monitor and Control System Use Cases.

FIG. 81 illustrates the Methane Generation System Monitoring and Control System Overview.

FIG. 82 illustrates Plant Health Monitoring System Use Cases.

FIG. 83 illustrates the Plant Health Monitoring System Overview.

FIG. 84 illustrates Power Supply Monitoring and Control System Use Cases.

FIG. 85 illustrates the Power Supply Monitoring and Control System Overview.

FIG. 86 illustrates the Remote Monitoring and Control System Use Cases.

FIG. 87 illustrates Remote Monitoring and Control System Hierarchy Overview.

FIGS. 88A, 88B, 88C, 88D illustrate the Remote Monitoring and Control System Overview.

FIG. 89 illustrates the Pest management Monitoring and Control Use Cases.

FIG. 90 illustrates Pest Management Monitoring and Control System Overview.

FIG. 91 illustrates Facilities & Security System Use Cases.

FIG. 92 illustrates the Facilities & Security System Hierarchy Overview.

FIG. 93 illustrates the Facilities & Security System.

FIG. 94 illustrates Scalable Insulated Structure Use Cases.

FIG. 95 illustrates Power Generation System Use Cases.

FIG. 96 illustrates Power Generation System Hierarchy Overview.

FIGS. 97A, 97B illustrate Power Generation System.

FIG. 98 illustrates Methane Power Generation System Use Cases.

FIG. 99 illustrates Methane Power Generation System Overview.

FIG. 100 illustrates Methane to Vehicle Fuel Processing System—Optional Use Cases.

FIG. 101 illustrates Methane to Vehicle Fuel Processing System Overview.

FIG. 102 illustrates Solar Power Generation System Use Cases.

FIG. 103 illustrates Solar Power Generation System Overview.

FIG. 104 illustrates the Wind Power Generation System Use Cases.

FIG. 105 illustrates the Wind Power Generation System Overview.

FIG. 106 illustrates the Power Conditioning, Distribution, & Storage System Use Cases.

FIGS. 107A, 107B illustrate the Power Conditioning, Distribution, & Storage System Overview.

FIG. 108 illustrates the Methane Storage and Cleaning System Use Cases.

FIG. 109 illustrates the Methane Storage and Cleaning System Overview.

FIGS. 110A, 110B, 110C, 110D illustrate an embodiment of the system and interface definition diagram that illustrates the interfaces between the various sub-systems (FIGS. 111A through 117) that combine to form the invention.

FIG. 111A illustrates an embodiment of the Food Growing sub-system and interface definition.

FIGS. 111B, 111C, 111D illustrate an embodiment of the water circulation path and components of the Vertical Food Growing sub-system.

FIGS. 112A, 112B illustrate an embodiment of the Organic Waste Recycling sub-system and interface definition.

FIGS. 113A, 113B, 113C, 113D illustrate an embodiment of the Power Generation sub-system and interface definition.

FIG. 114 illustrates an embodiment of the Pest Management sub-system and interface definition.

FIGS. 115A, 115B illustrate an embodiment of the Environmental Control sub-system and interface definition.

FIGS. 116A, 116B, 116C, 116D illustrate an embodiment of the Automated Monitoring and Control sub-system and interface definition.

FIG. 117 illustrates an embodiment of the Facilities and Security sub-system and interface definition.

### DETAILED DESCRIPTION OF THE DISCLOSURE

This disclosure illustrates a scalable, bioregenerative crop and energy production system for Terrestrial and Non-Terrestrial Uses (hereinafter “system”). The system comprises an animal and plant growing sub-system that can increase plant (agriculture) output of one square foot by a factor of two. The system utilizes at a minimum, 50% less water than required for traditional agriculture. The system is further able to utilize traditional and non-traditional agricultural spaces in all human inhabitable environments, terrestrial and non-terrestrial. Included in the disclosure is the use of vacant industrial spaces and shopping malls. Multi-story structures may be particularly advantageously used. The system may utilize organic, non-polluting pesticides, herbicides, or fertilizers for food security and health.

The system subject of this disclosure may also be a closed system, i.e., not requiring external resources such as air, water, wind, and sunlight to operate. It is also envisioned that embodiments maybe utilized in enclosed spaces such as structures akin to warehouses, or other structures having significant floor space. Also, enclosure that may allow installation of multiple tiers or shelves of system components may be particularly useful or advantageous. External resources may be furnished to the systems within enclosed spaces or enclosures.

In another embodiment, the system may be self-contained, i.e. allowing harvesting of plants and animals from the animal breeding and plant growth within the system and requiring only external resources such as air, water, wind, and sunlight. The harvesting will be controlled in order to maintain a necessary animal and plant stock for continued growth and maintenance of the equilibrium. It will be appreciated that the system may require energy for the operation of pumps or component control systems such as water pH monitors, temperature monitors, heaters, water aerators, etc. Wind and sunlight may be required for generation of electrical power, e.g., via wind turbines or solar panels, as well as for purposes of pollination and photosynthesis.

Referencing FIG. 1 (FIG. 01.00A) System Use Cases, the drawing illustrates an embodiment of the disclosure wherein the Scalable, Bioregenerative Crop and Energy Production System for Terrestrial and Non-Terrestrial Uses (henceforth referenced as: The System), has been created in order to:
Increases the agricultural output of one square foot by a factor of two;
Utilizes at a minimum, 50% less water than traditional agriculture;
Is able to utilize traditional and non-traditional agricultural spaces in all human inhabitable environments, terrestrial and non-terrestrial;
Utilizes organic, non-polluting pesticides, herbicides, or fertilizers for food security and health;
Is self-contained (only external resources including: air, water, wind, and sunlight to operate);
Recycles organic waste generated by the system and organic waste from outside the system, back into the system (waste negative);
Generates its own power and the power and fuel needed for 4 adults at a minimum;
Consumes more Carbon Dioxide than it produces; and
Is scalable, such that at a specified number of adults can receive their food and power (electricity and fuel) needs from the system.

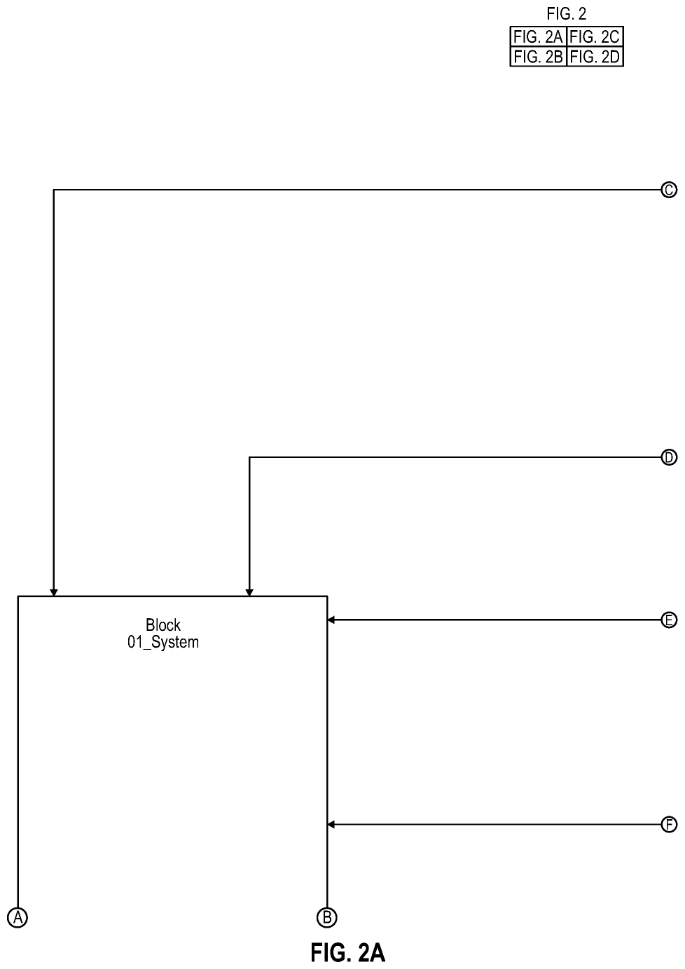

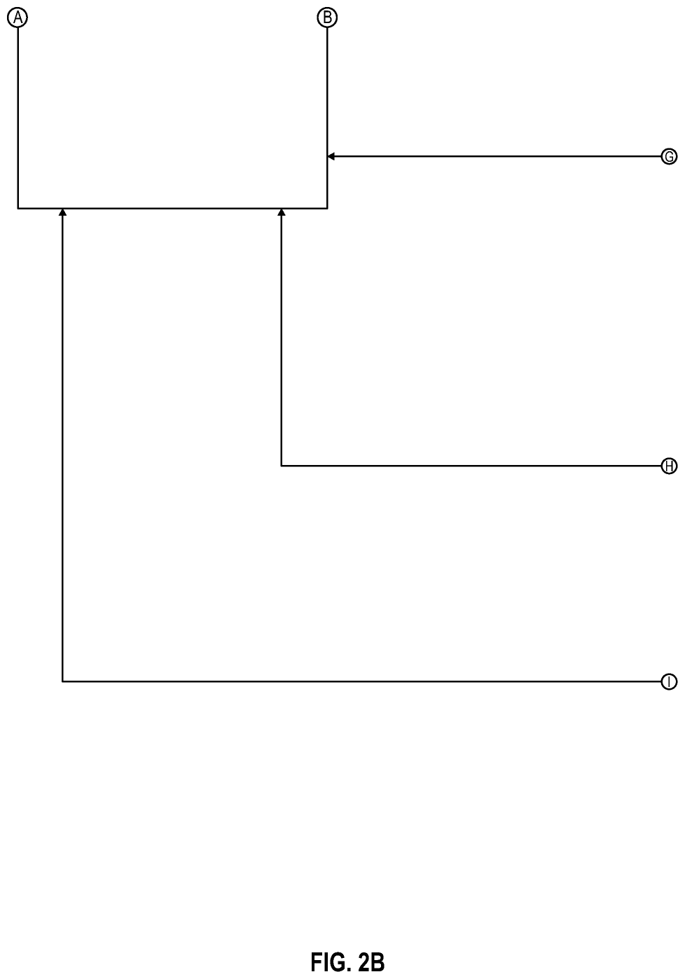

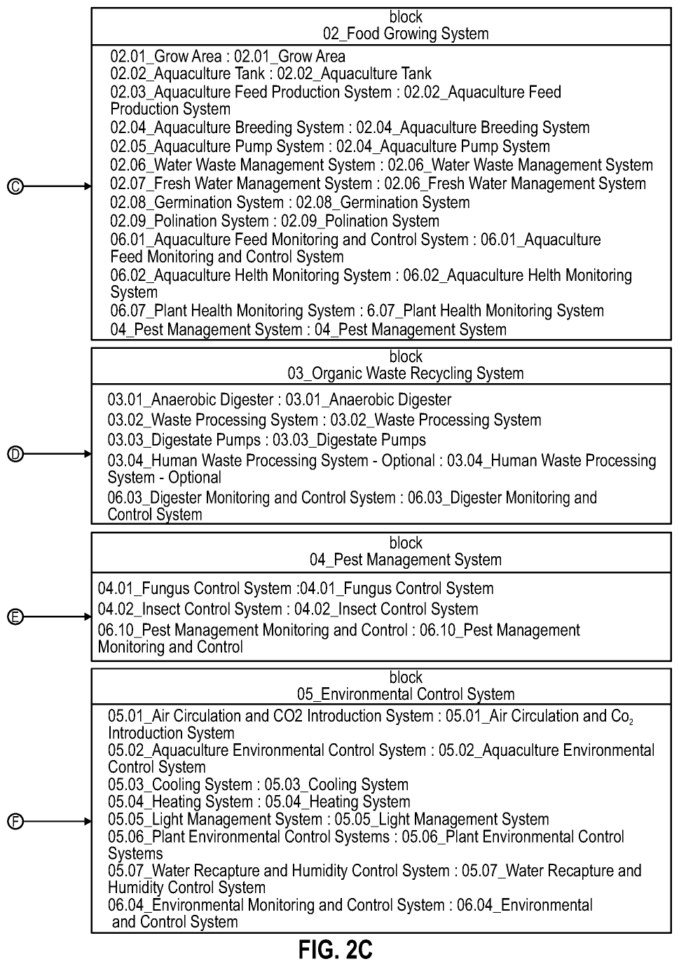

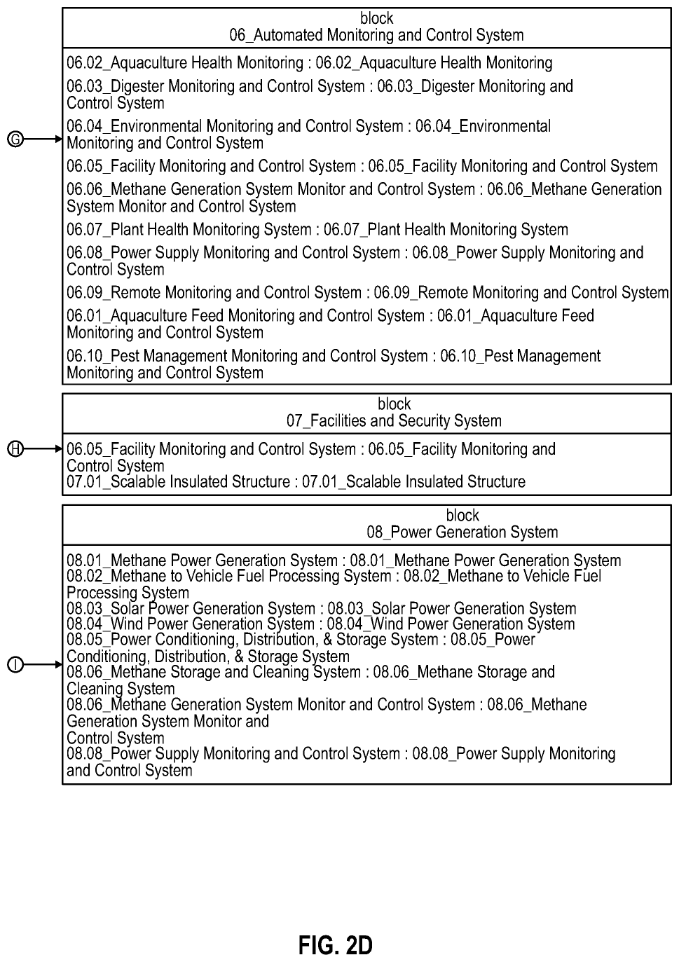

Referencing FIG. 2 (FIG. 01.01B) System Hierarchy Overview, The System consists of a Food Growing System 02, Organic Waste Recycling System 03, Pest Management System 04, Environmental Control System 05, Automated Monitoring and Control System 06, a Facilities and Security System 07, and a Power Generation System 08.

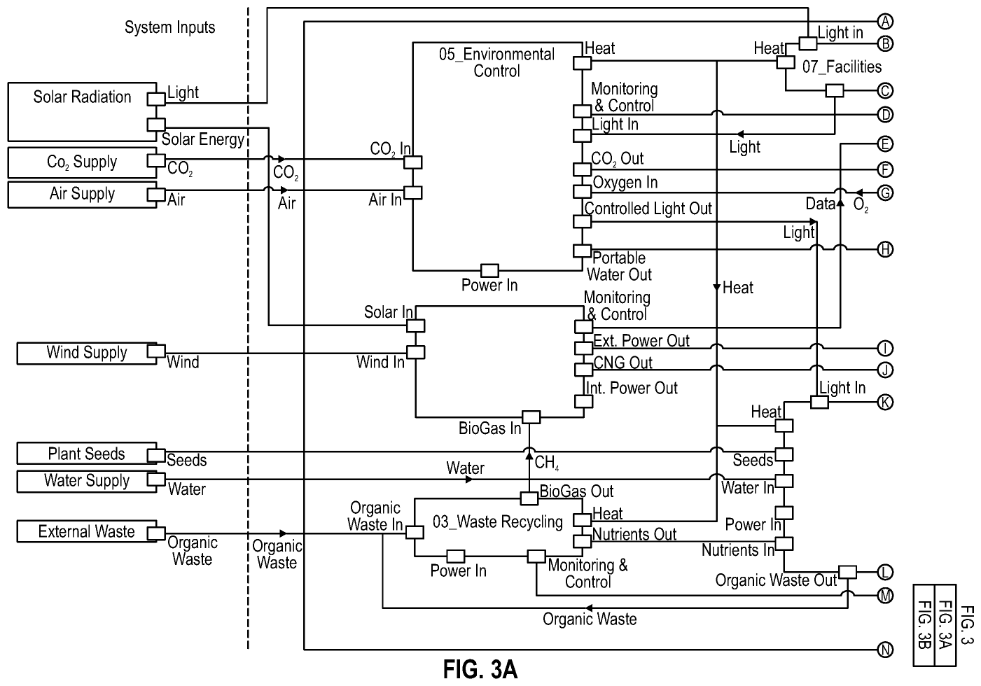

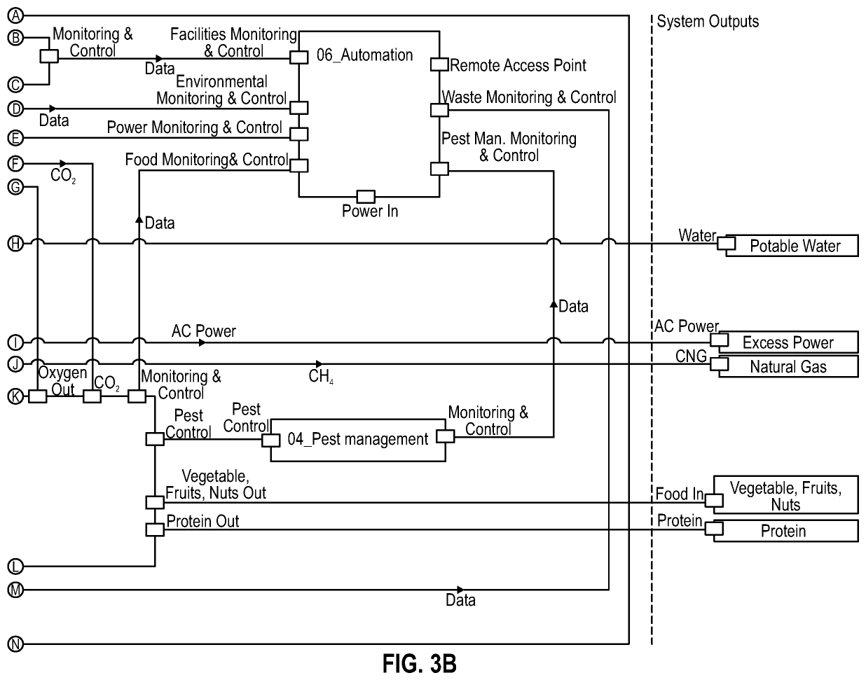

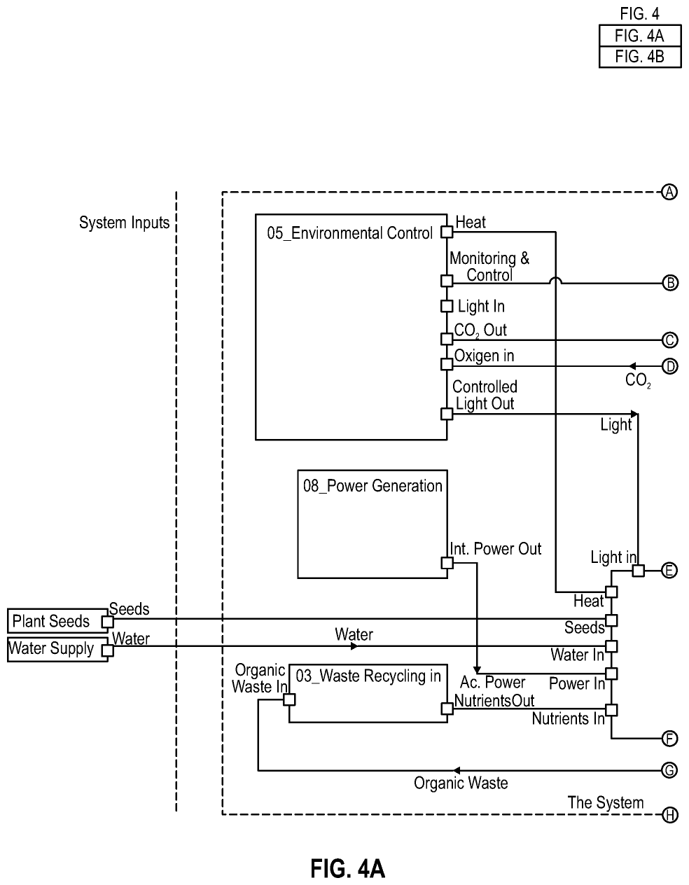

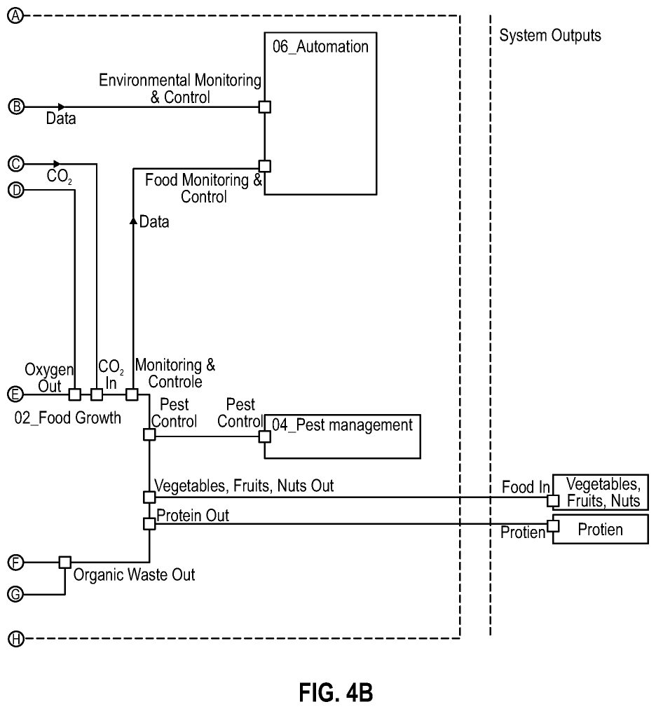

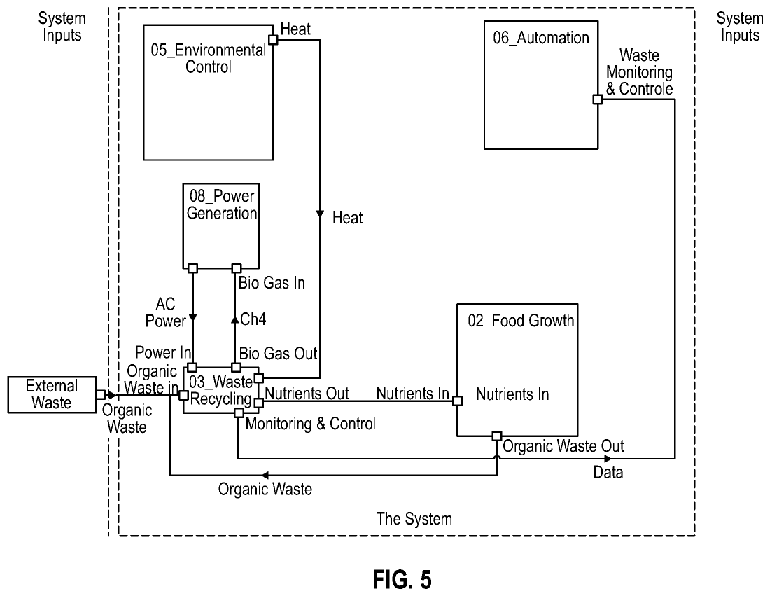

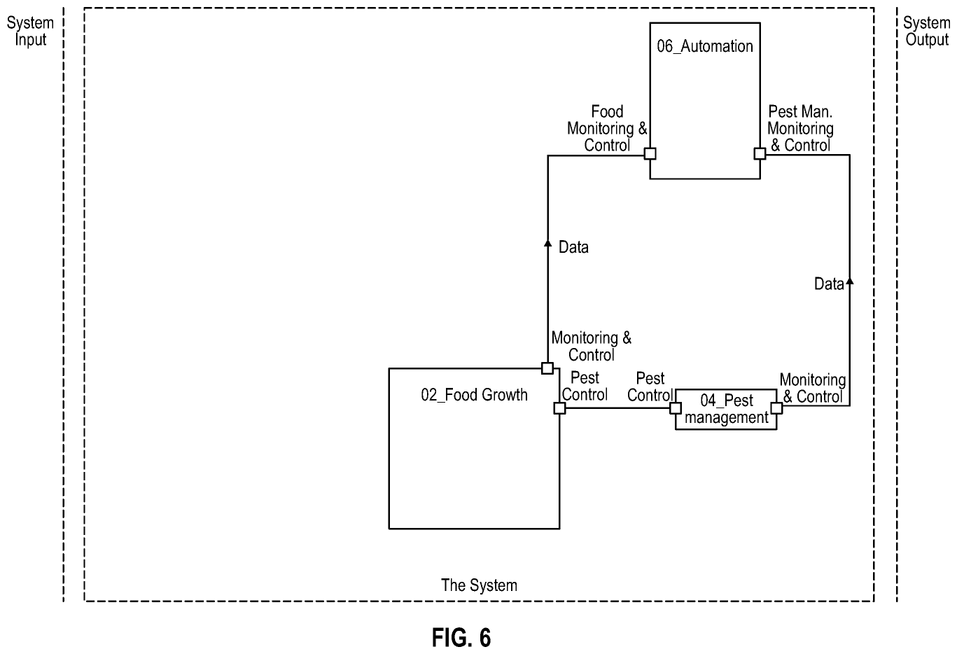

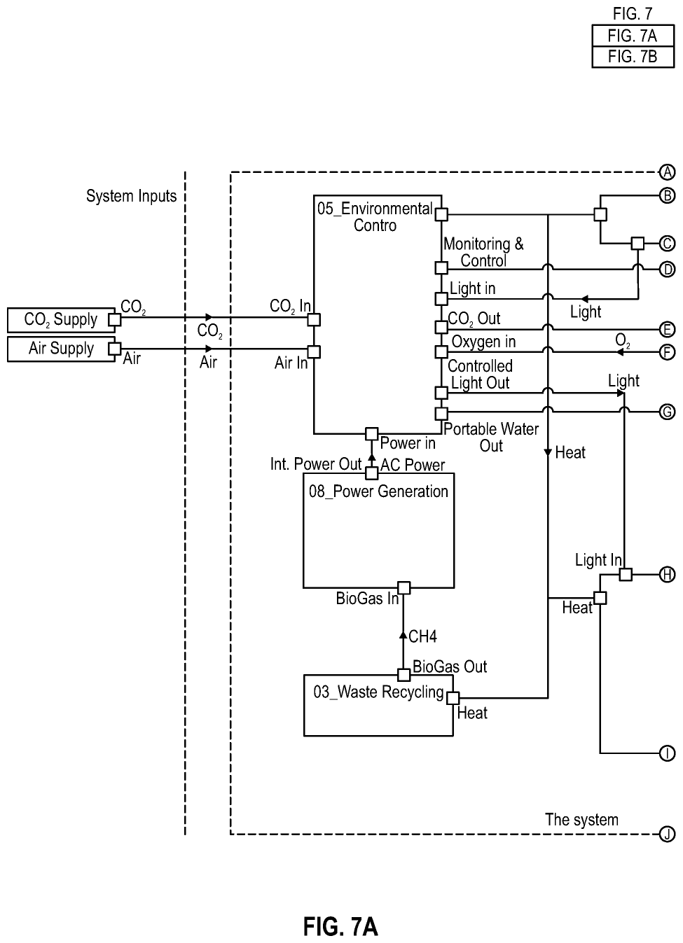

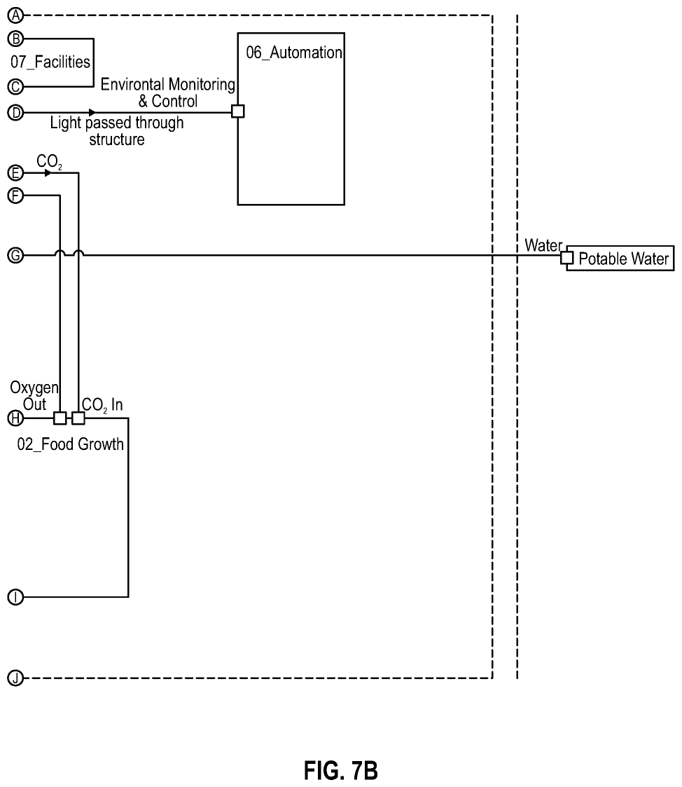

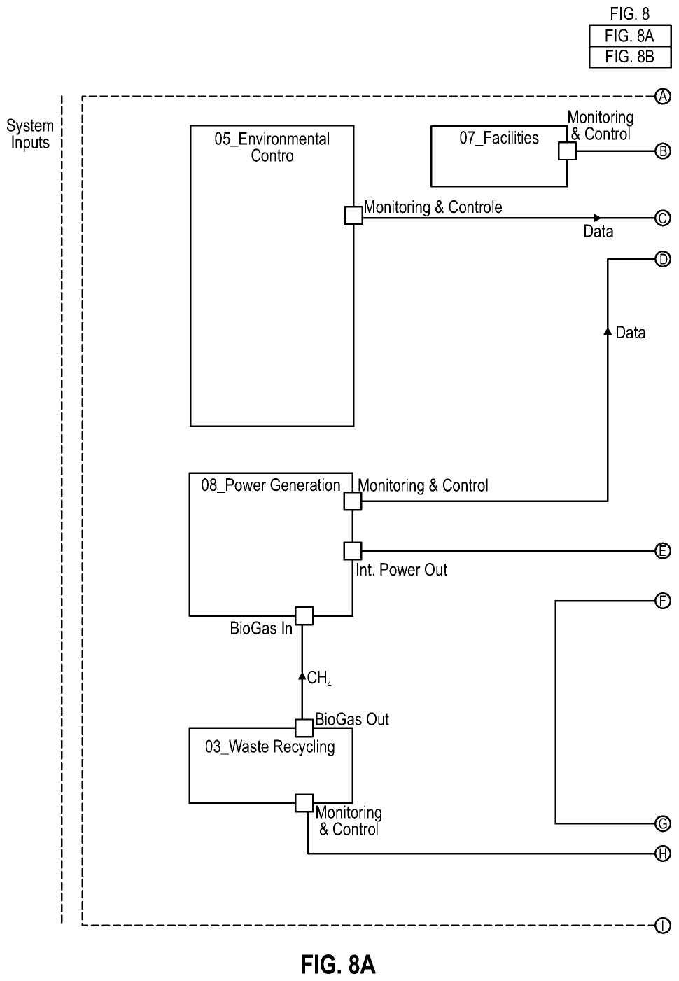

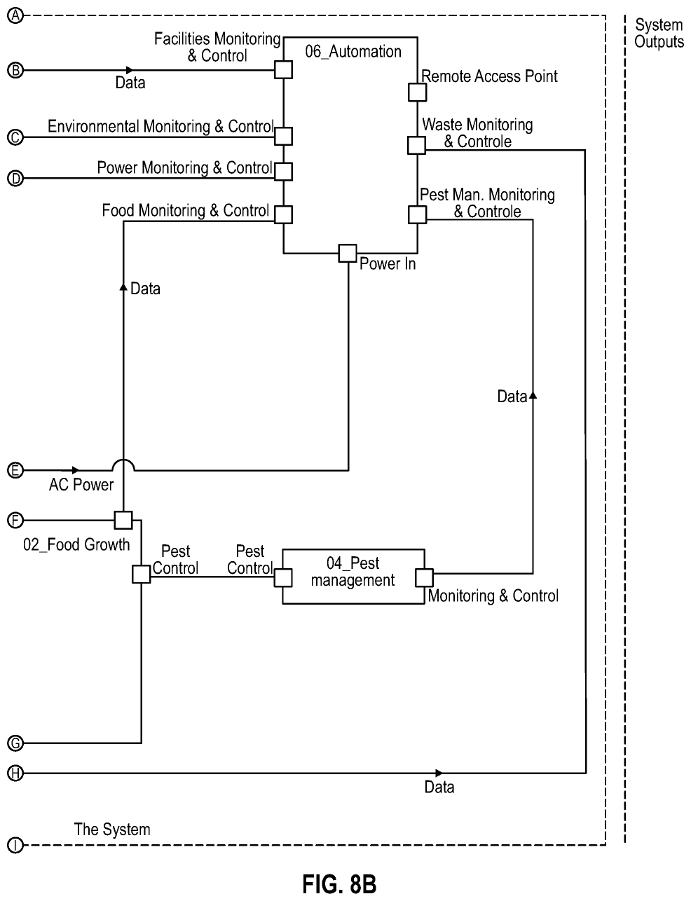

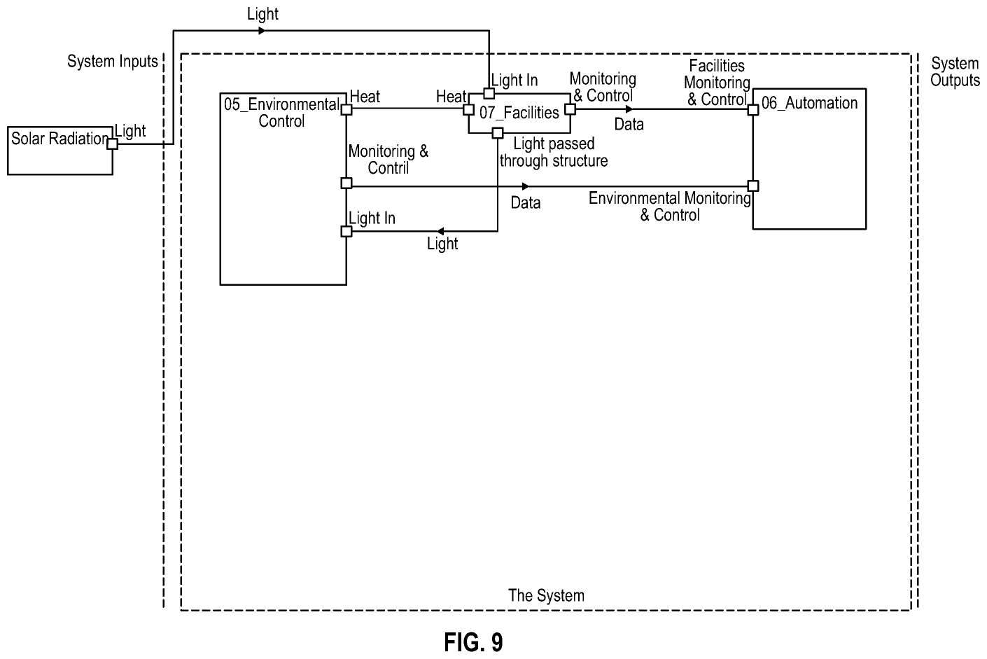

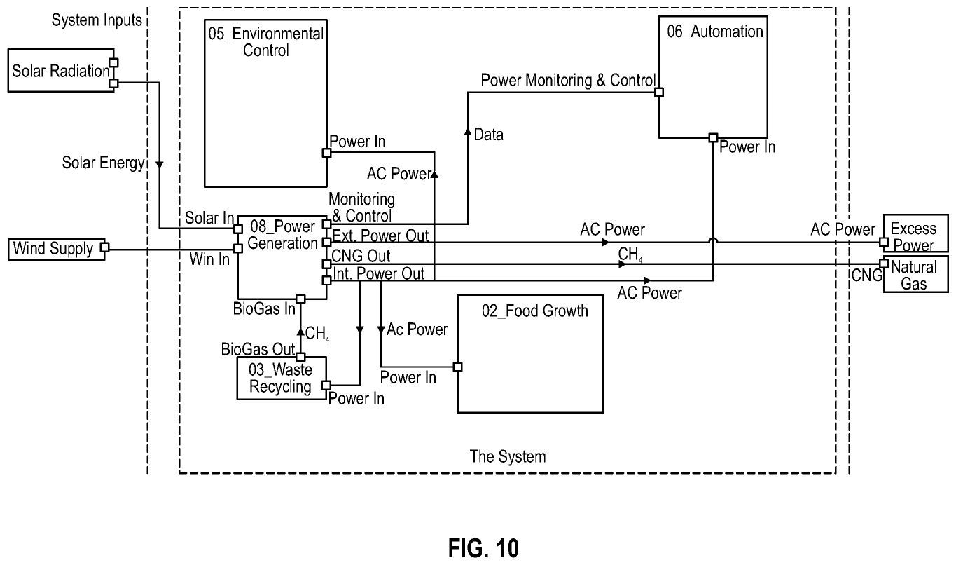

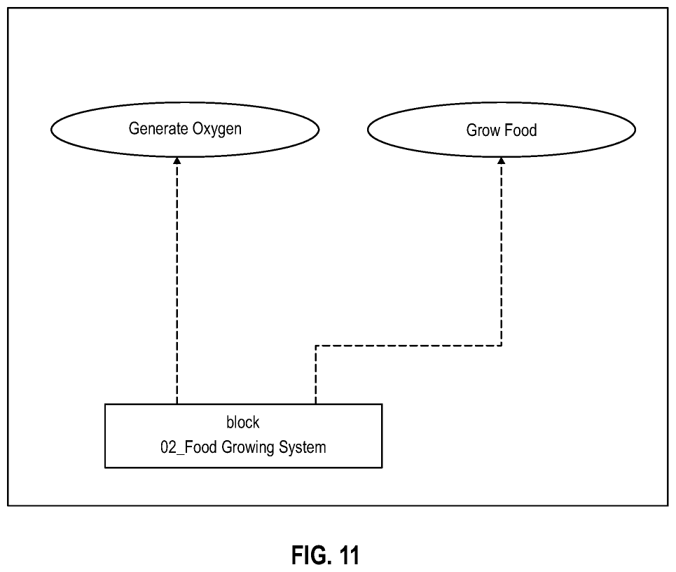

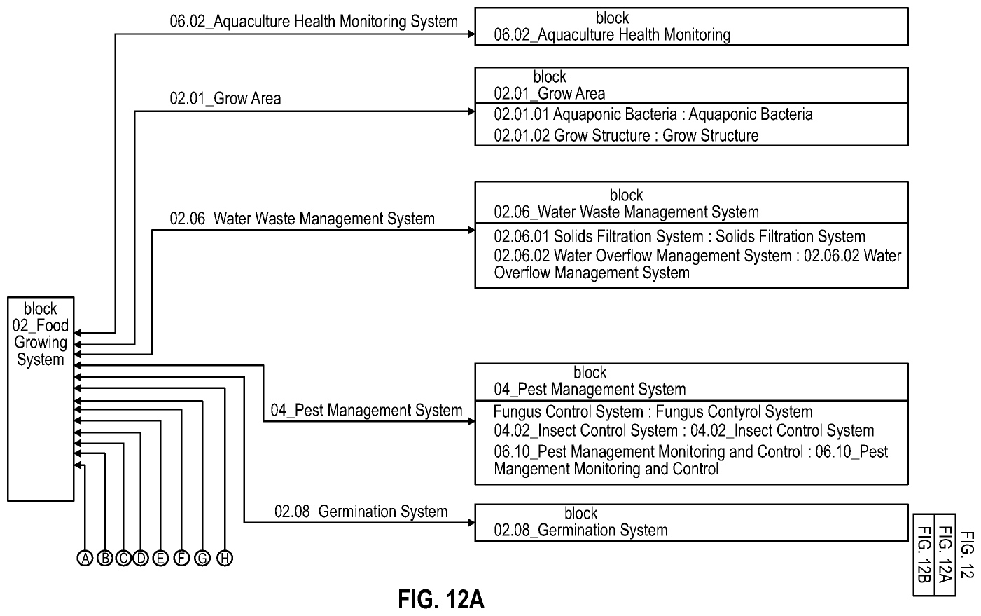

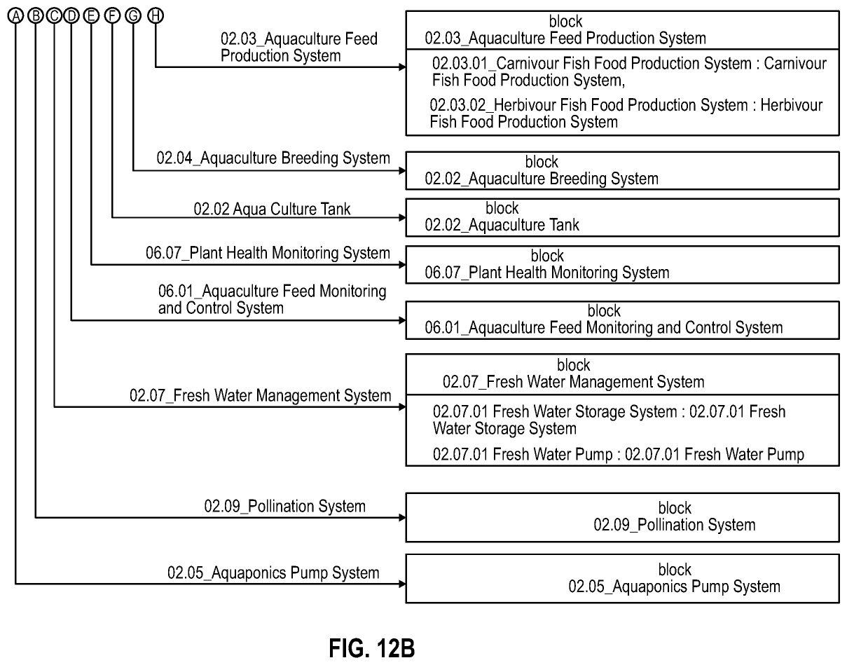

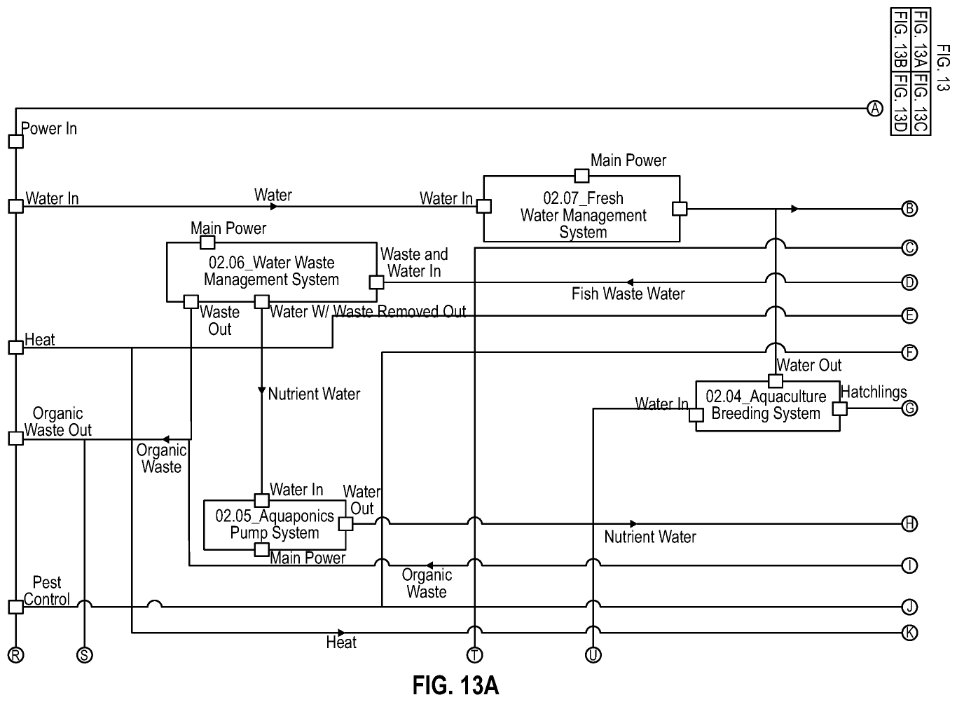

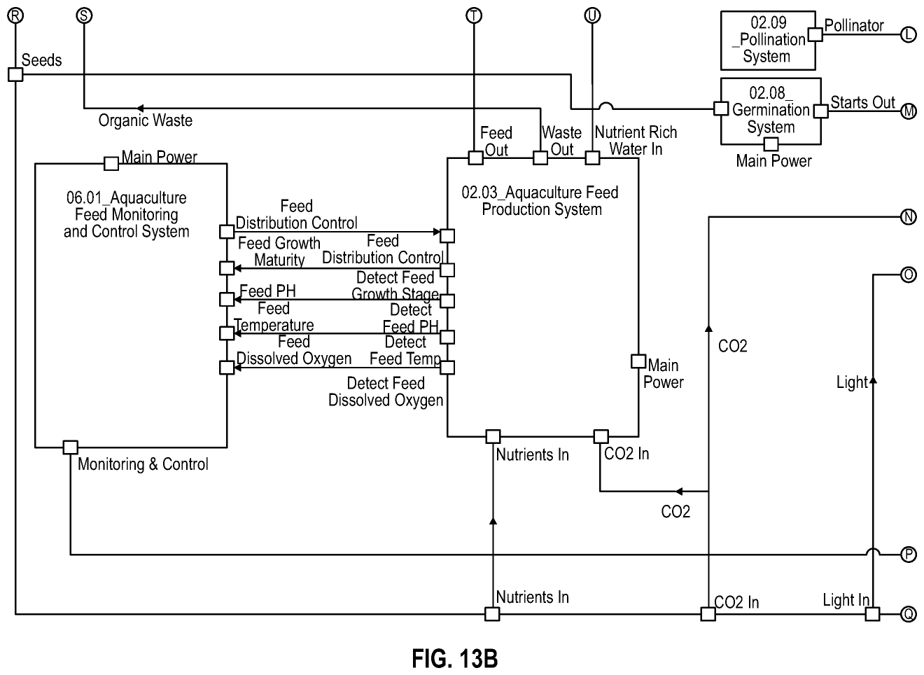

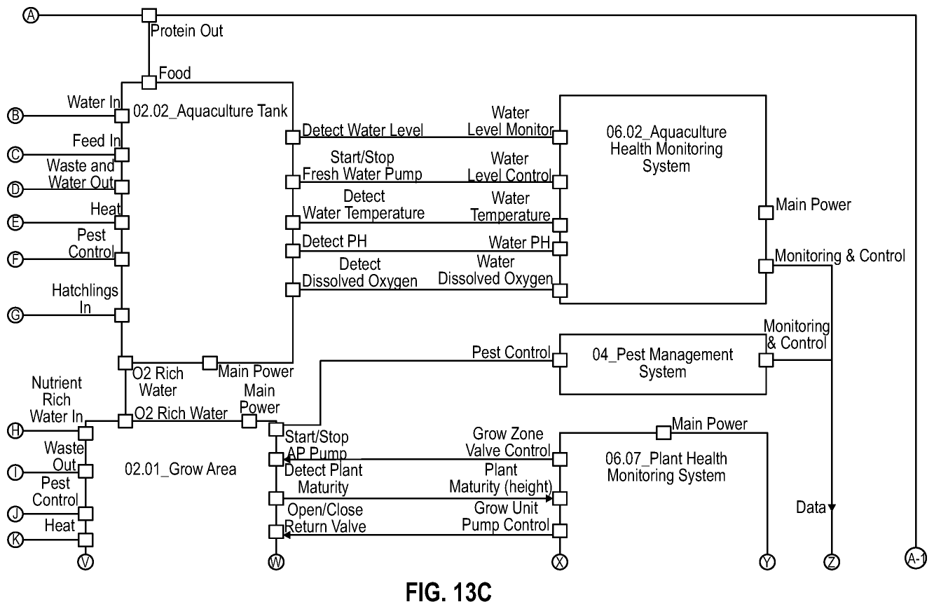

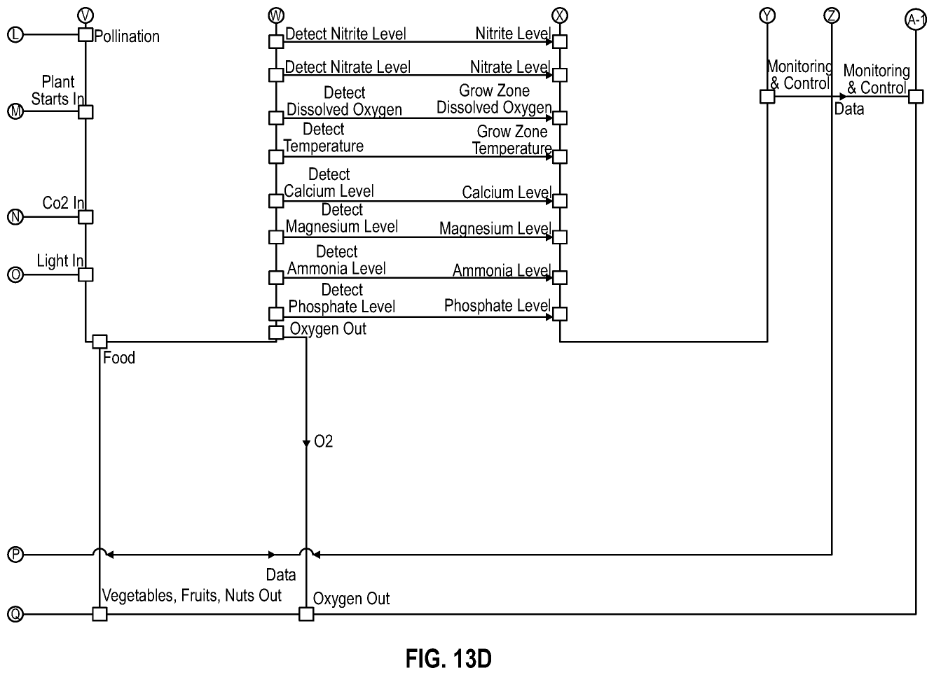

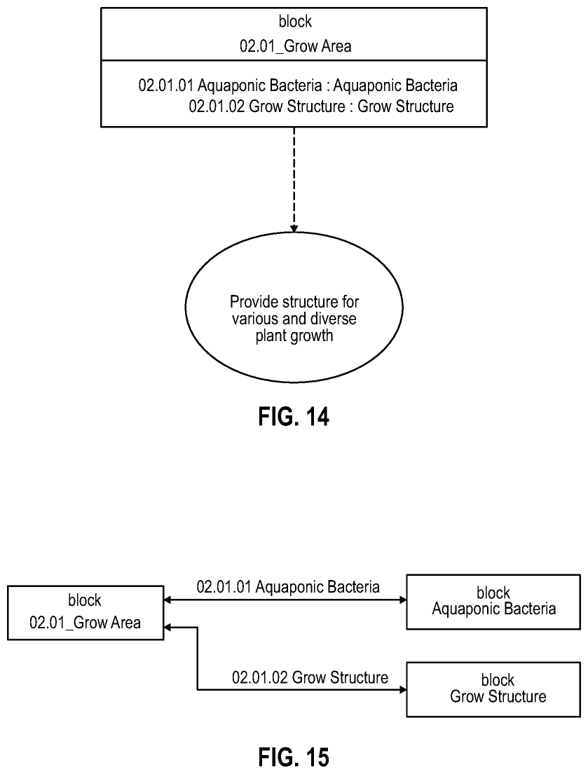

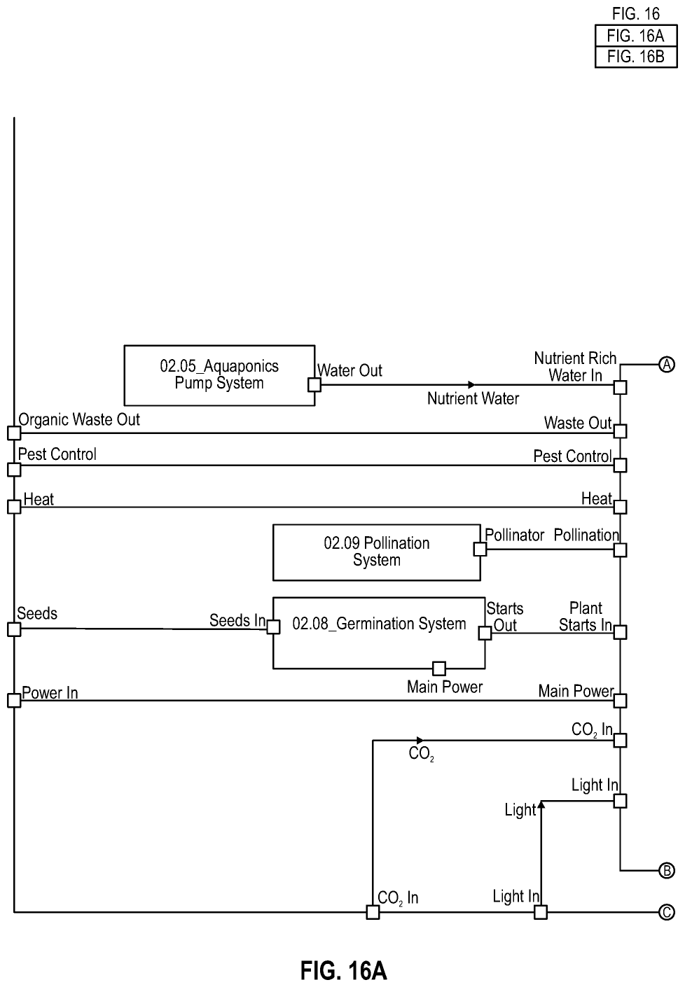

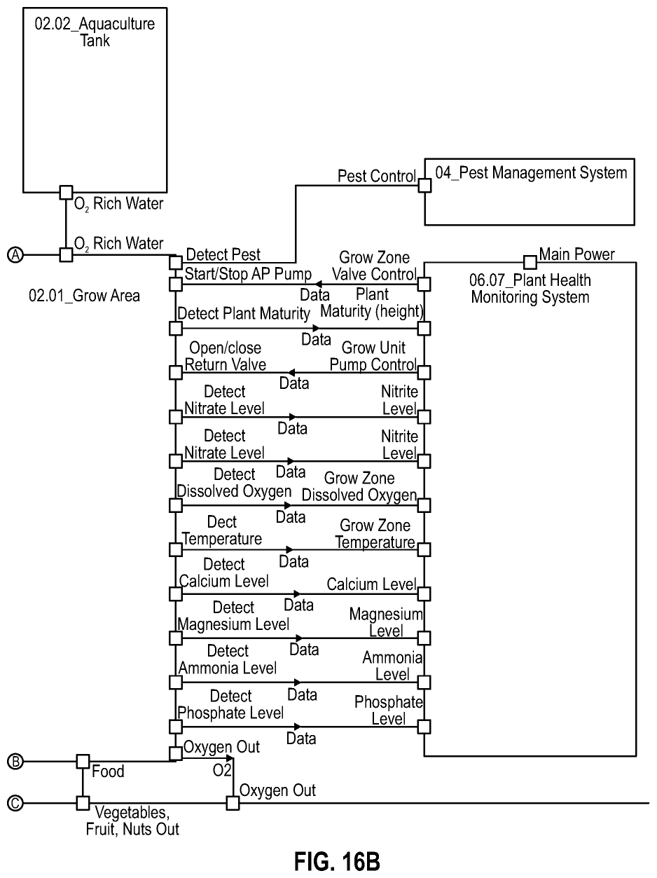

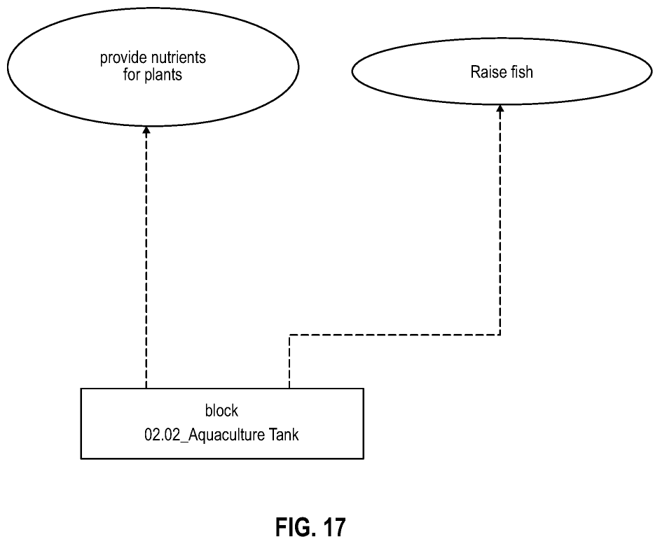

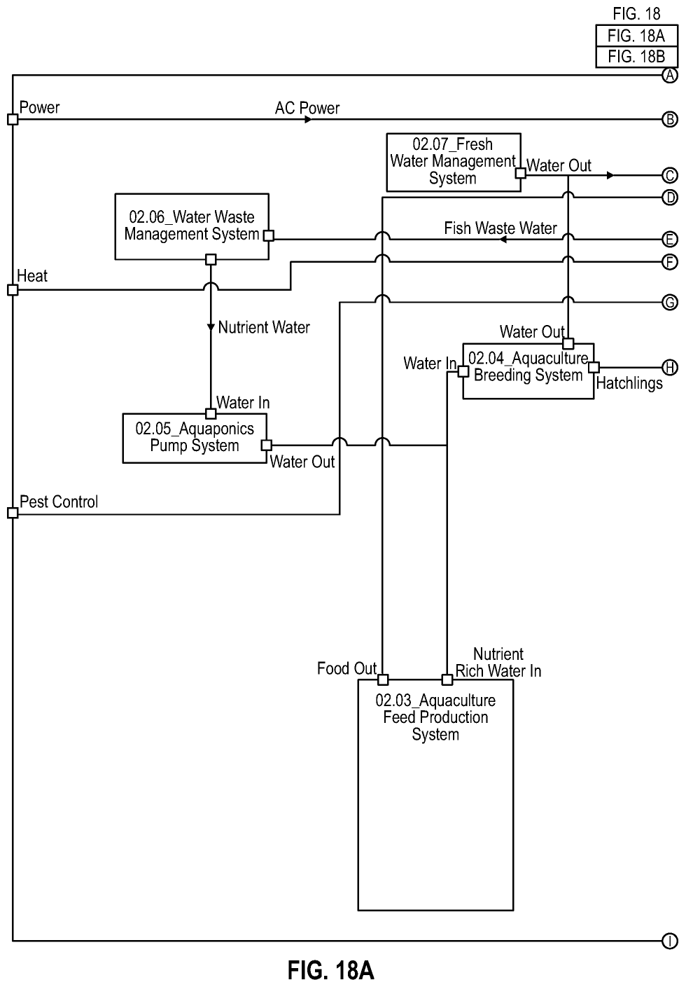

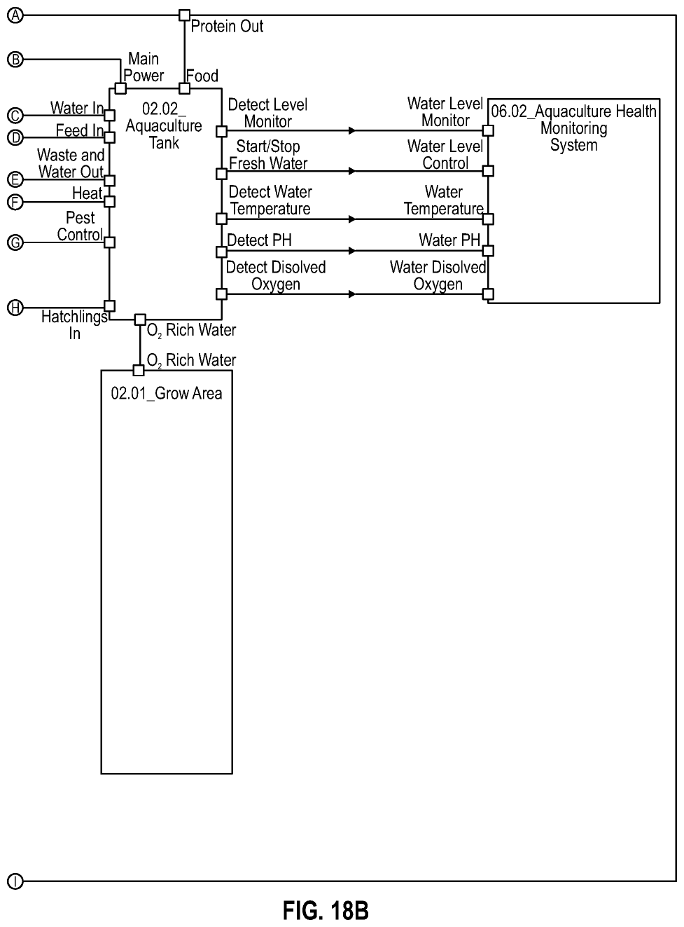

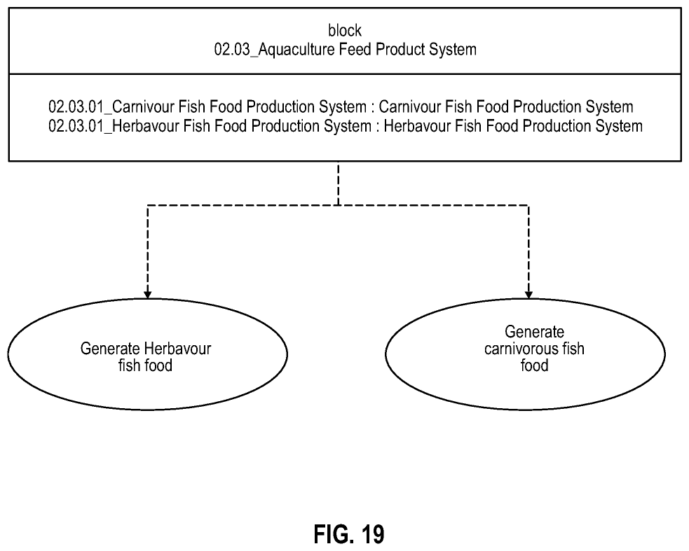

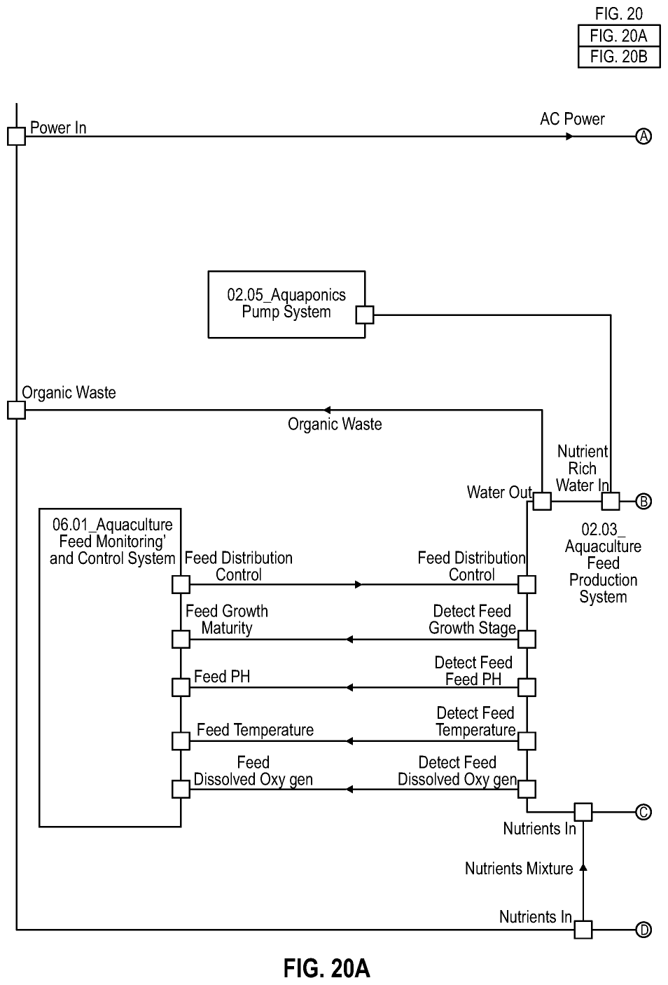

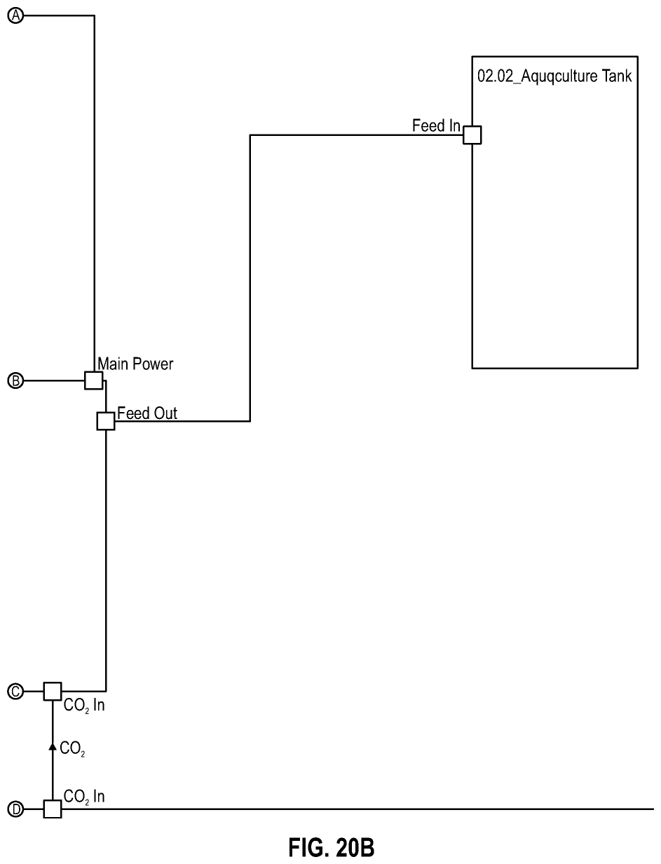

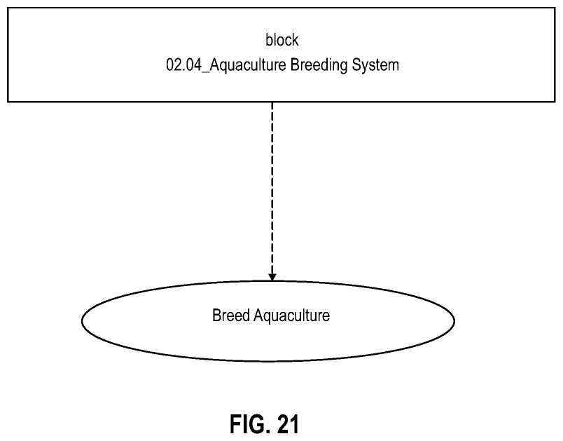

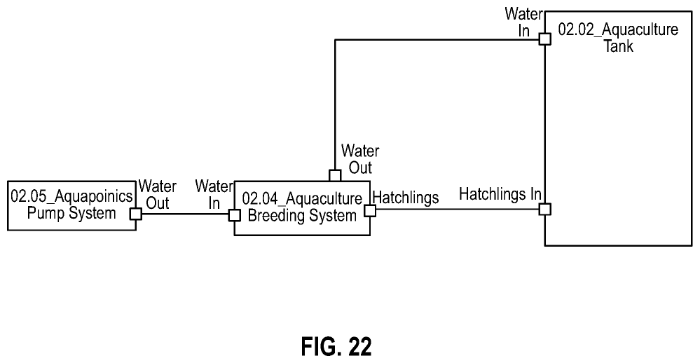

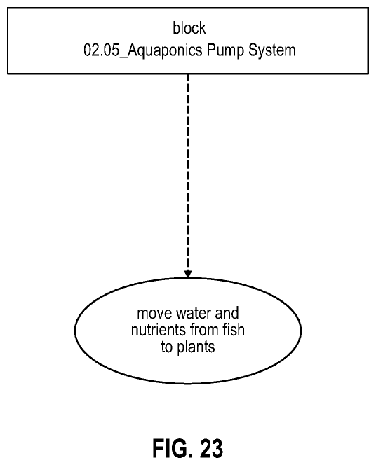

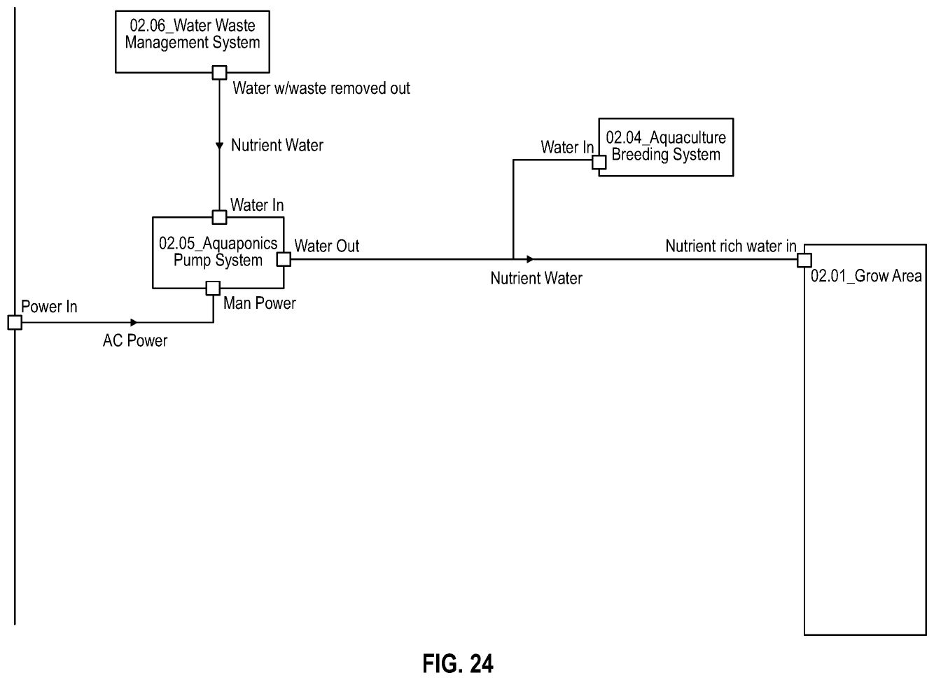

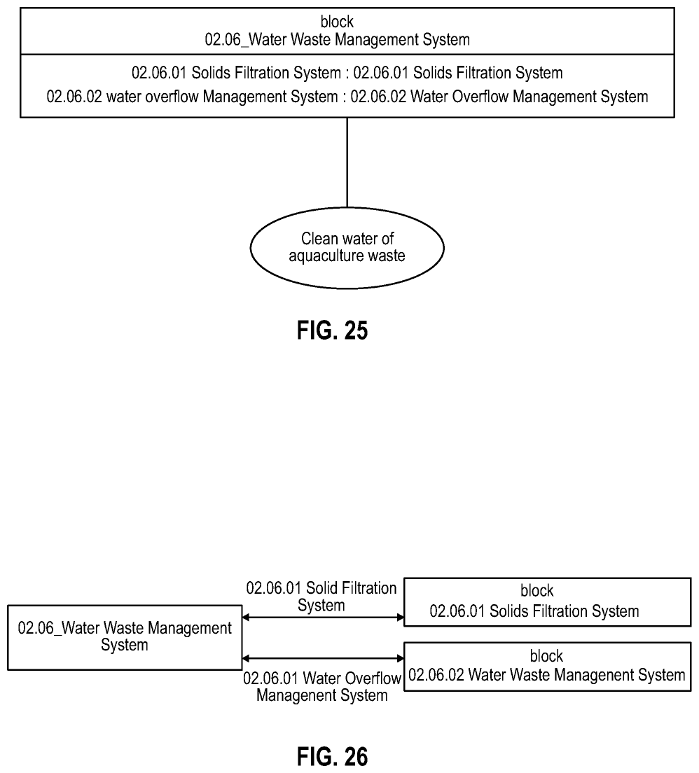

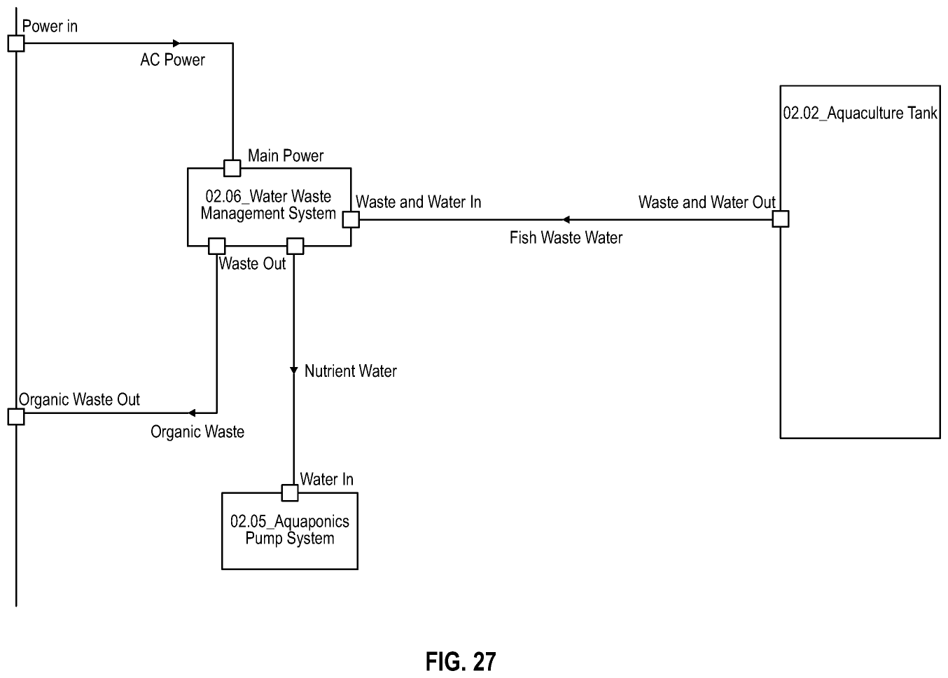

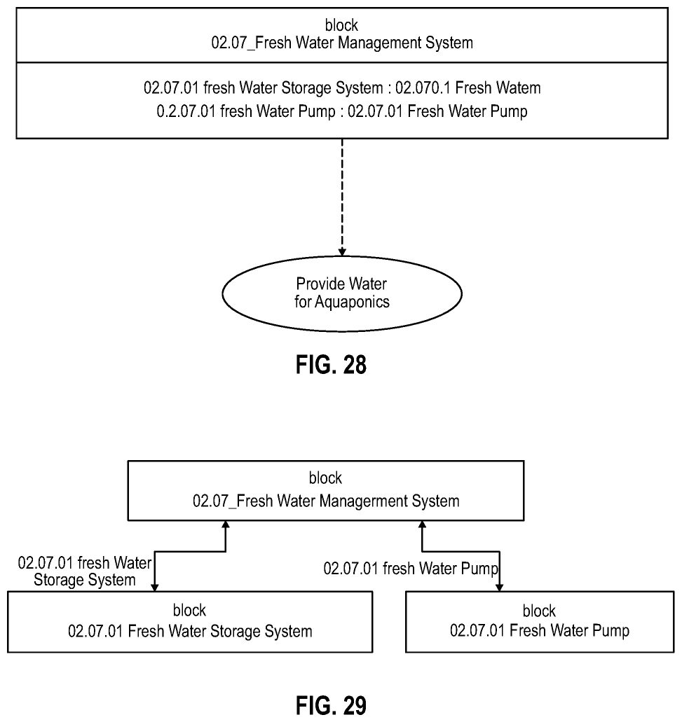

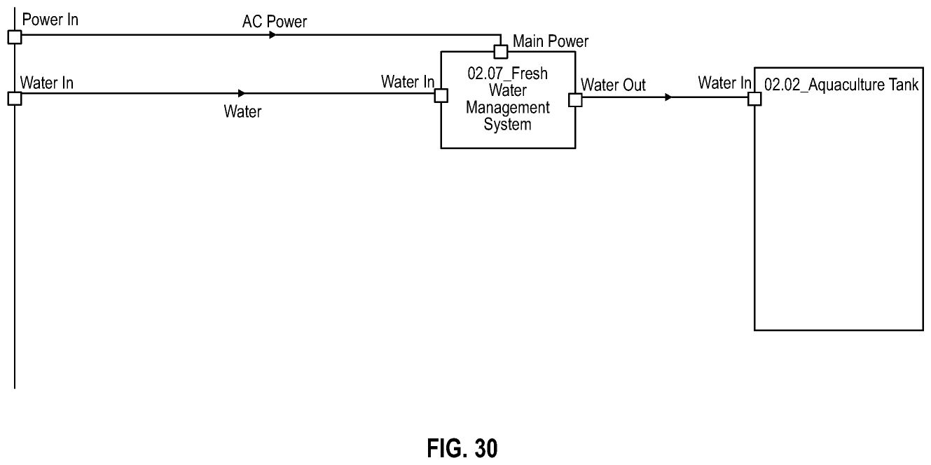

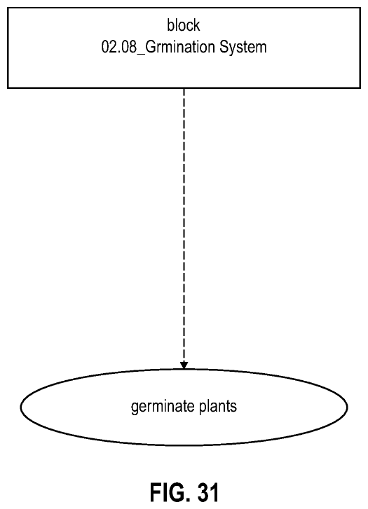

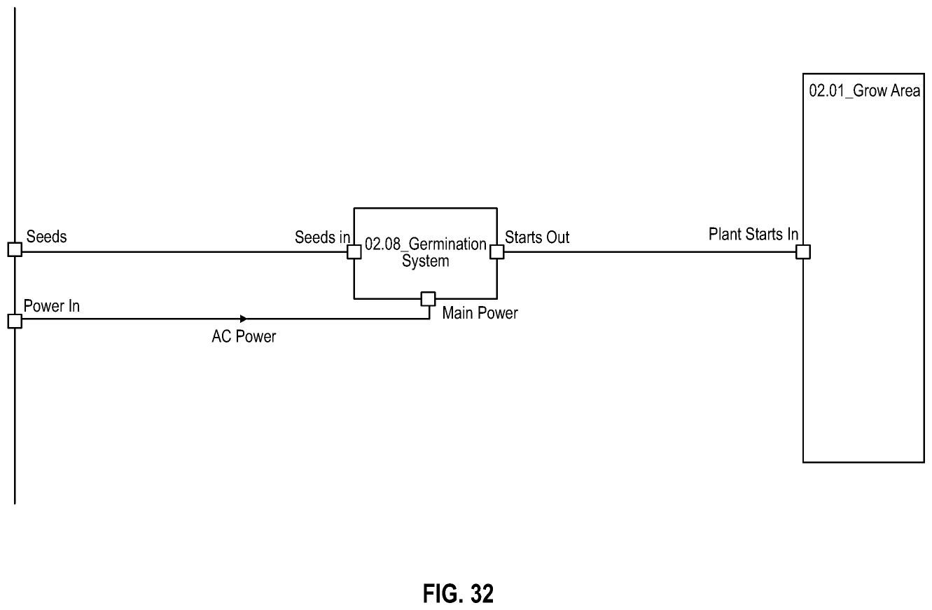

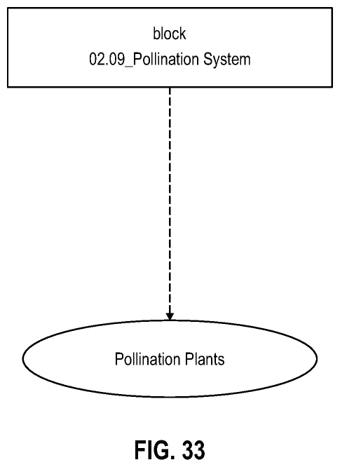

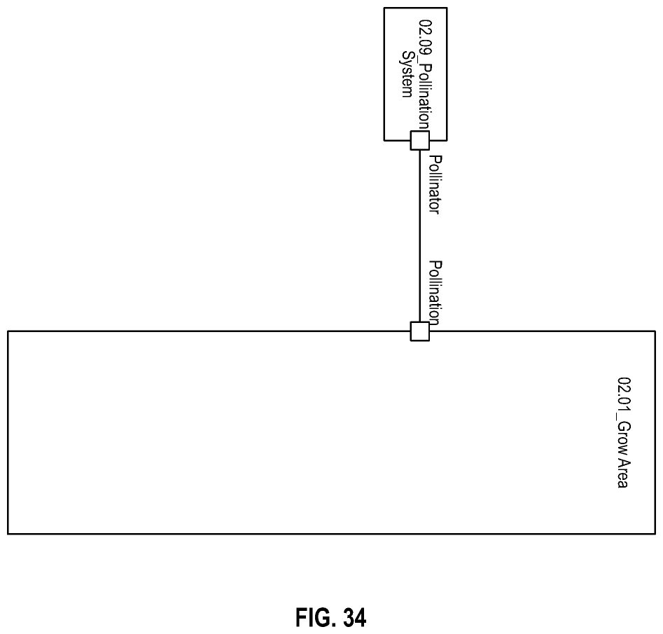

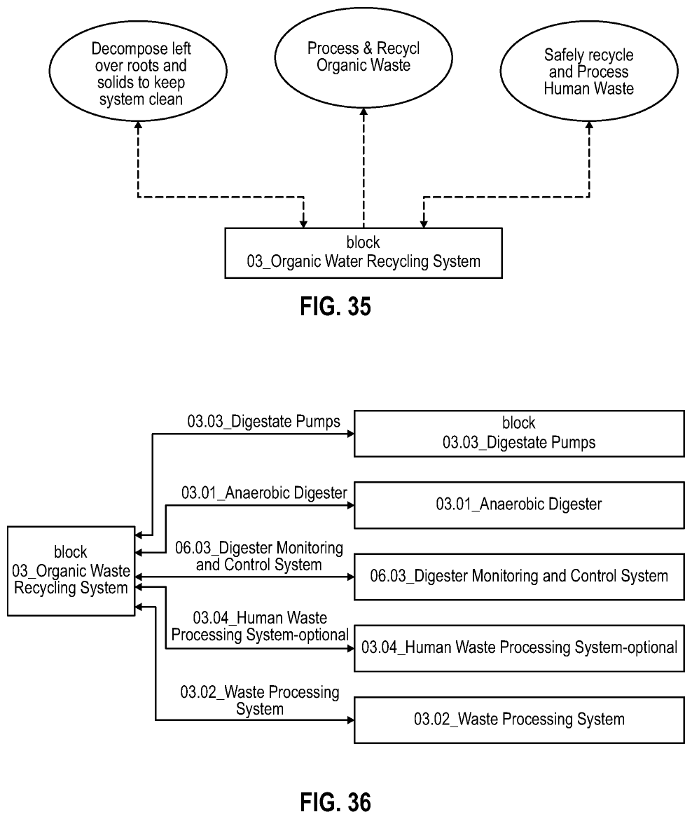

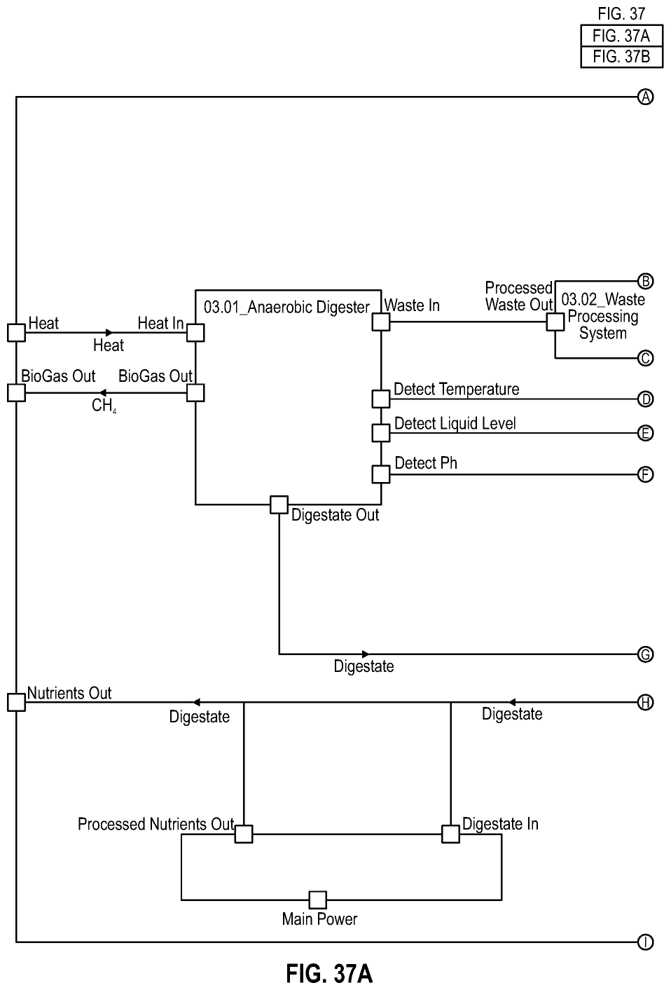

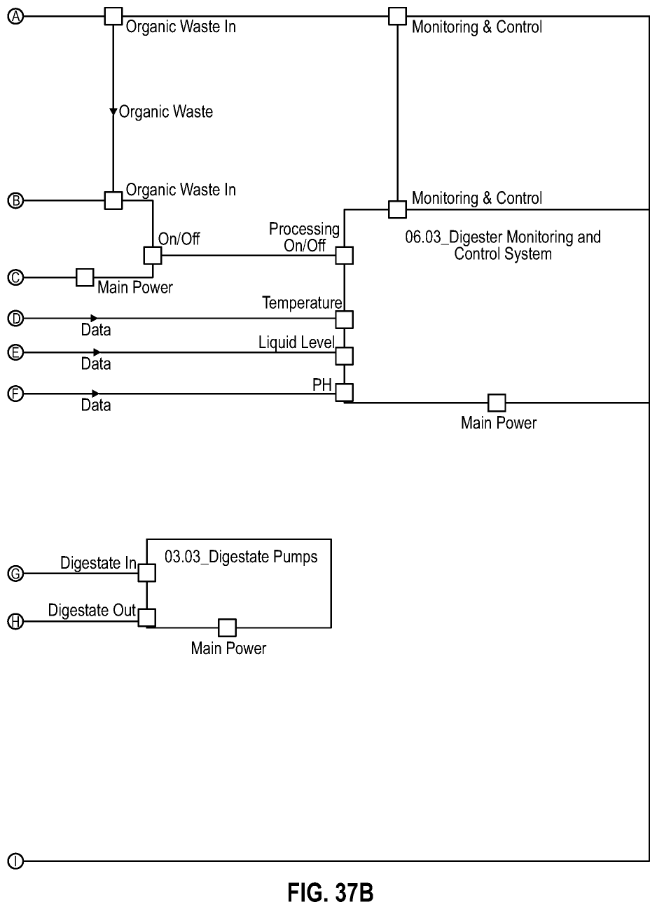

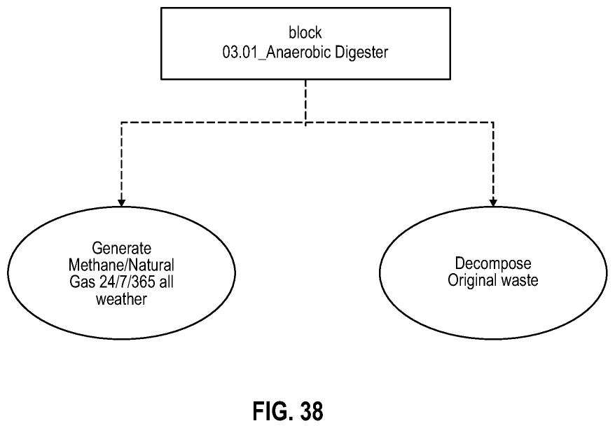

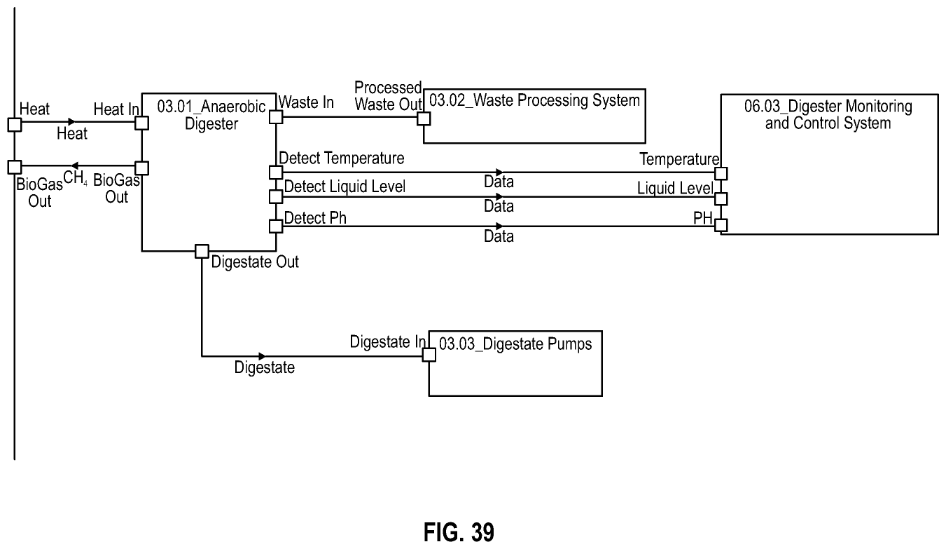

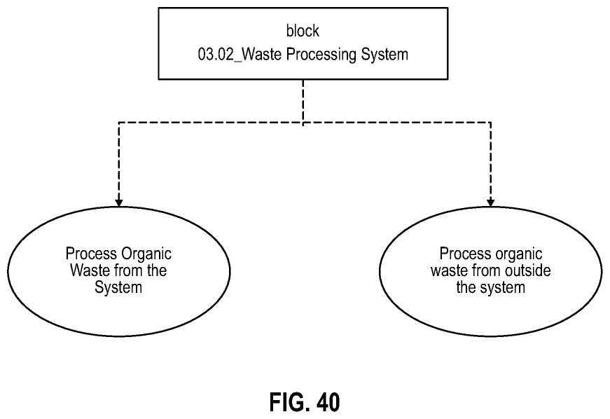

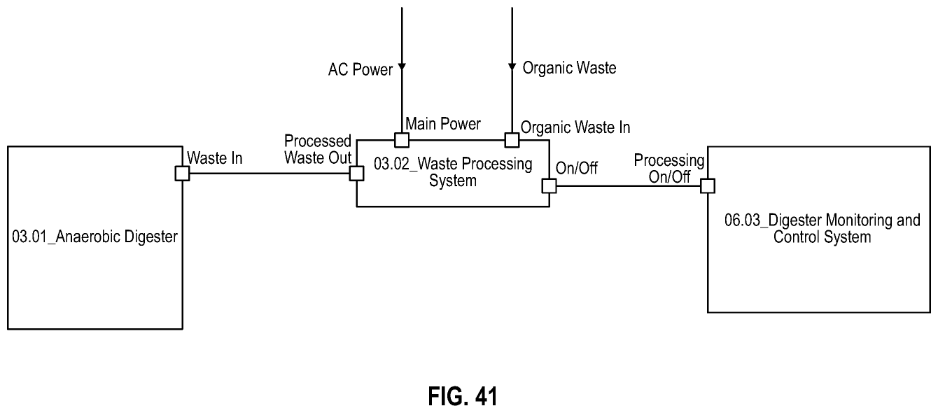

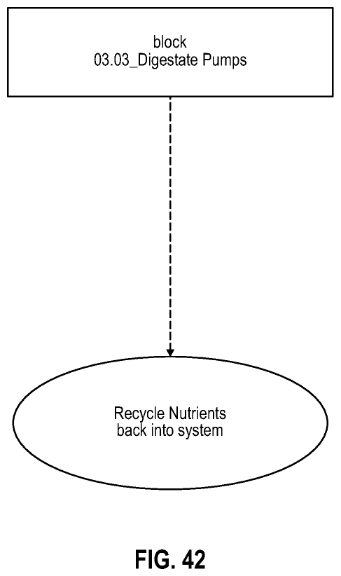

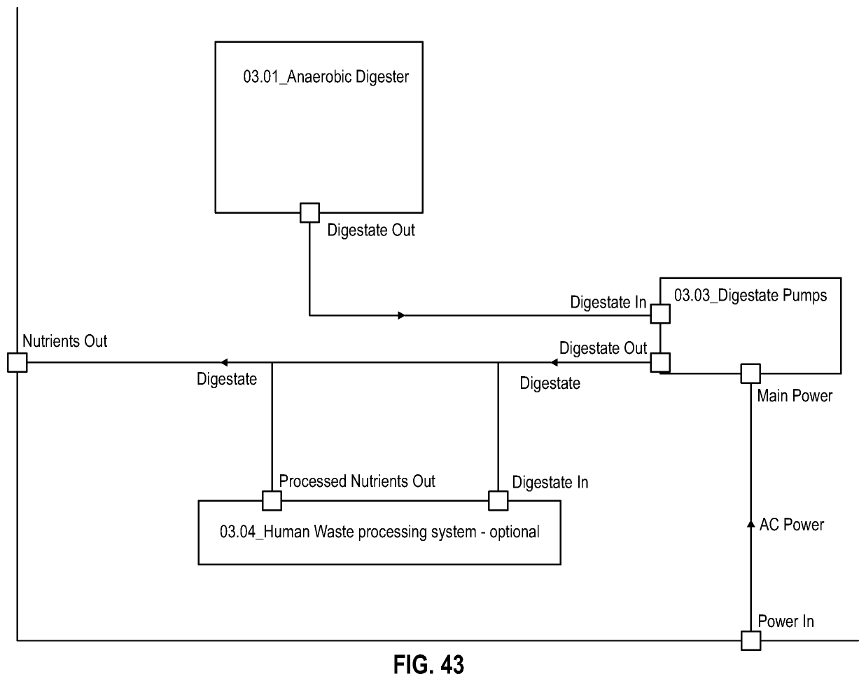

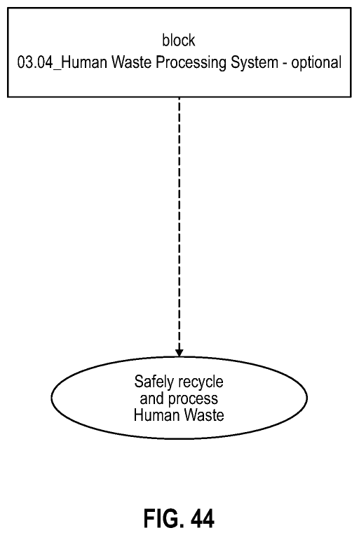

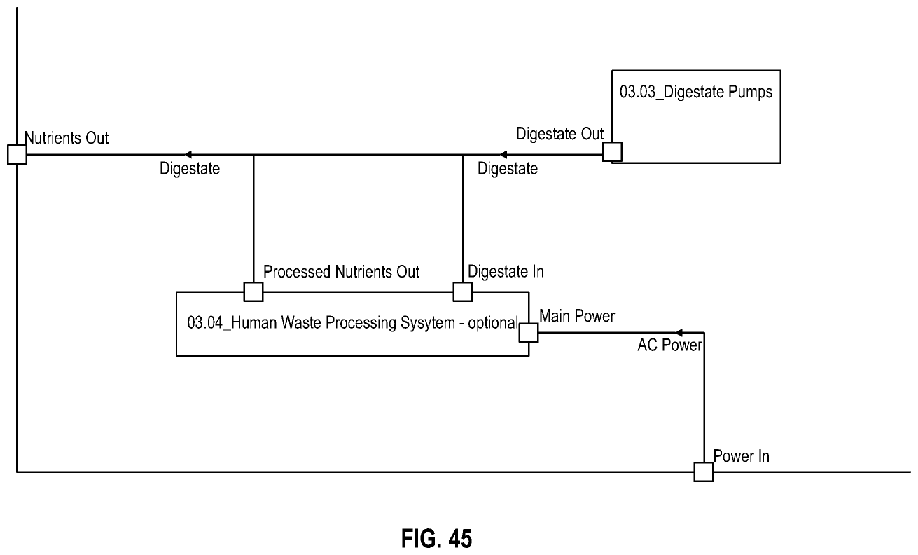

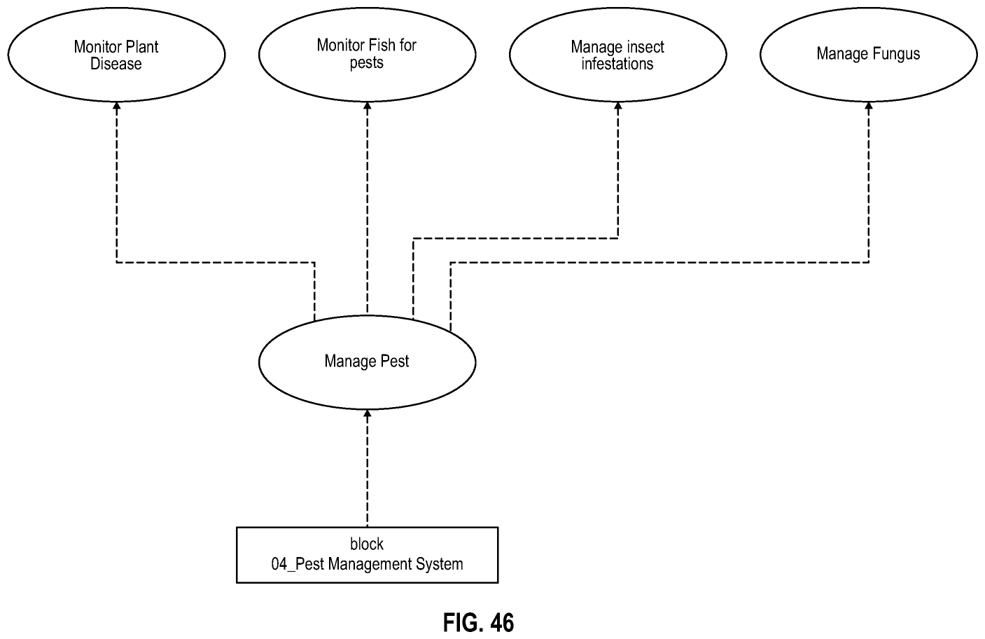

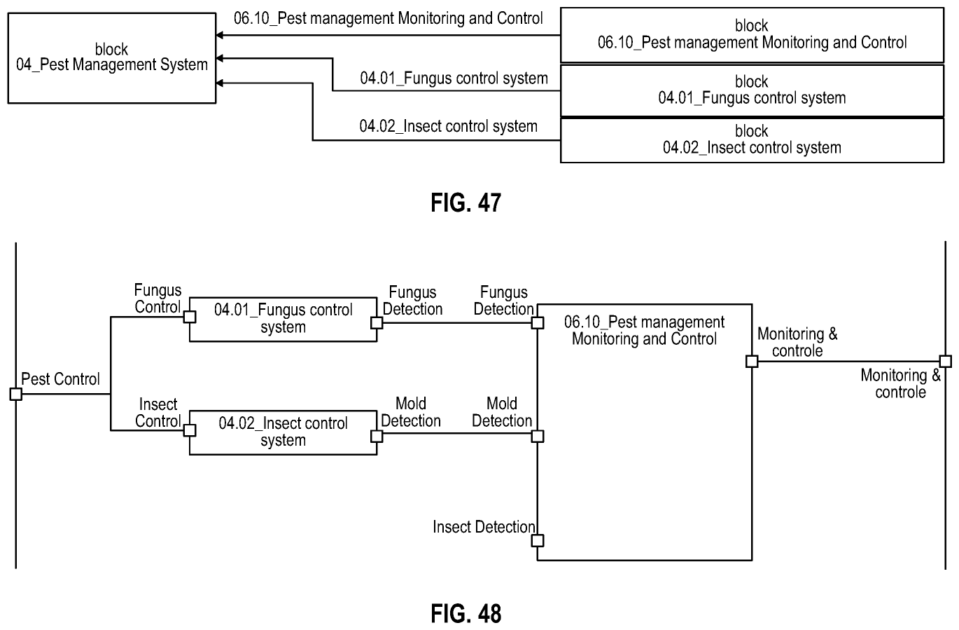

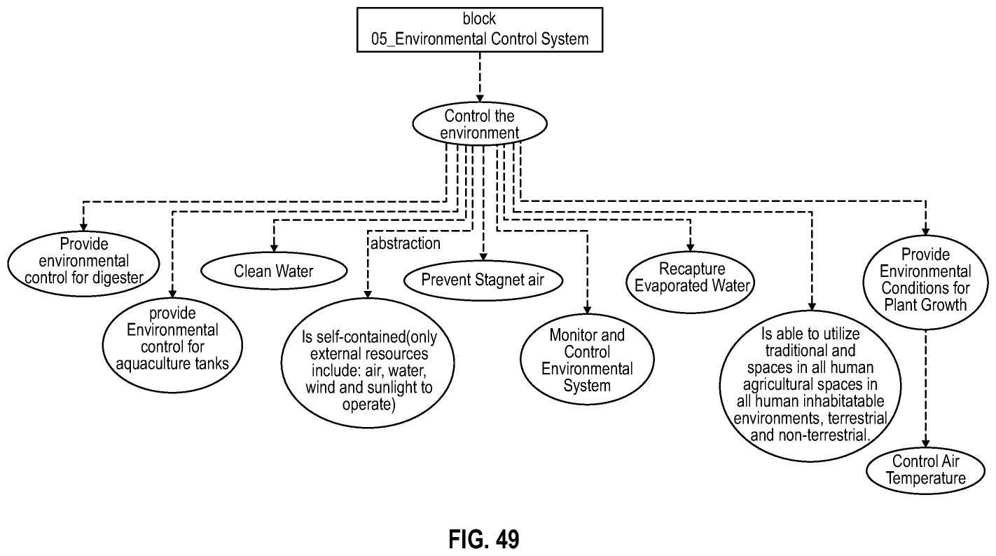

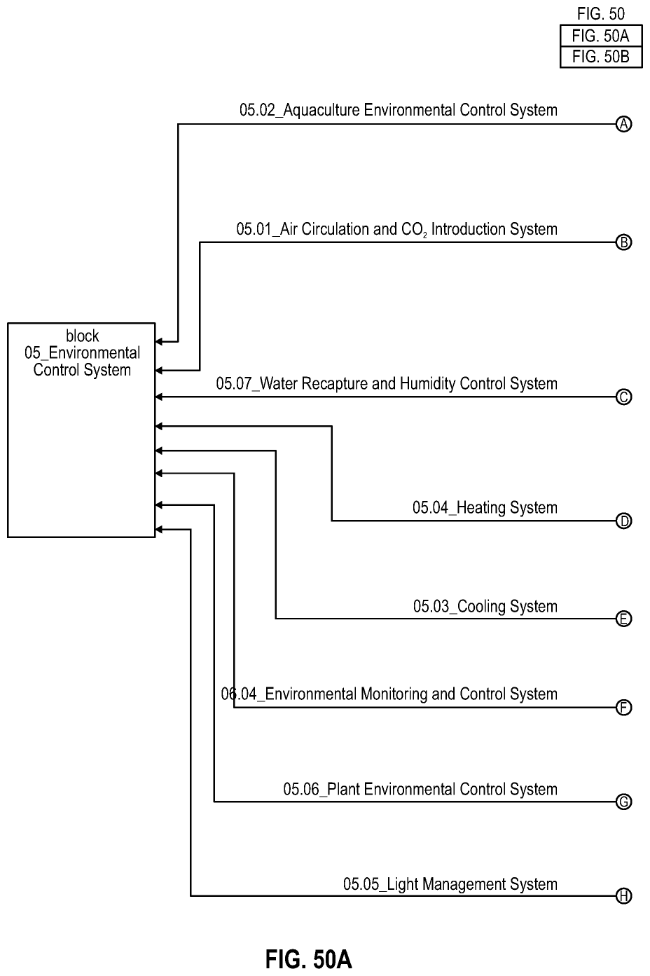

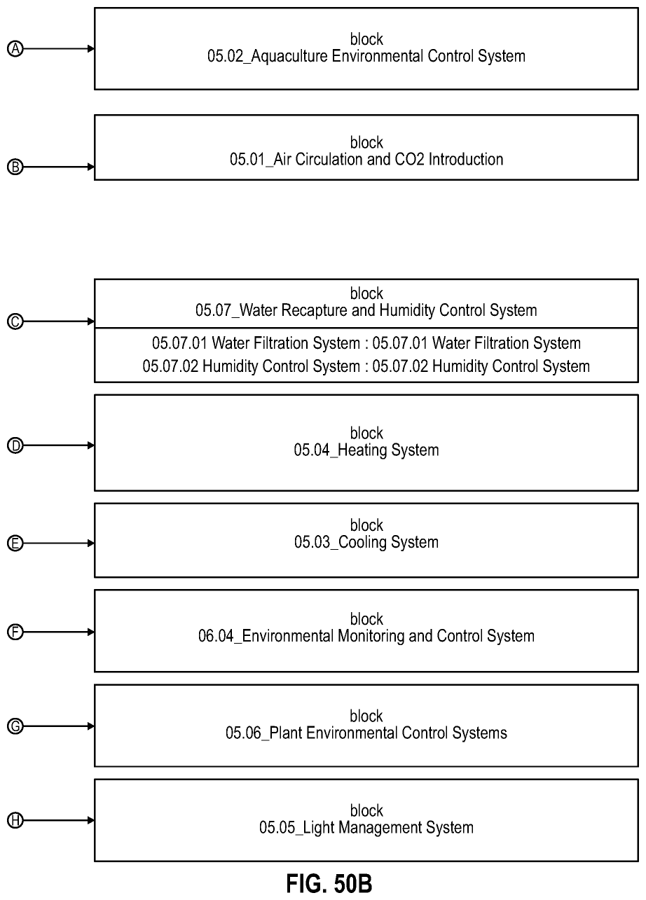

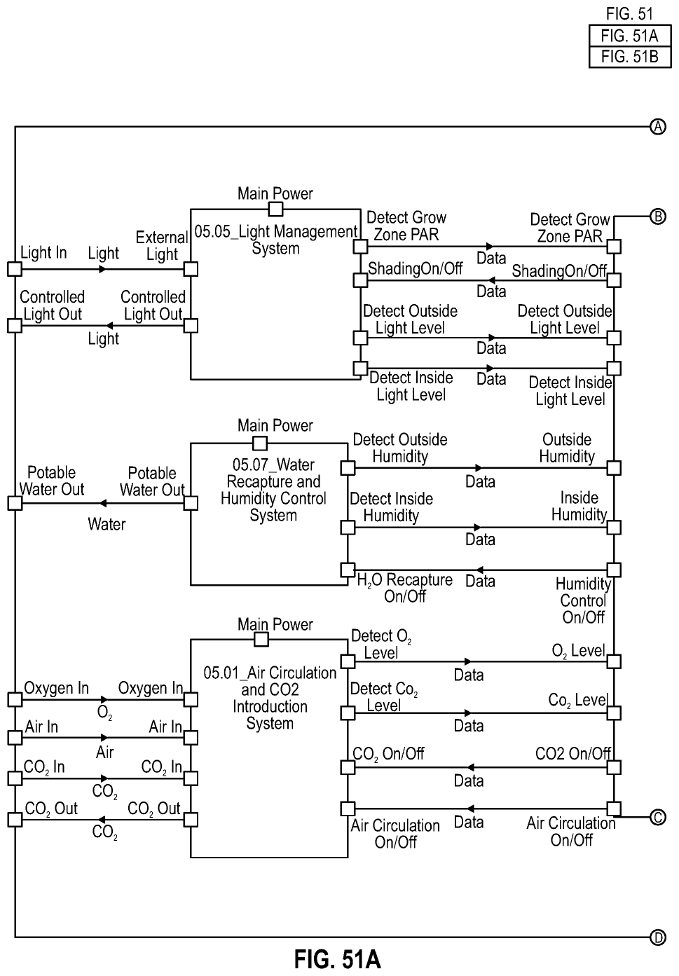

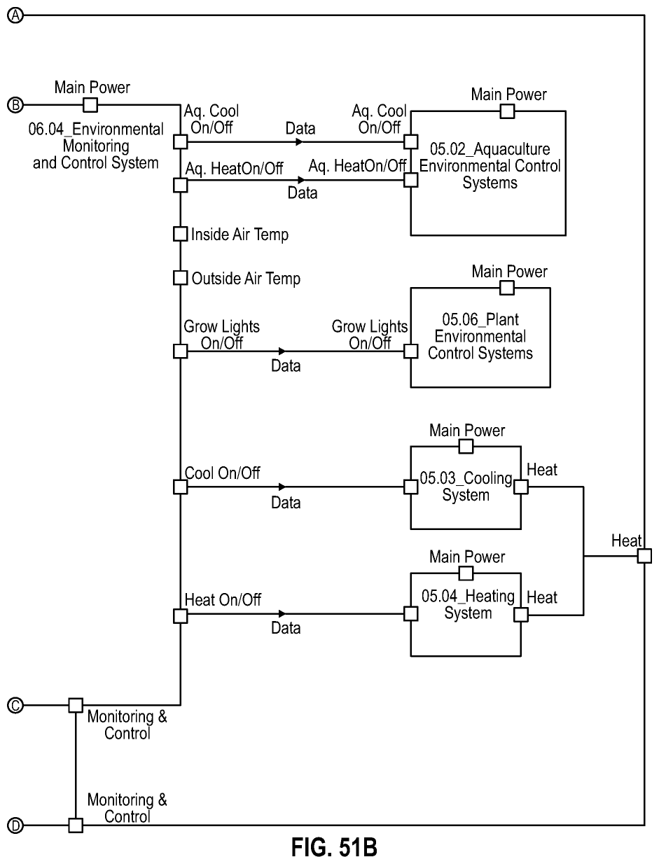

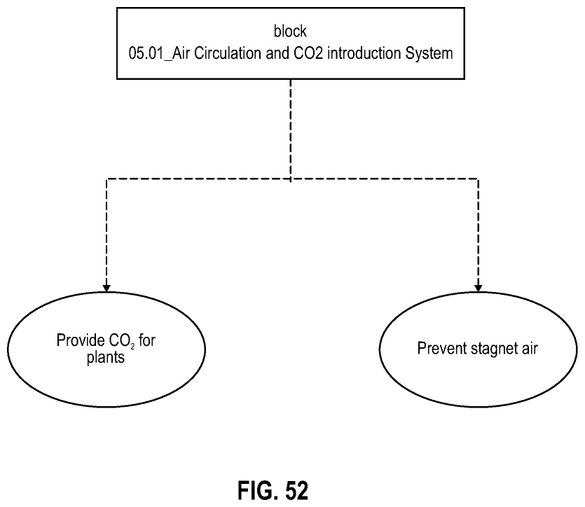

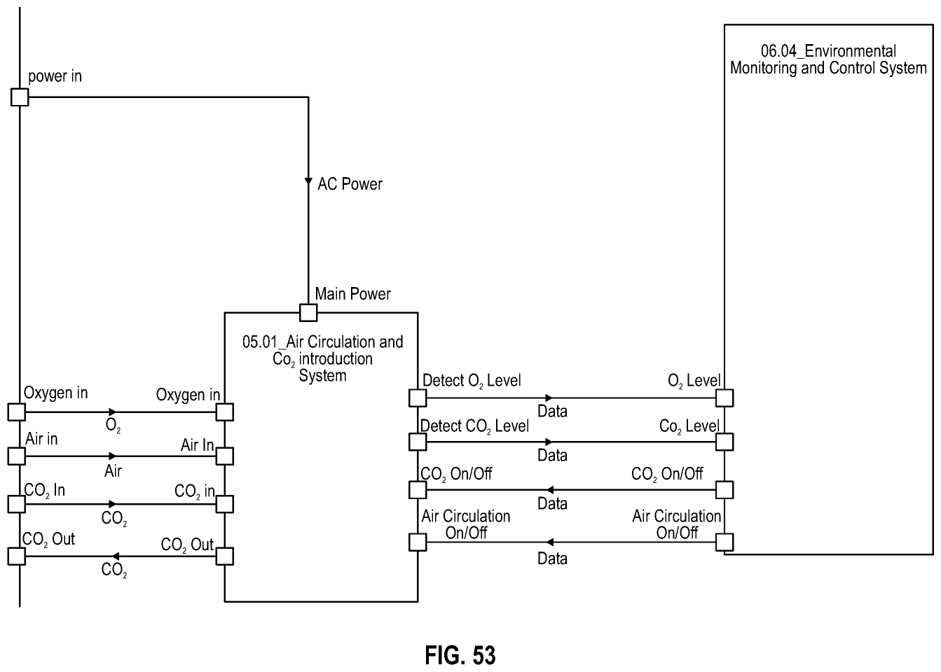

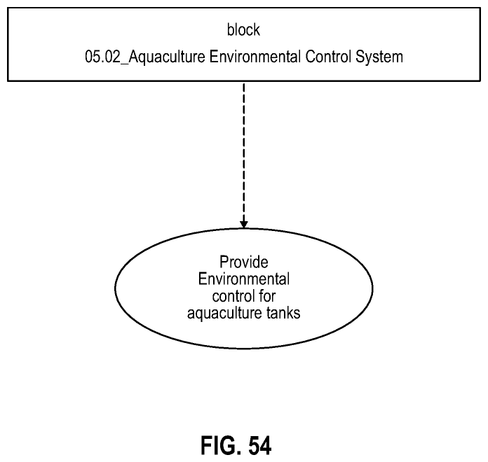

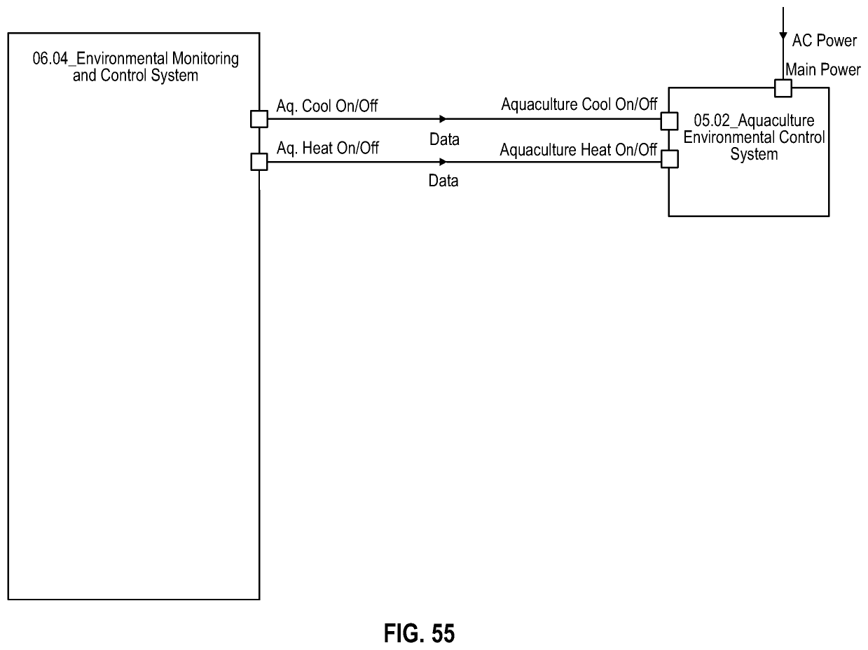

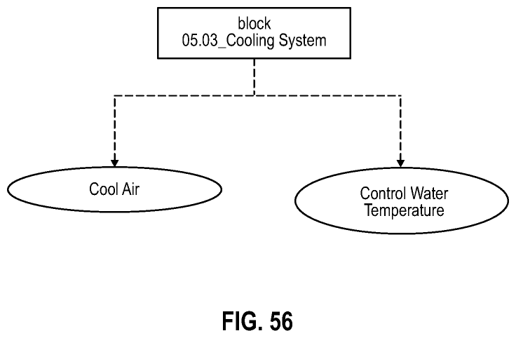

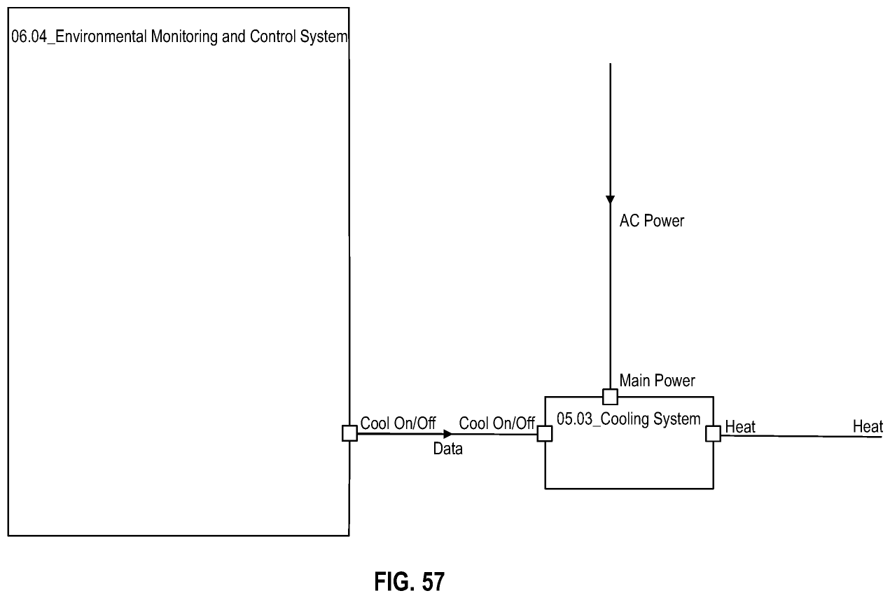

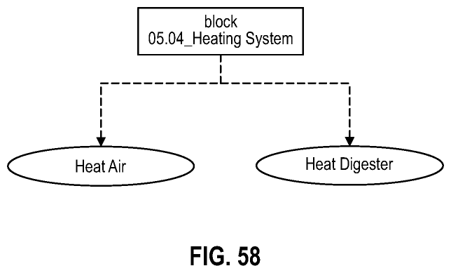

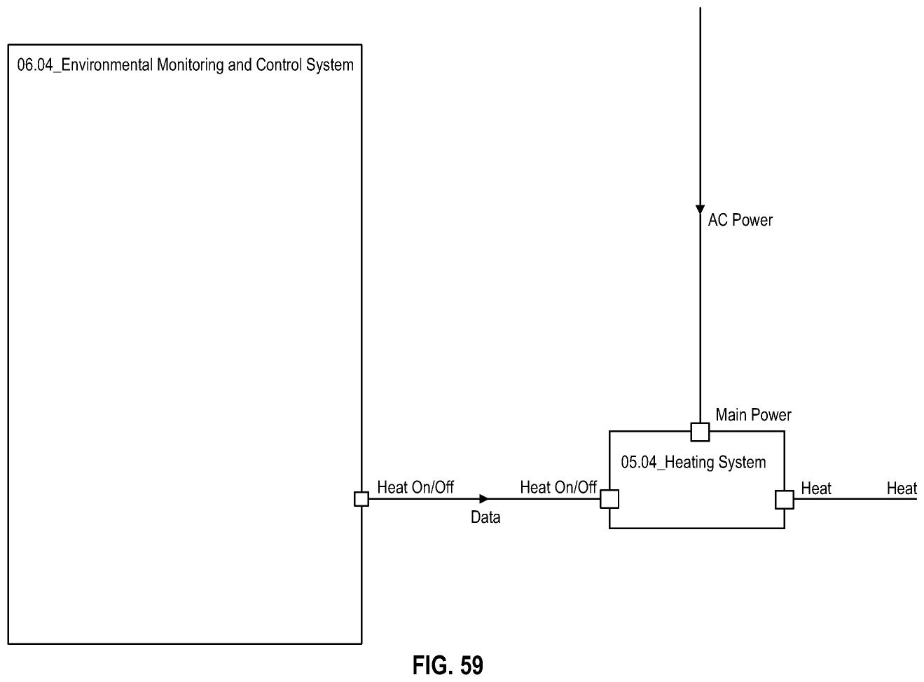

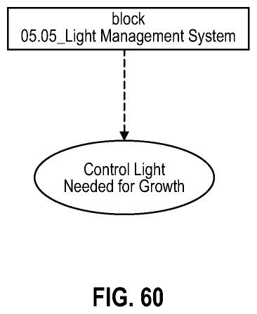

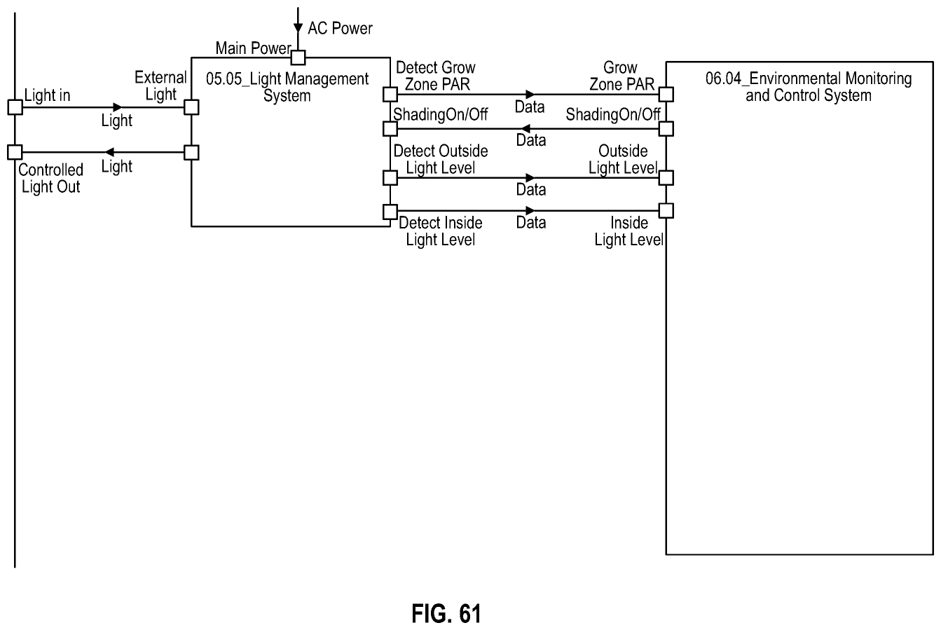

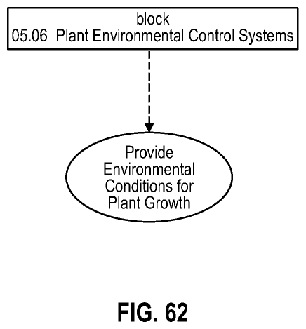

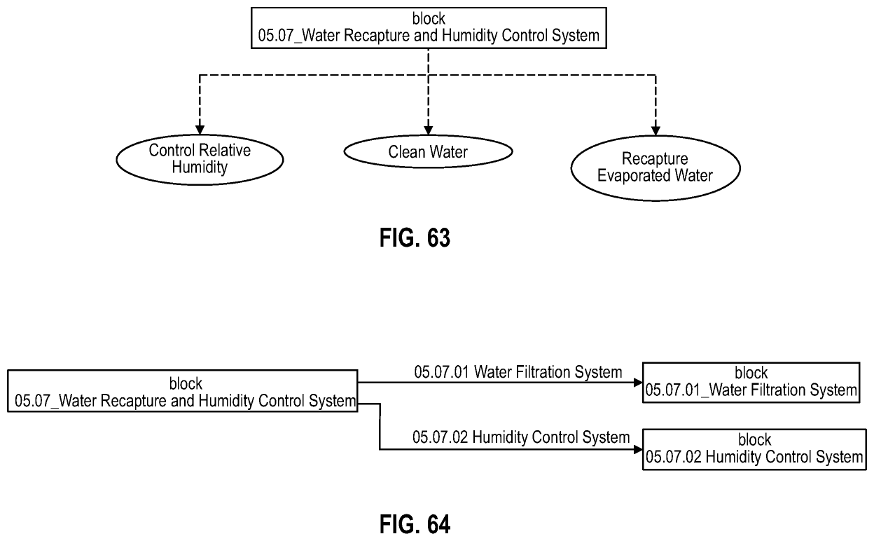

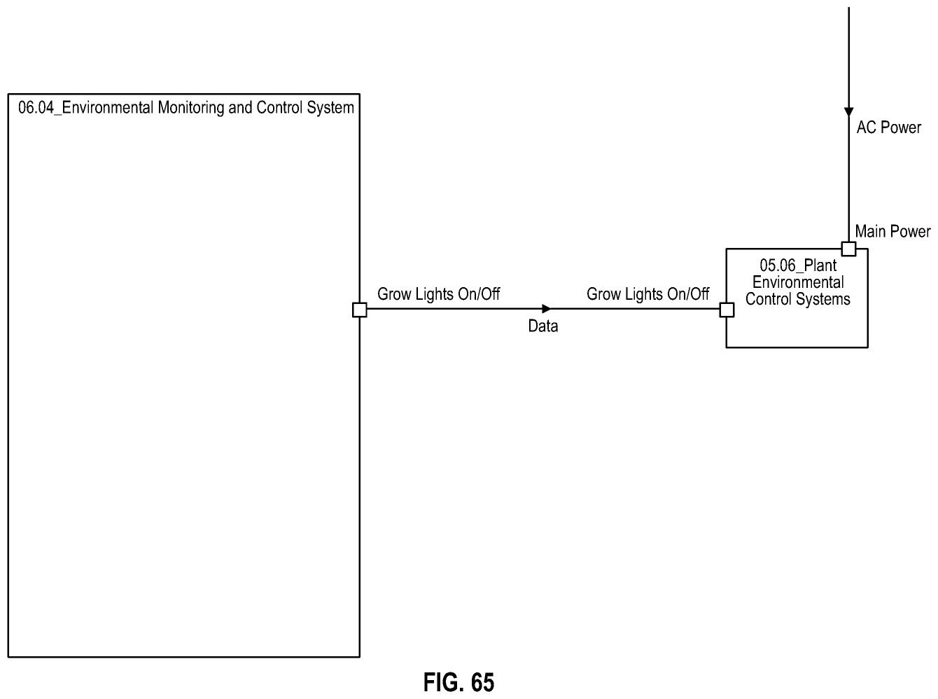

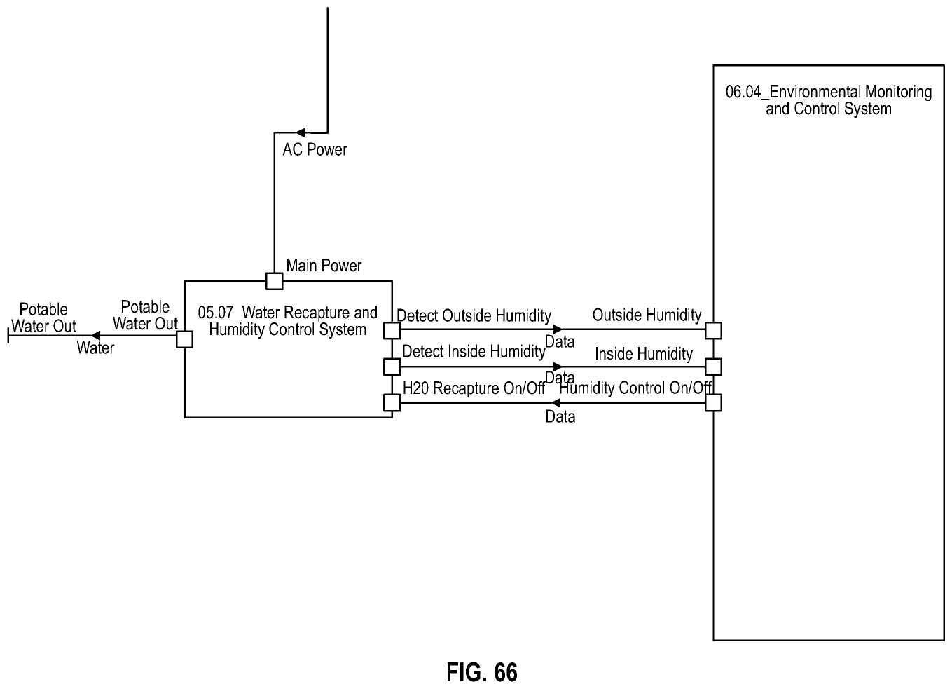

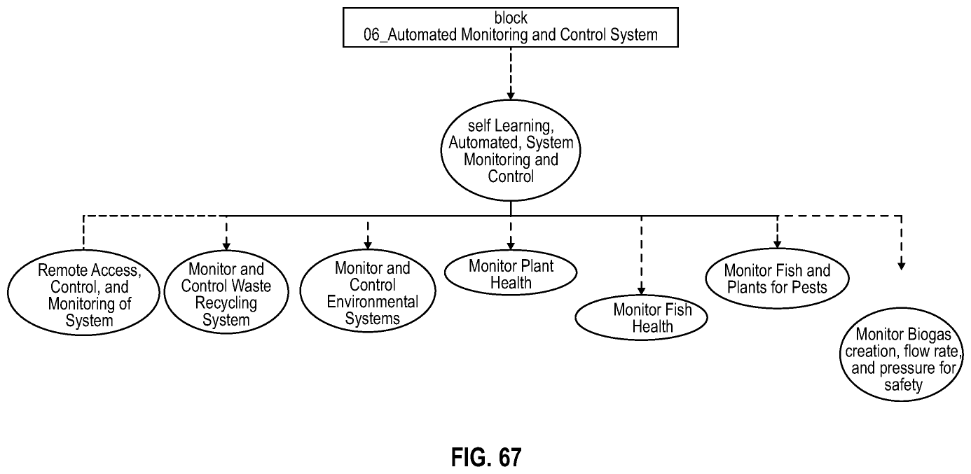

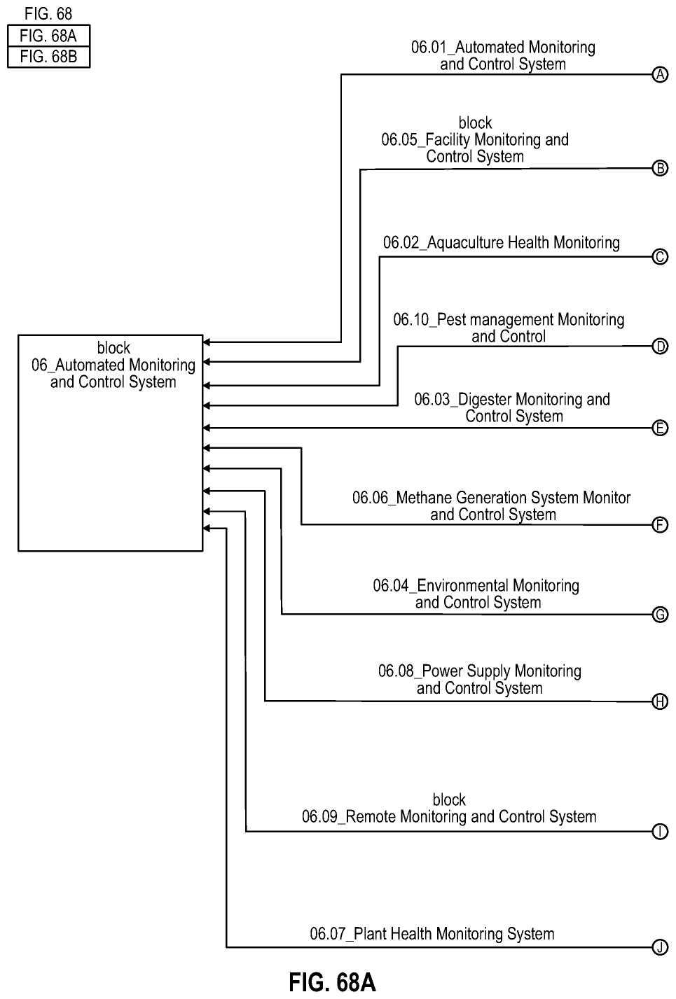

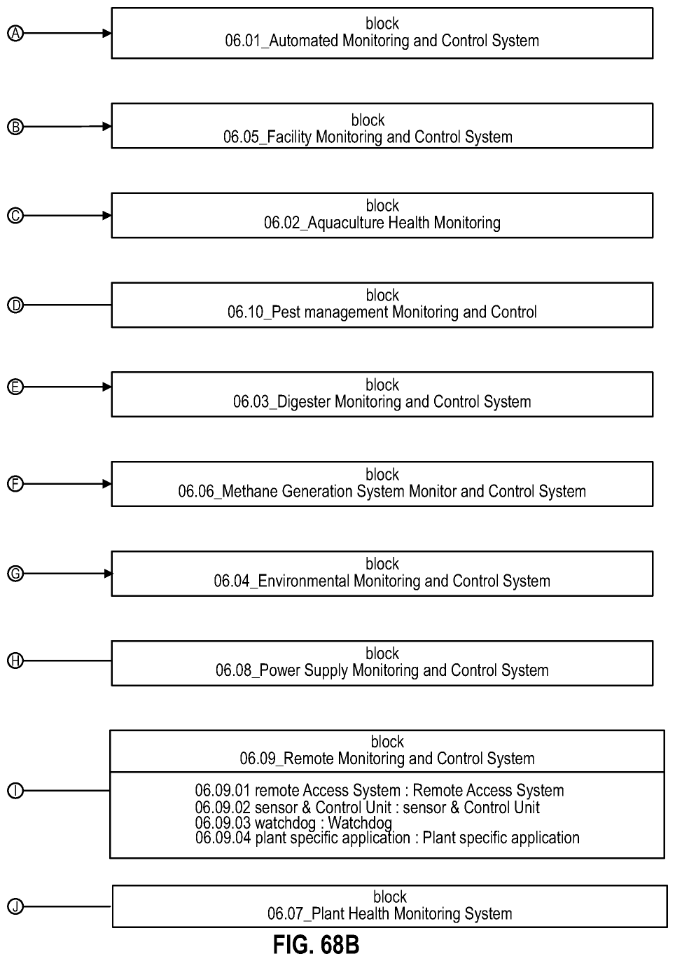

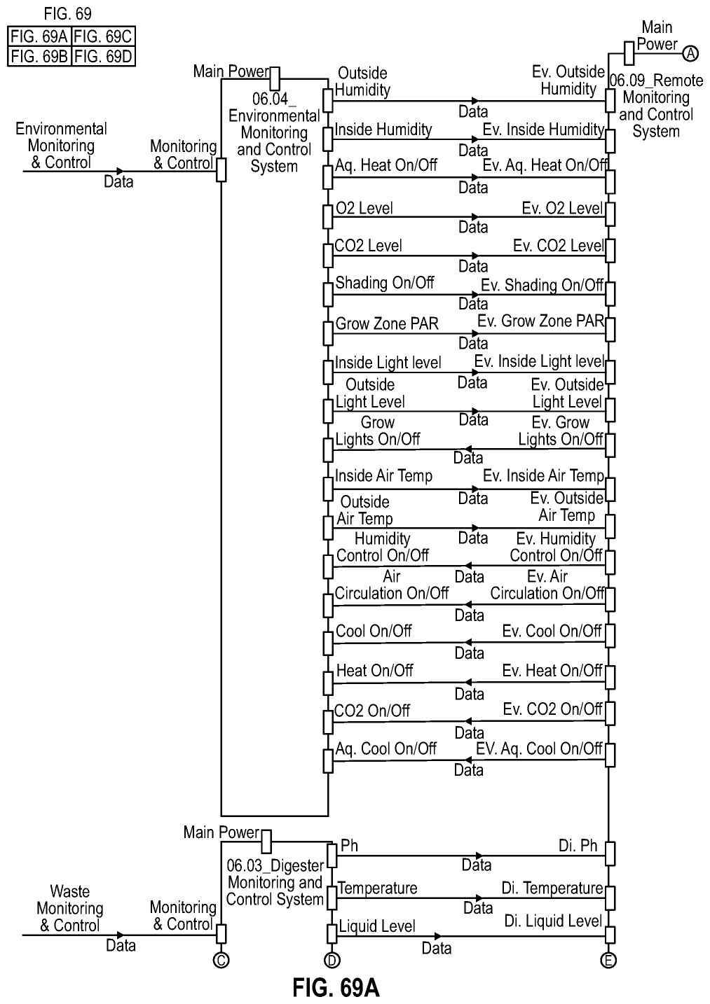

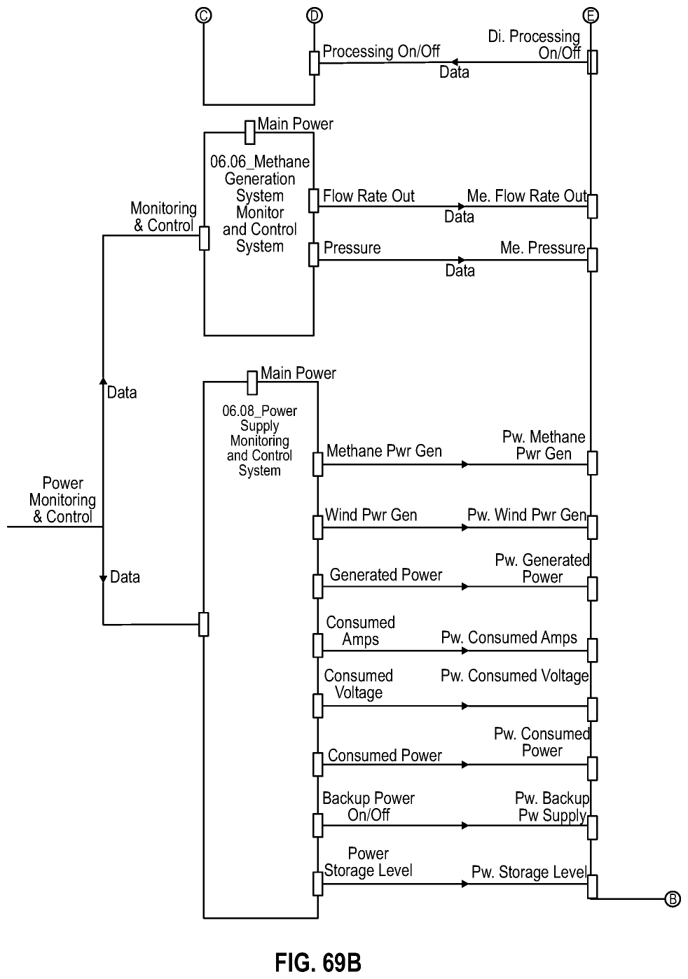

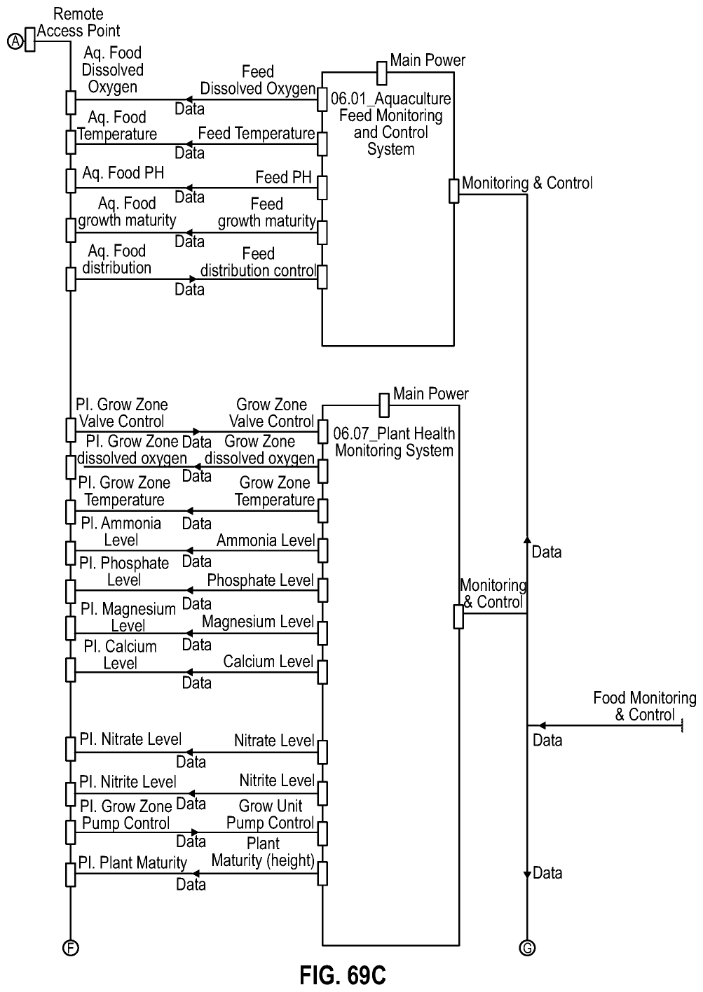

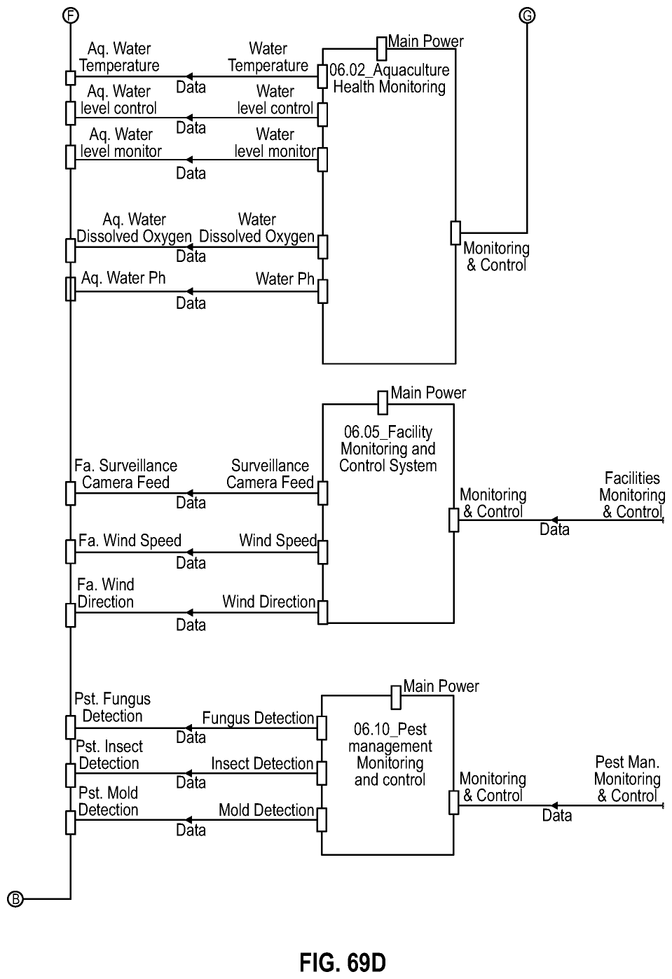

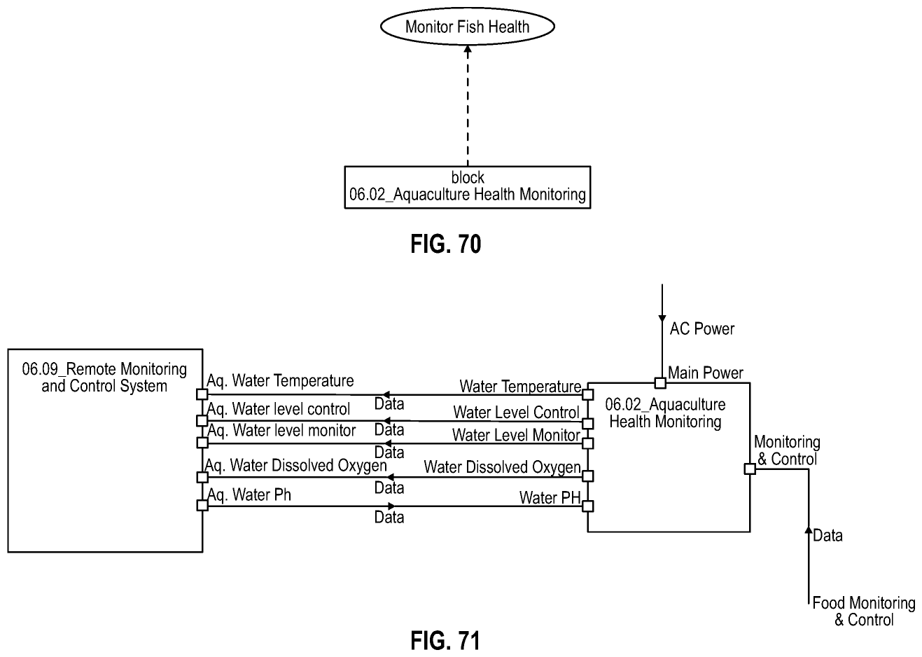

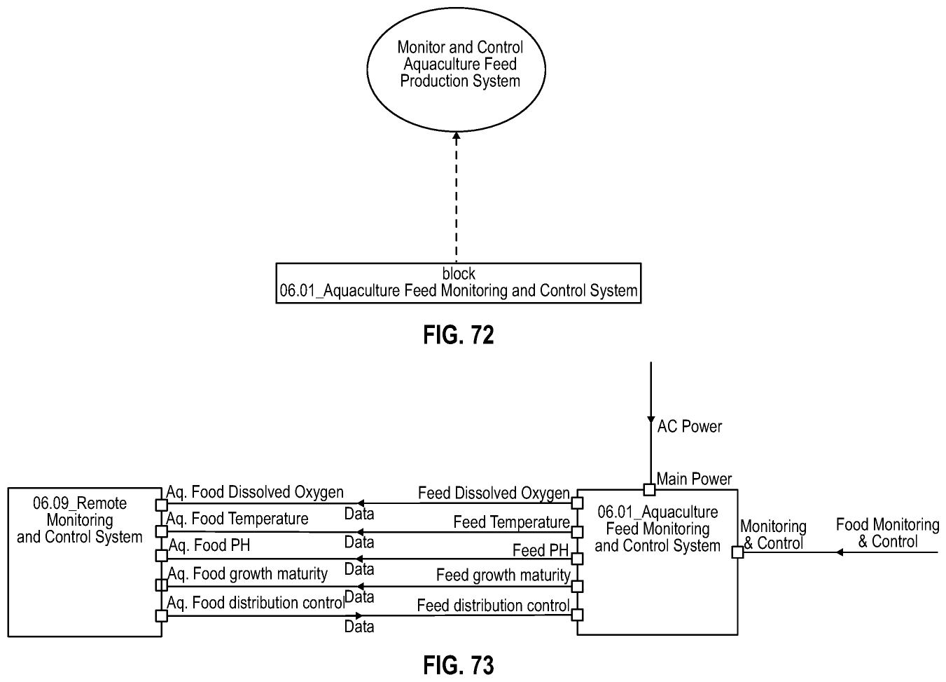

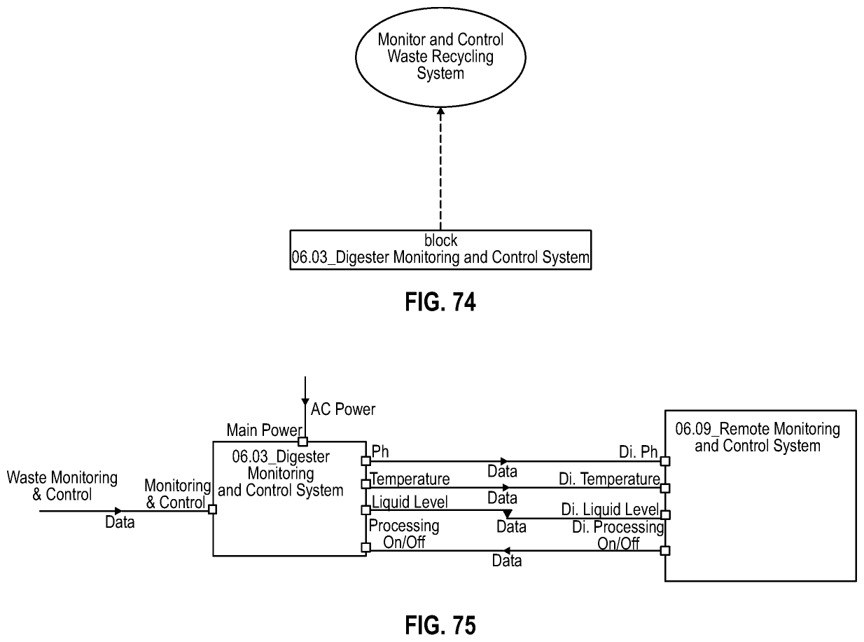

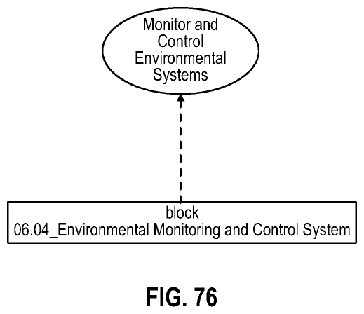

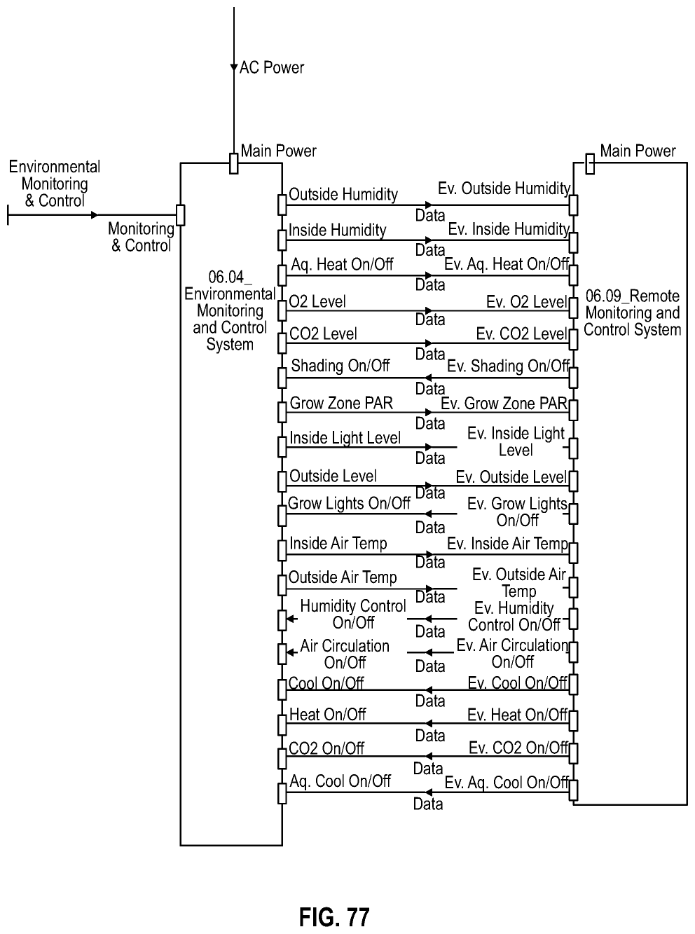

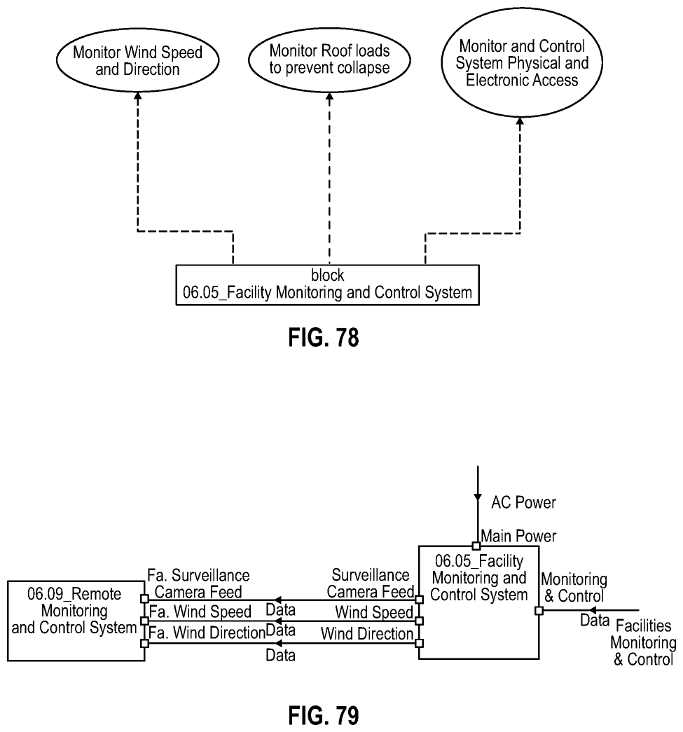

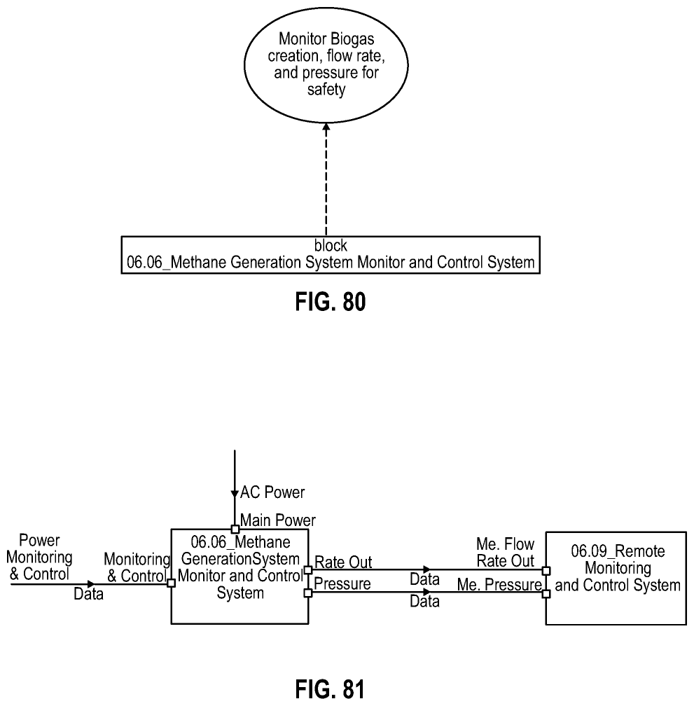

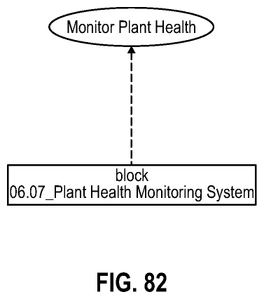

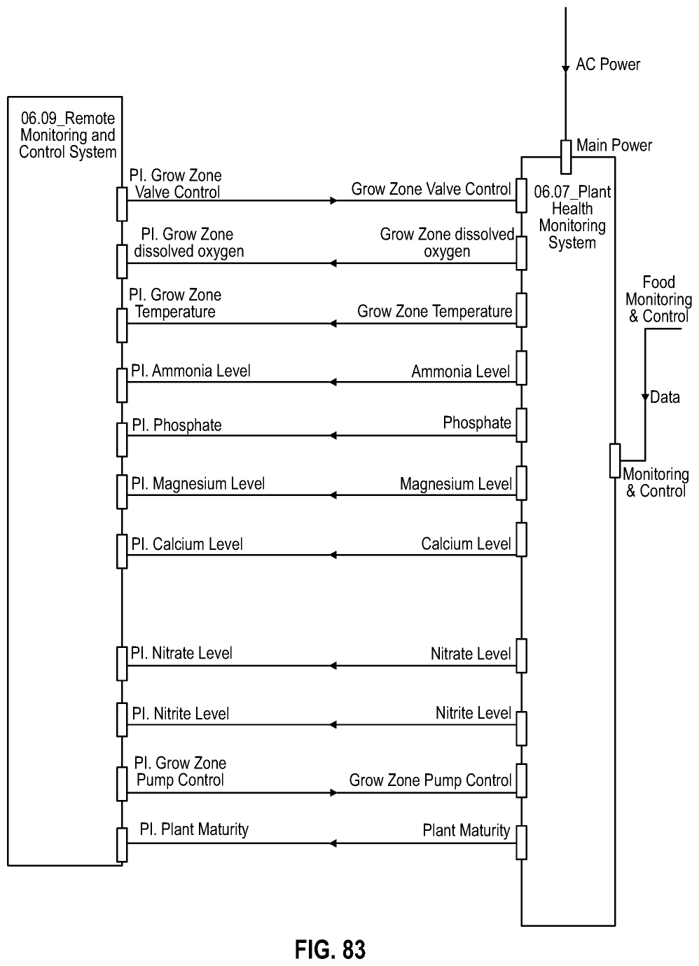

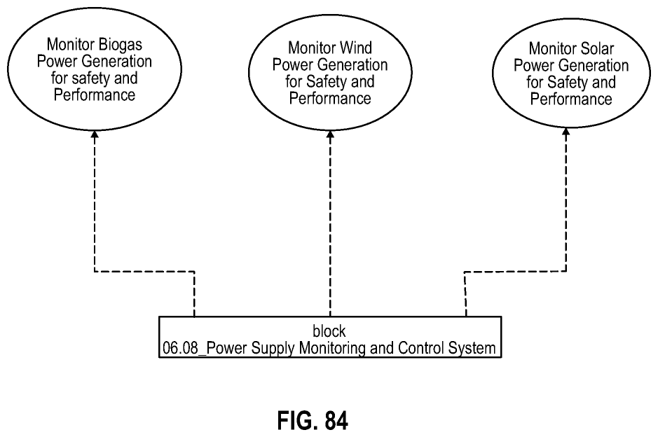

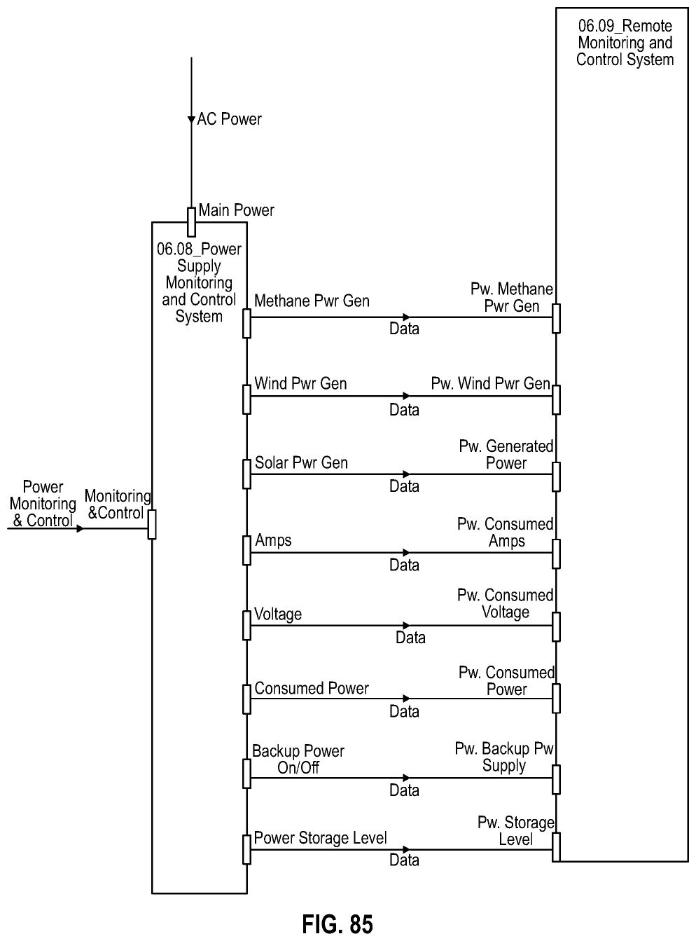

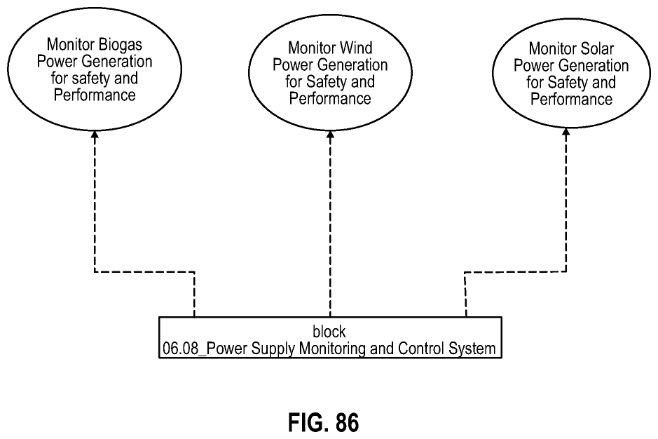

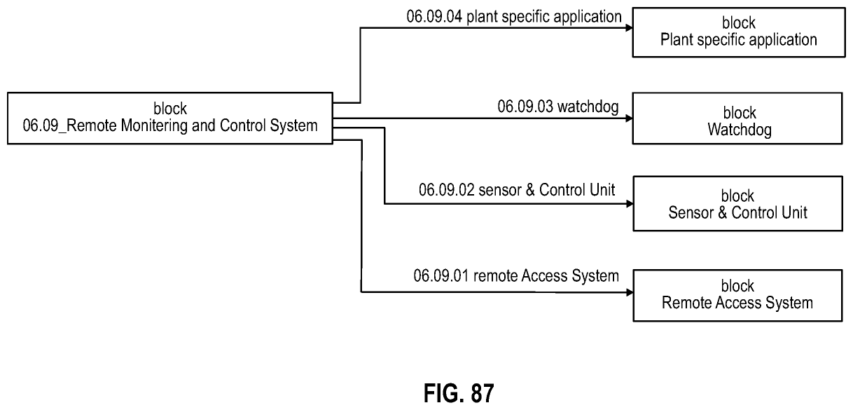

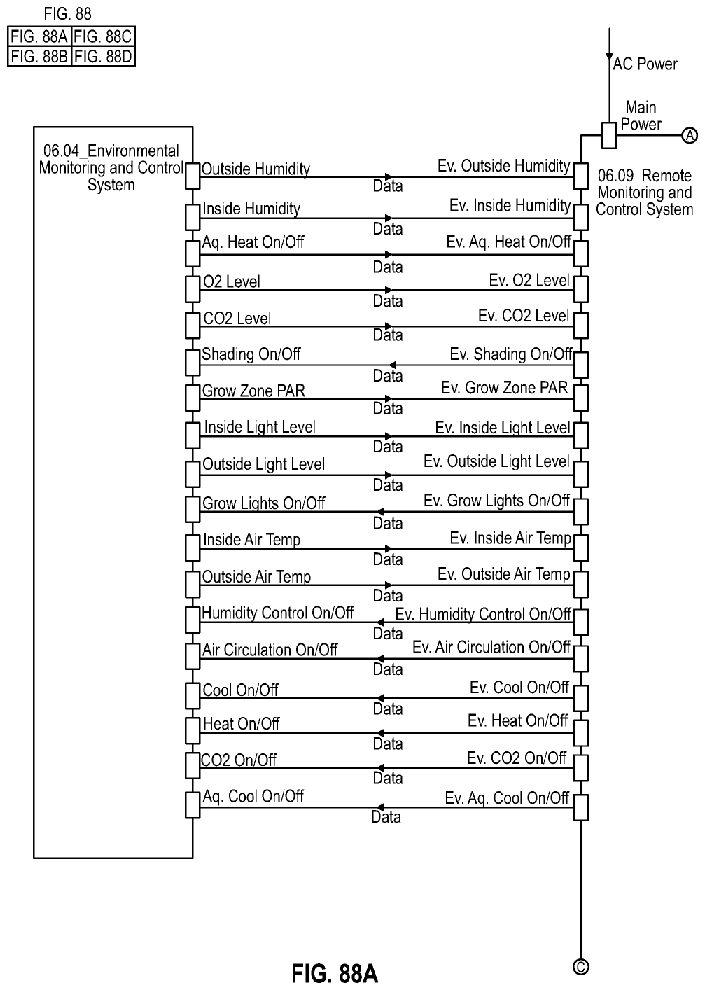

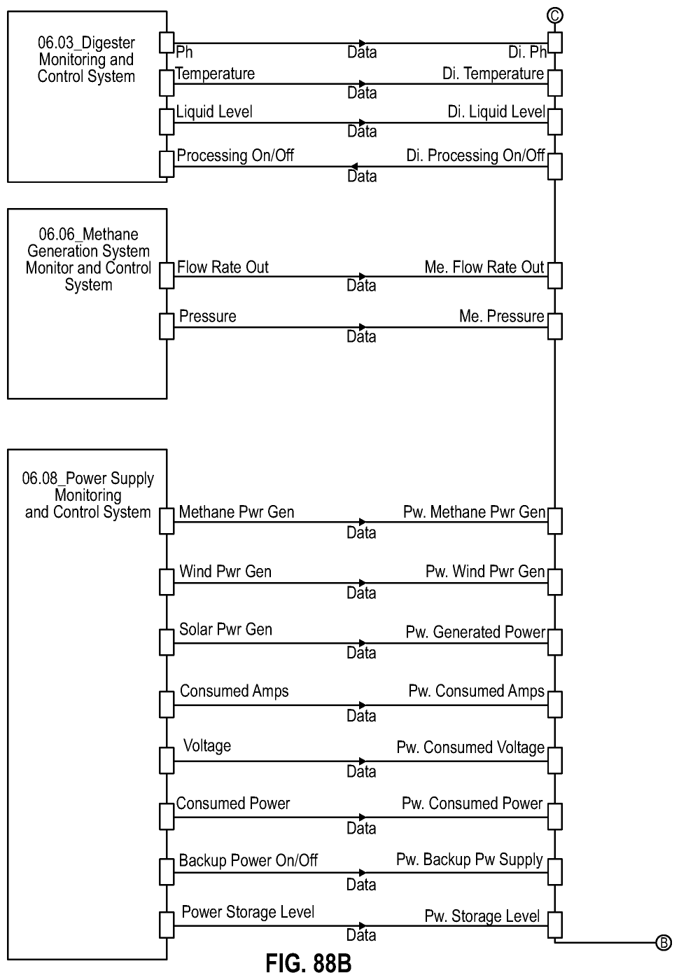

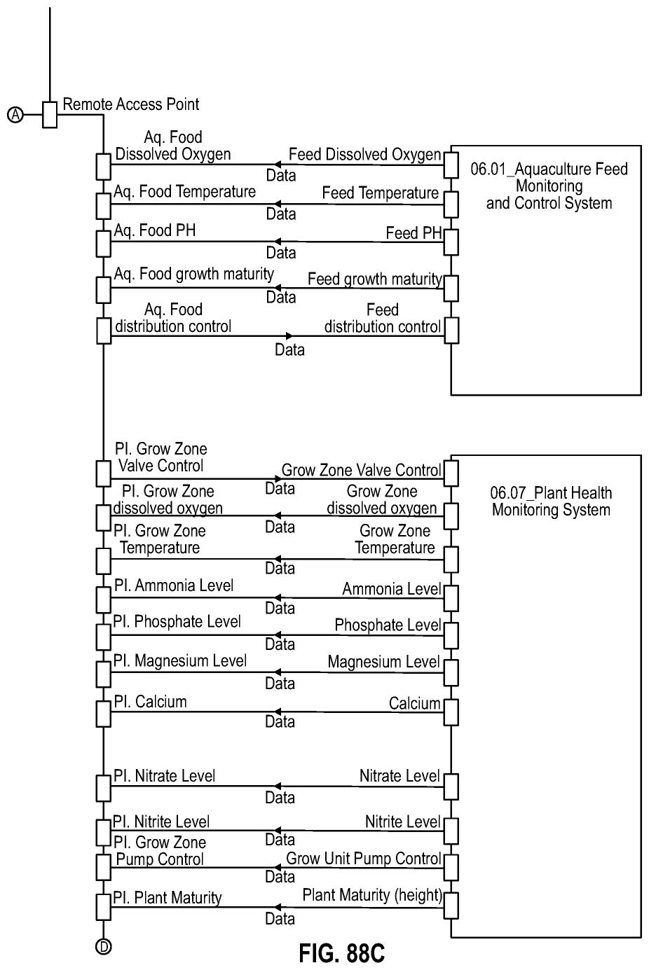

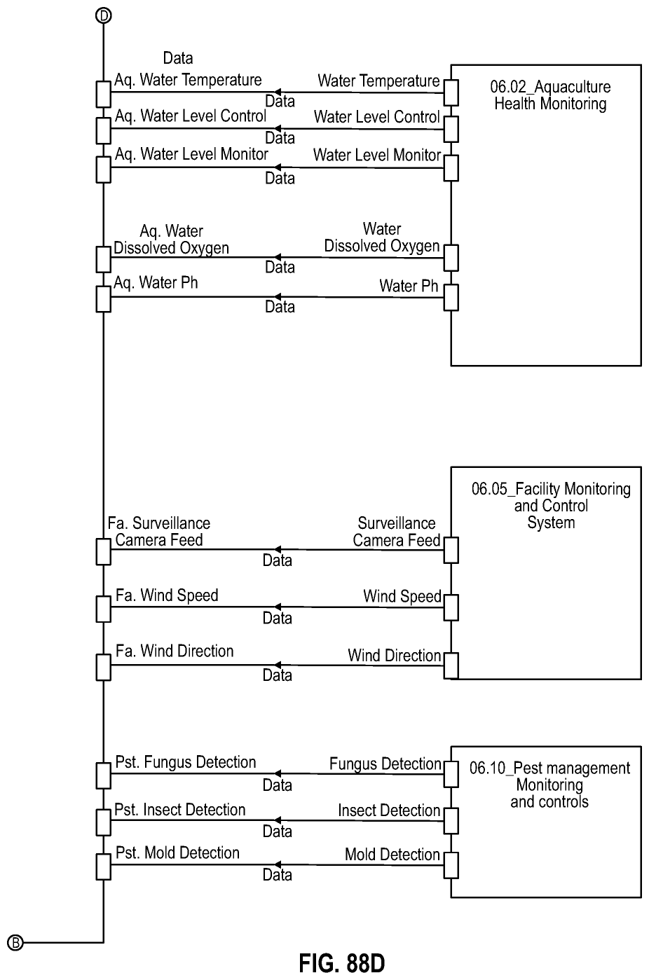

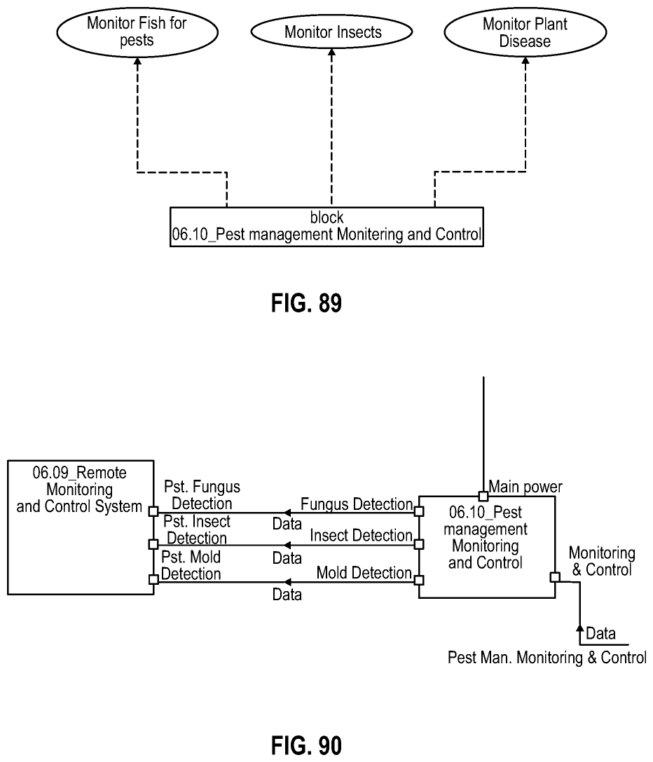

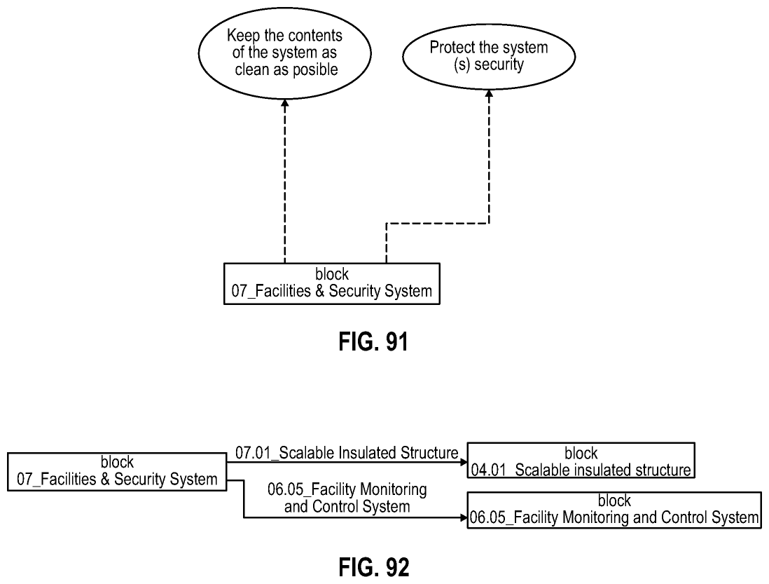

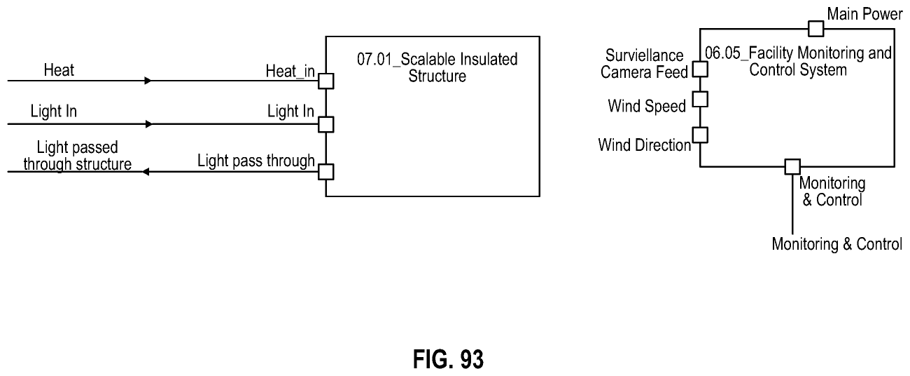

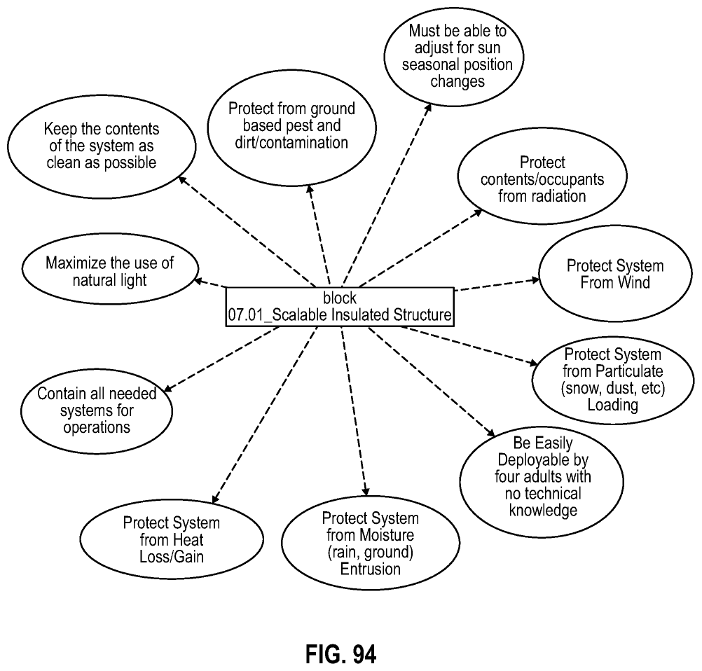

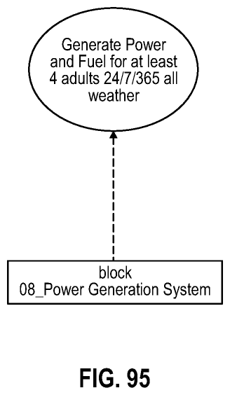

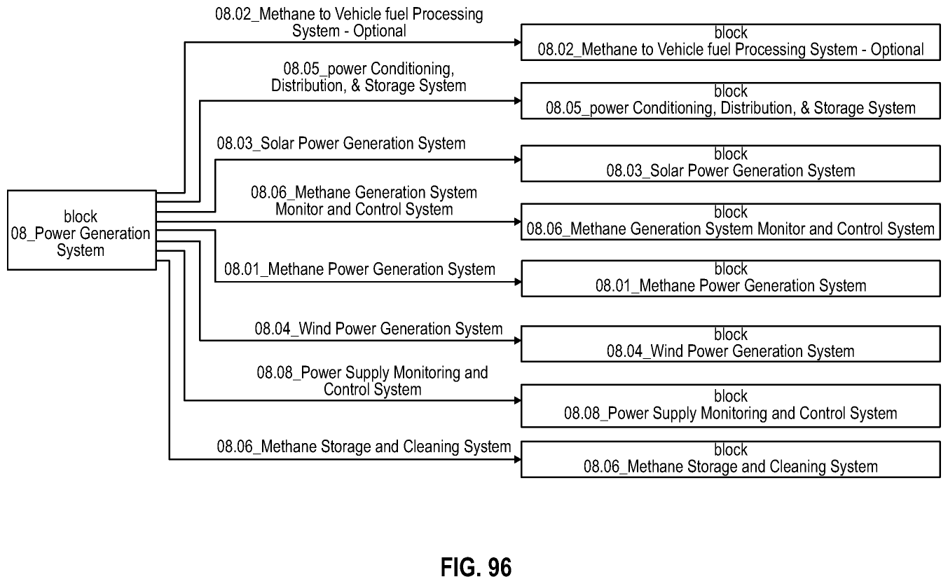

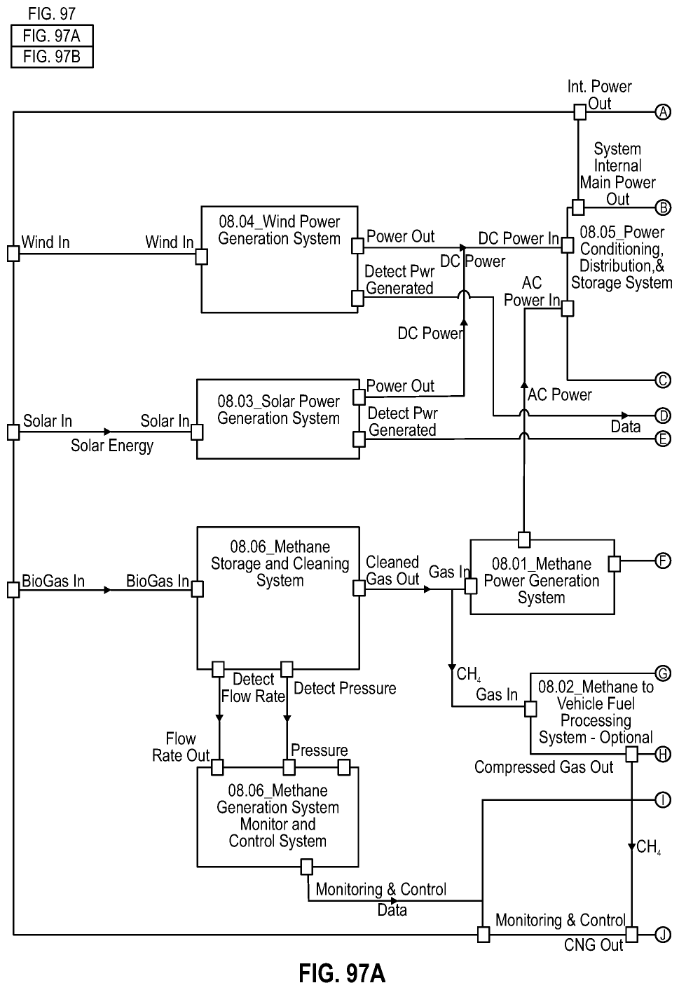

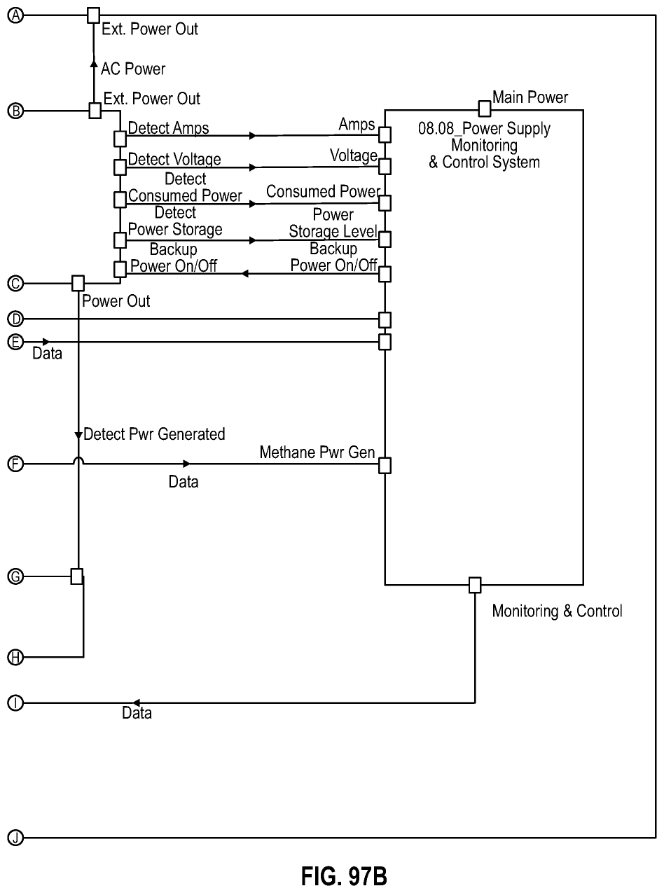

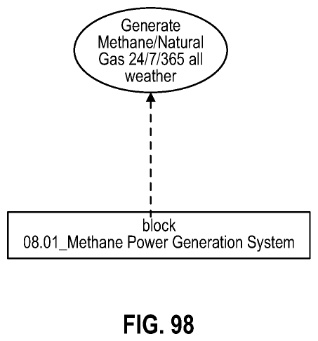

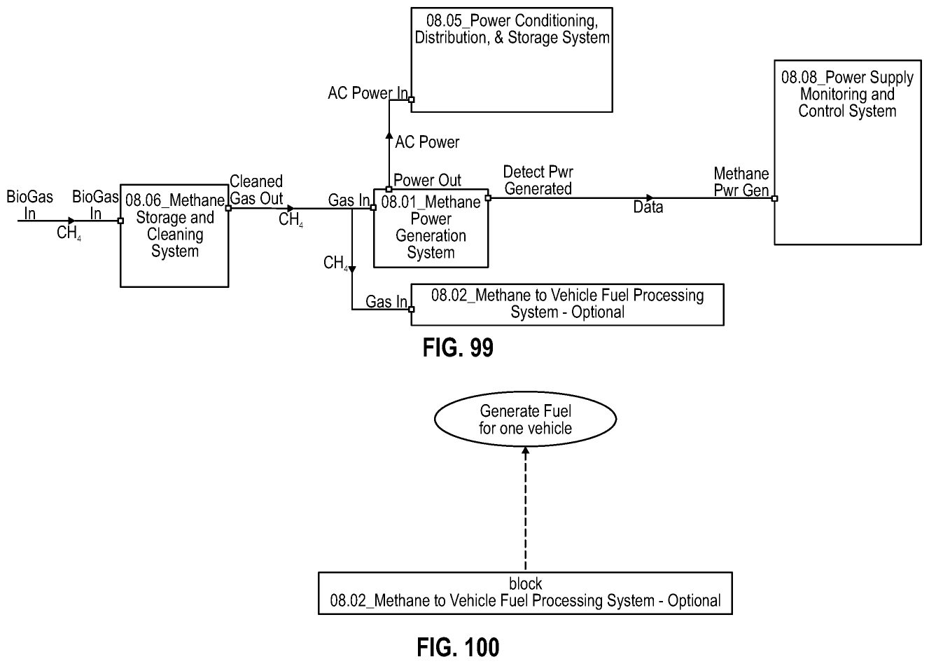

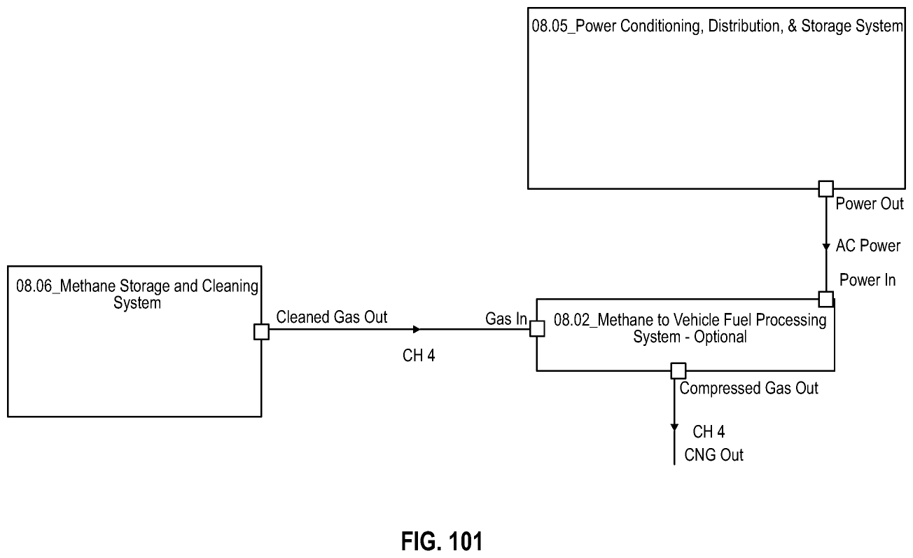

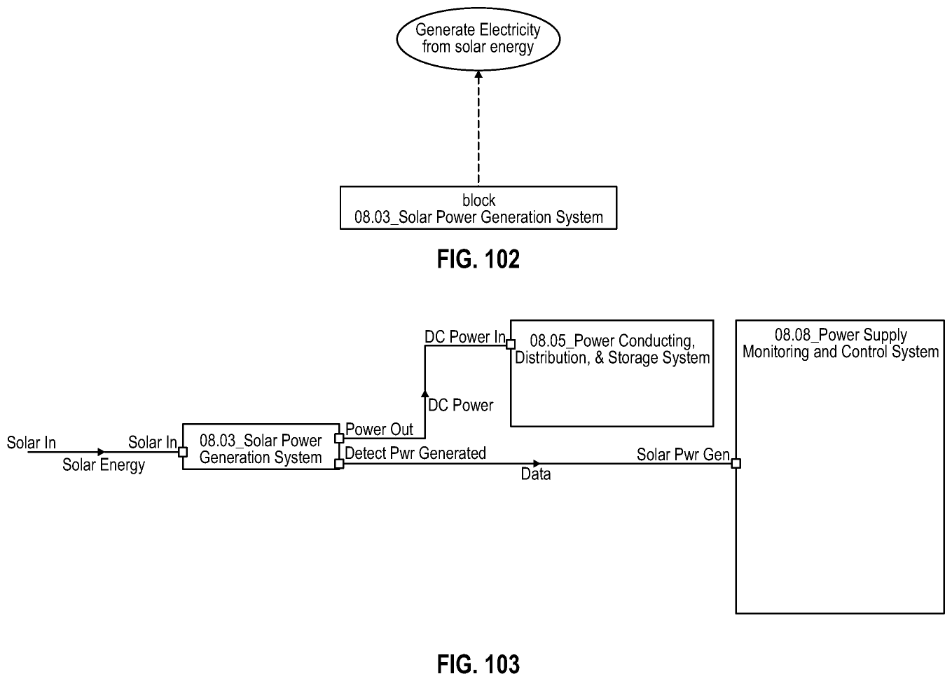

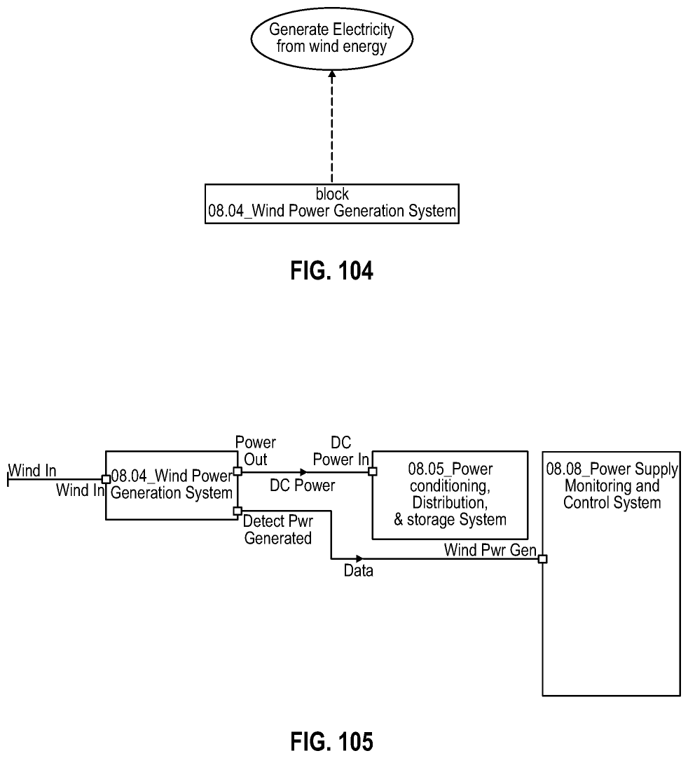

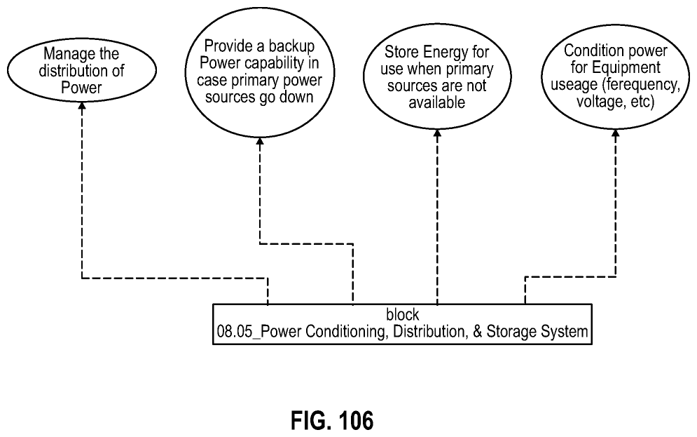

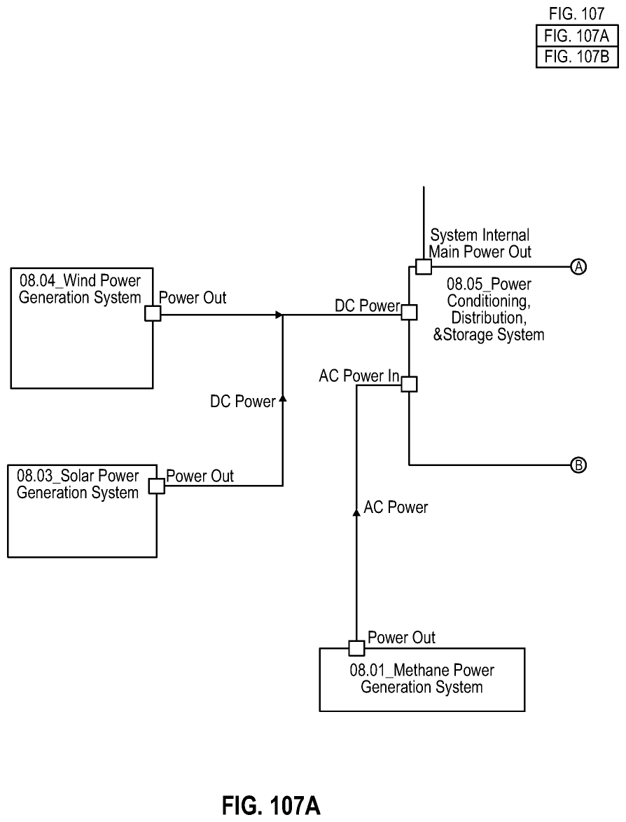

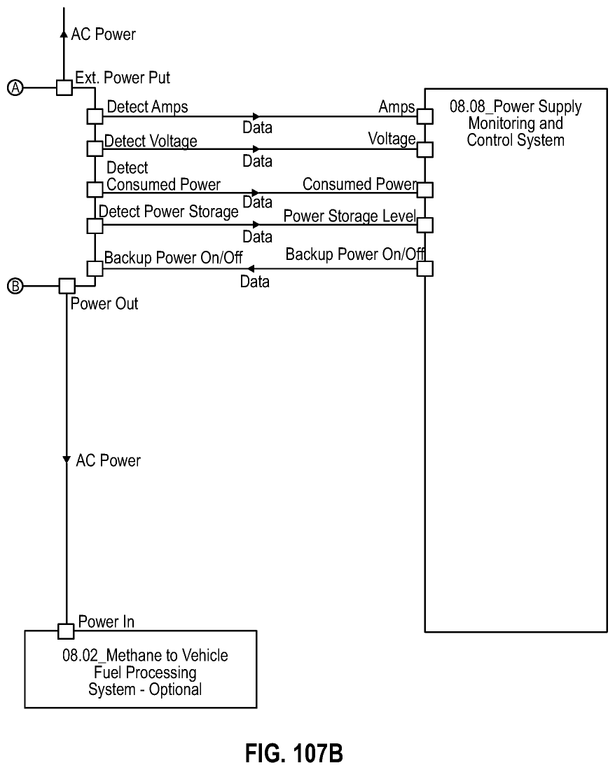

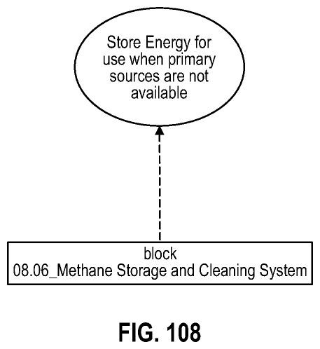

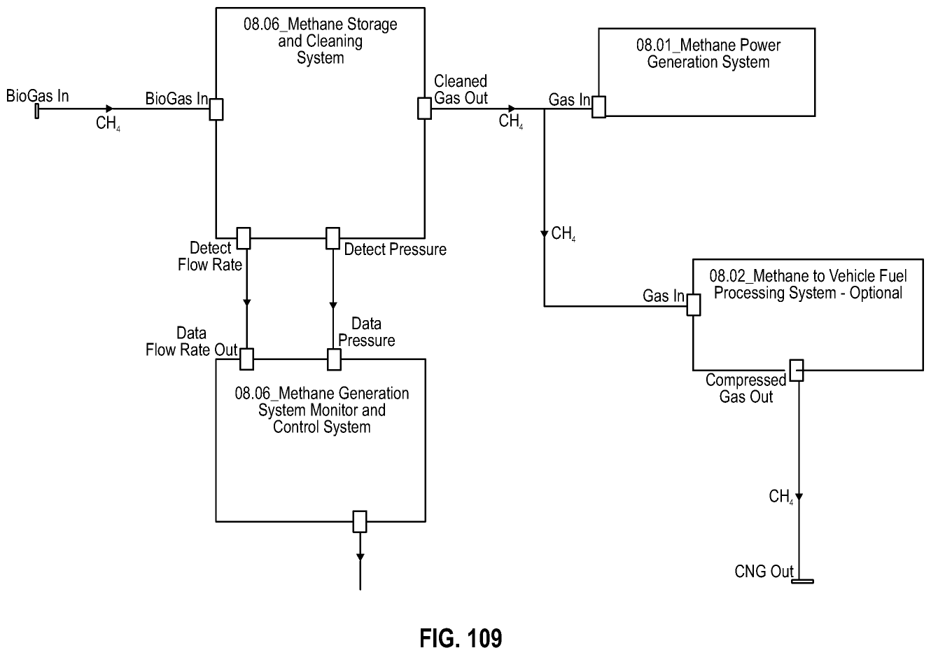

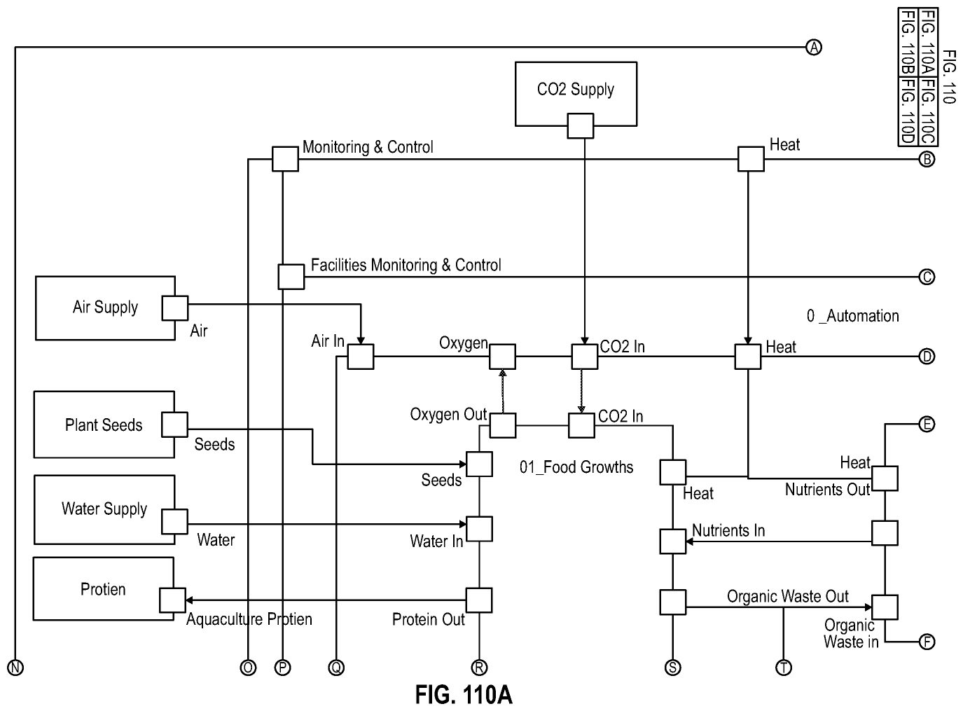

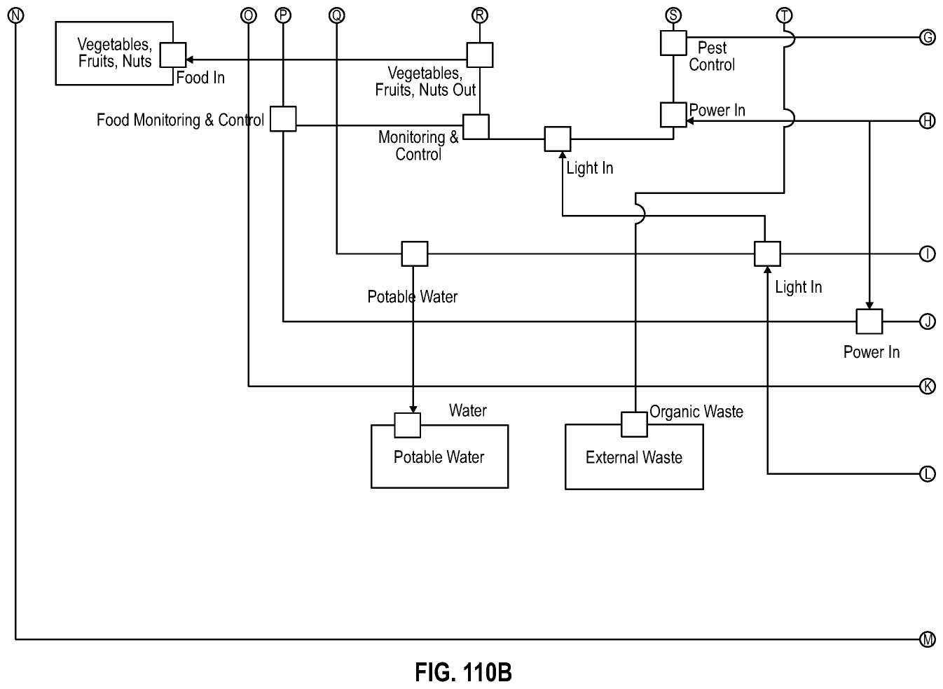

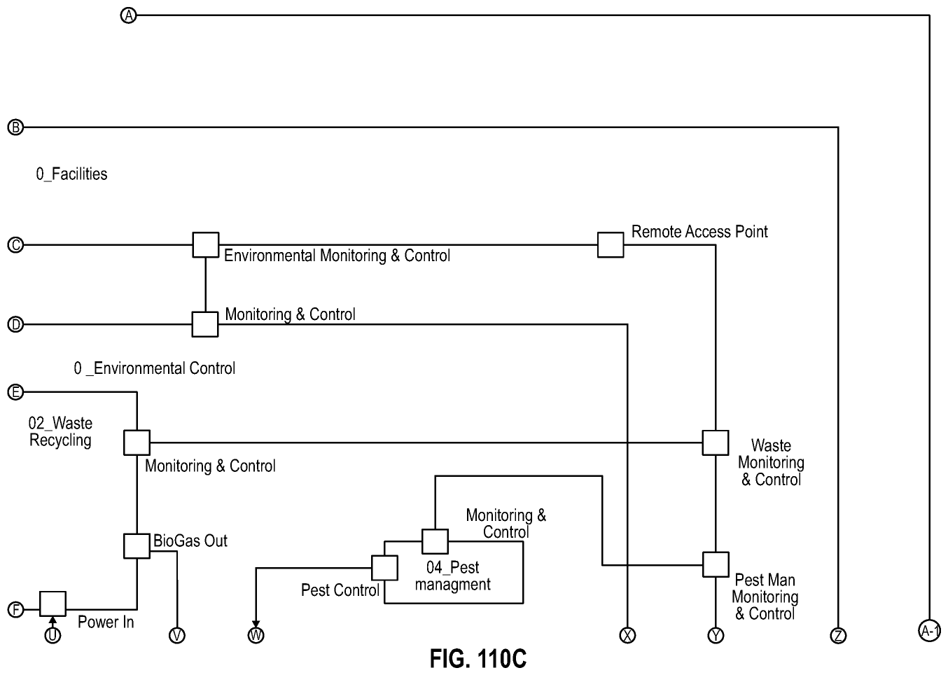

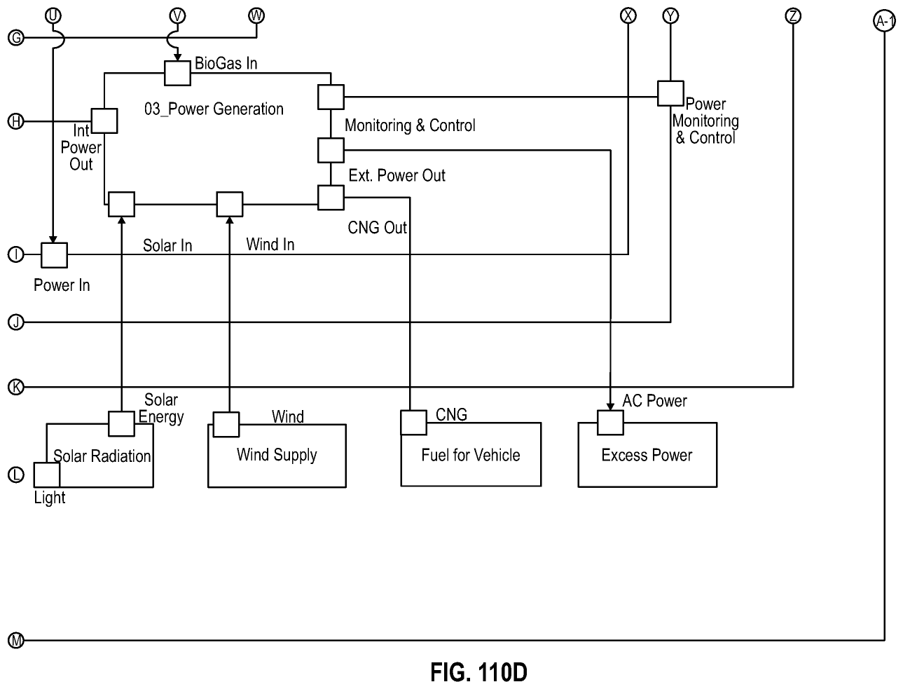

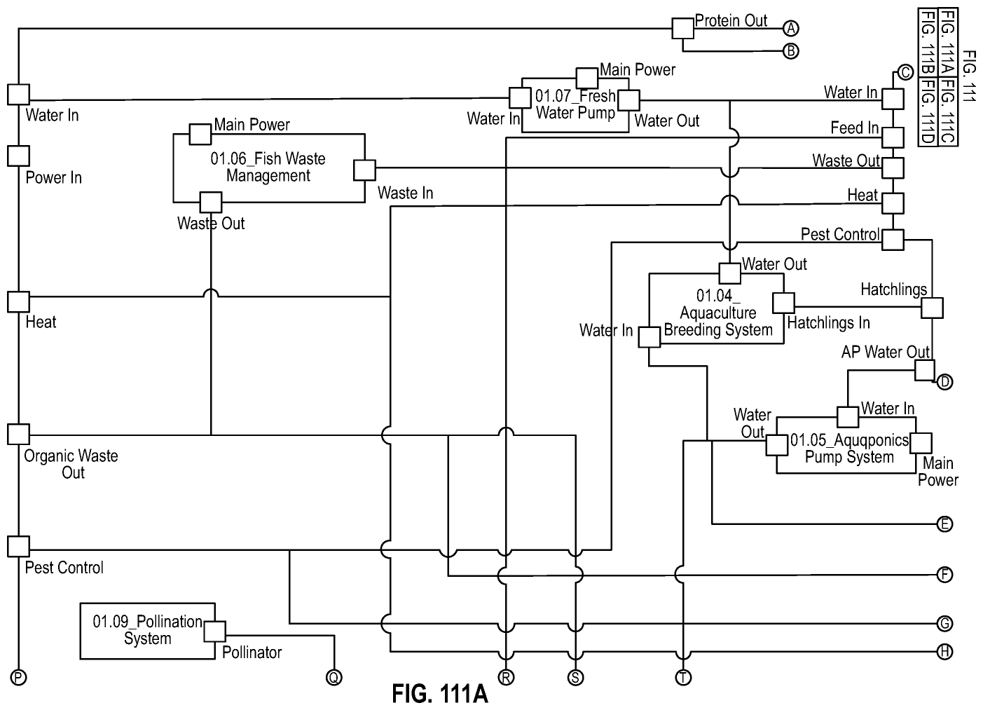

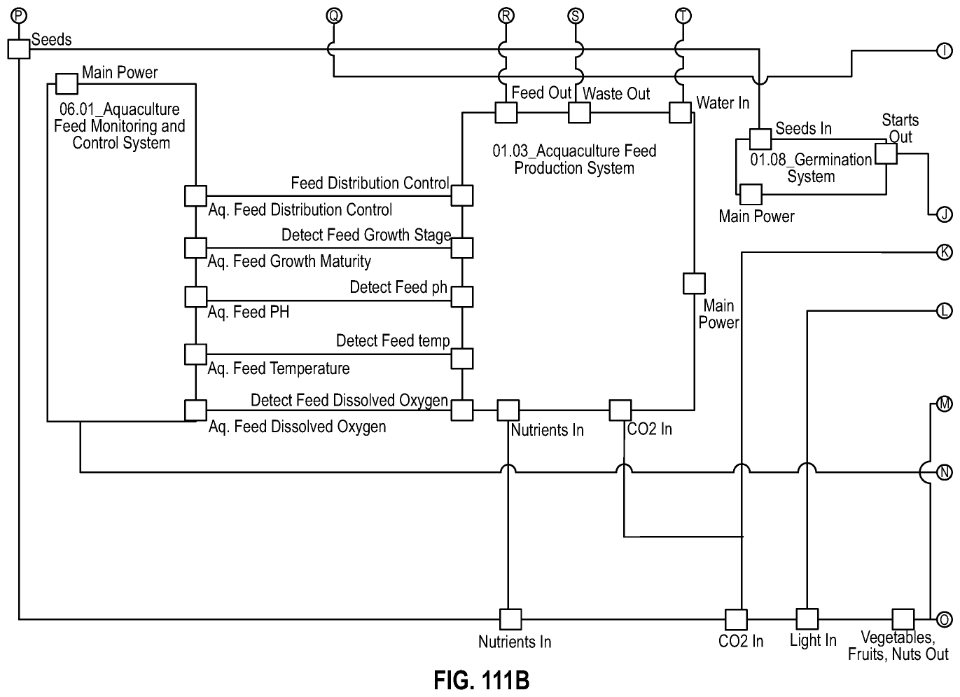

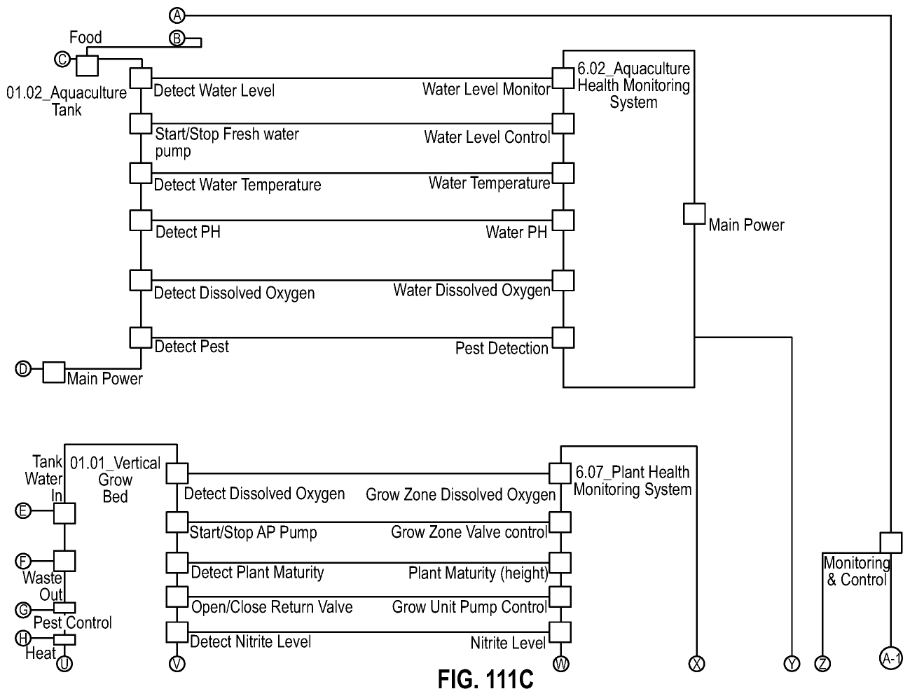

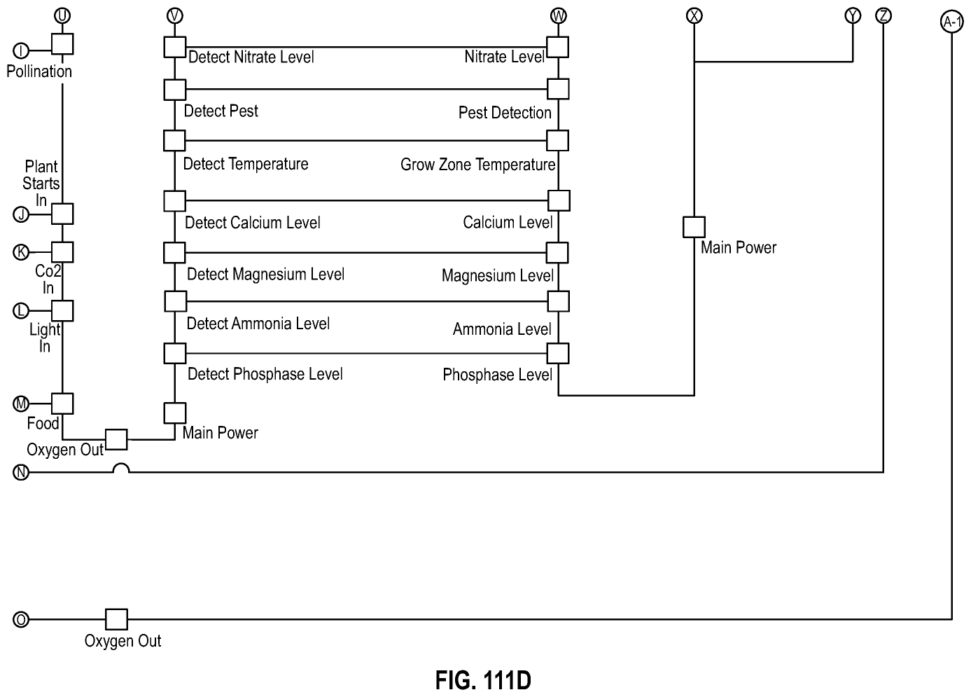

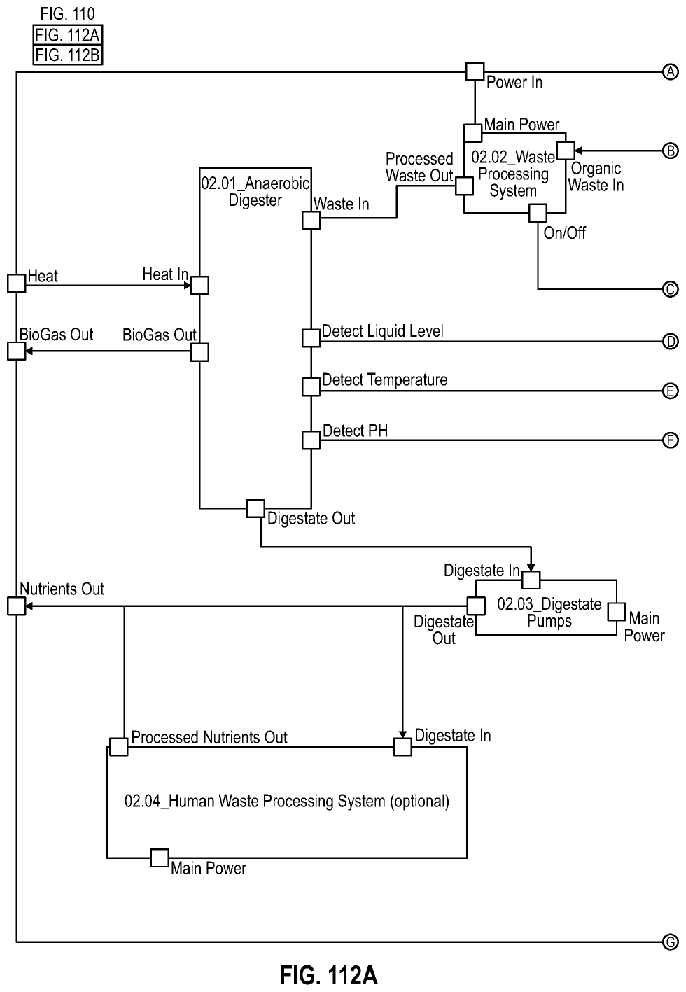

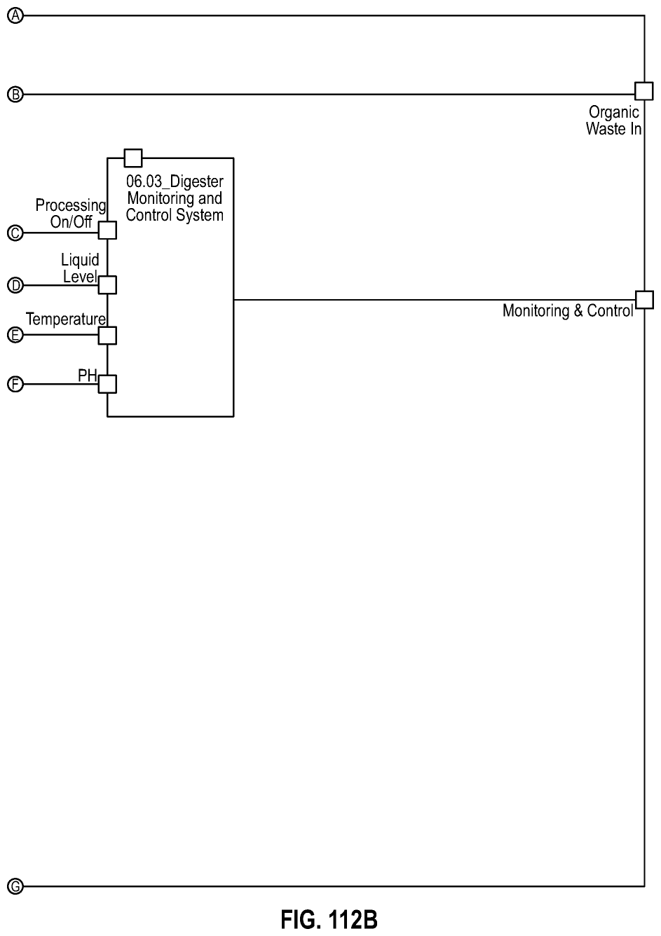

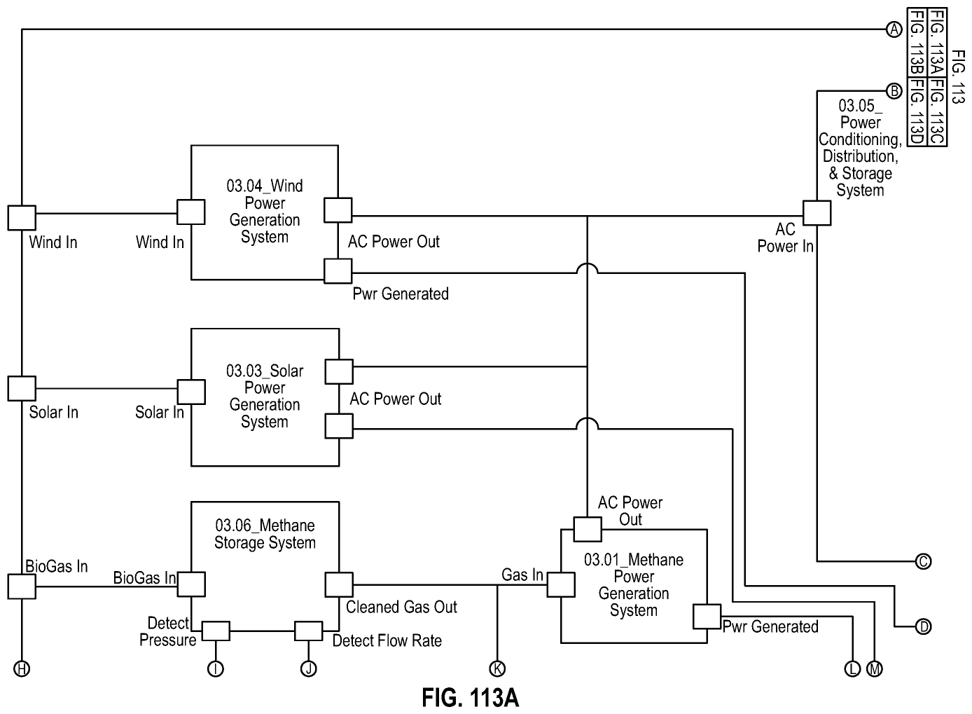

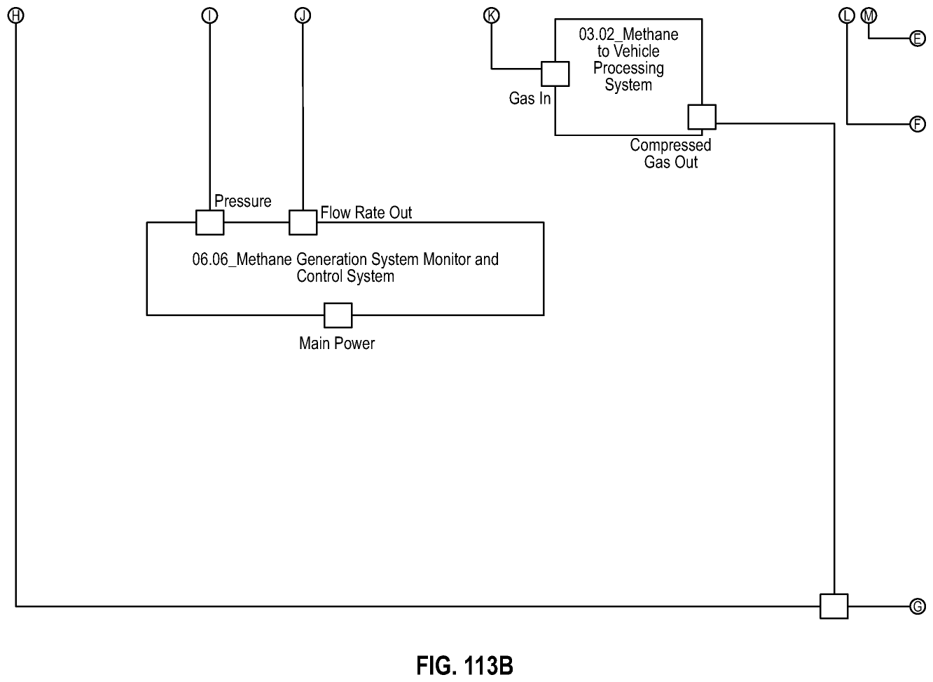

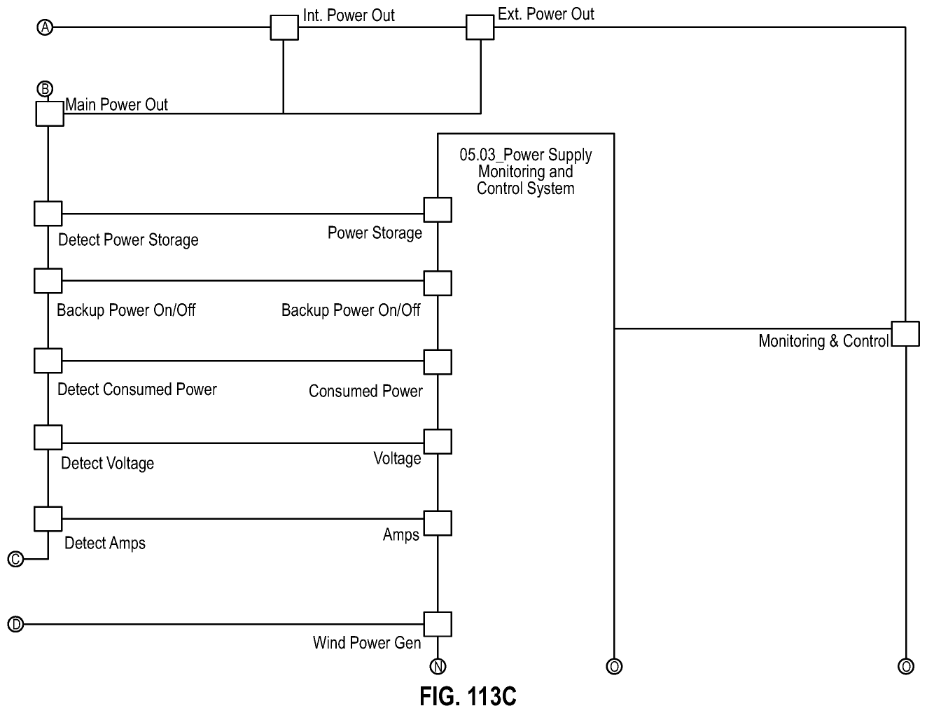

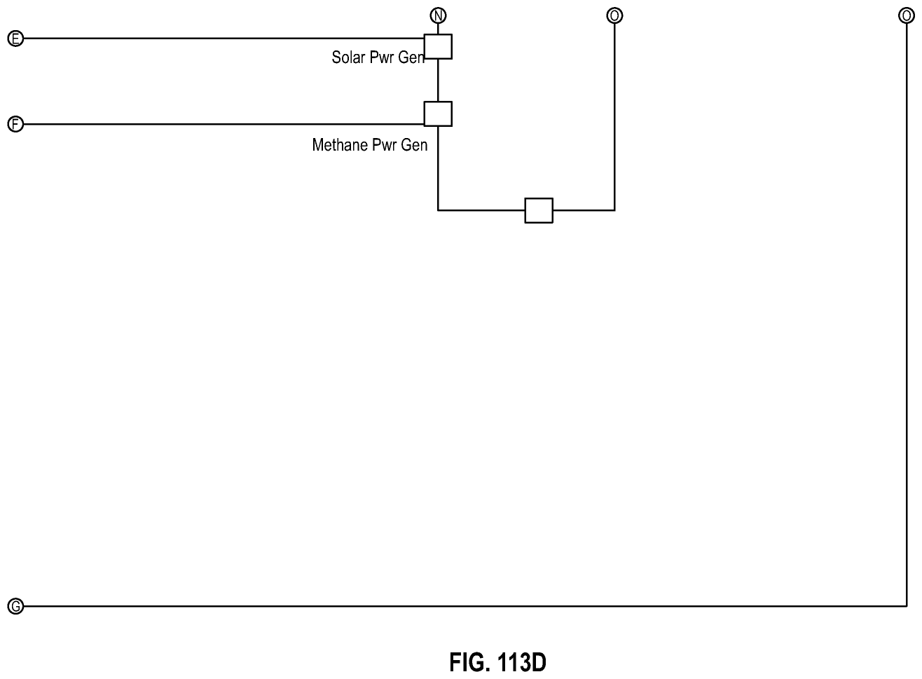

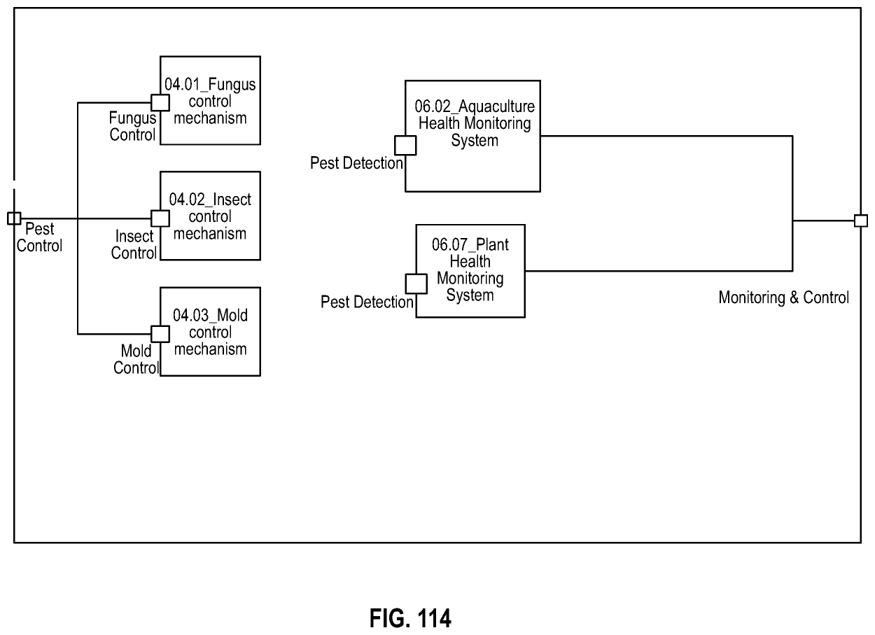

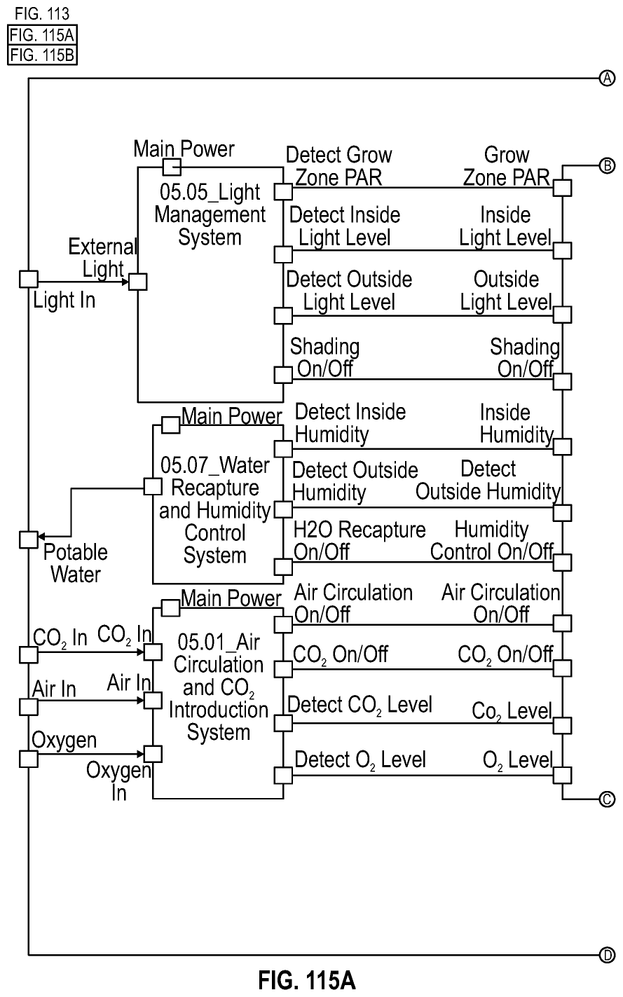

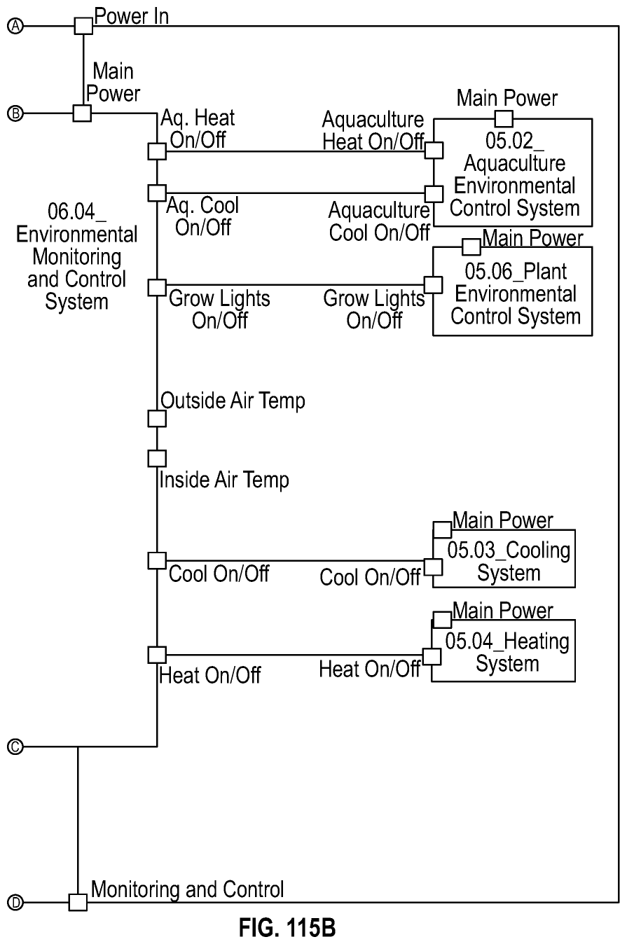

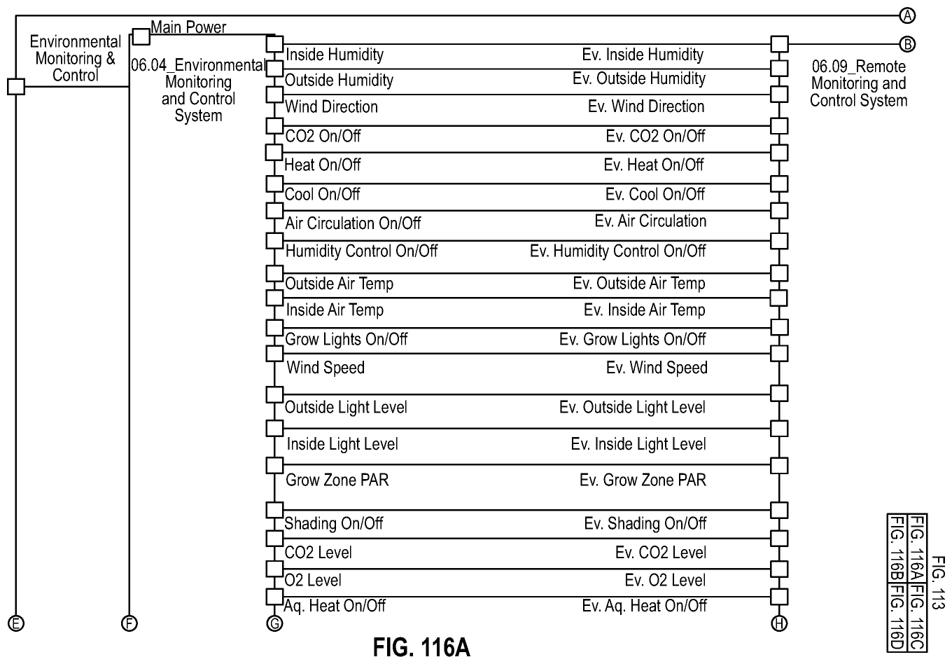

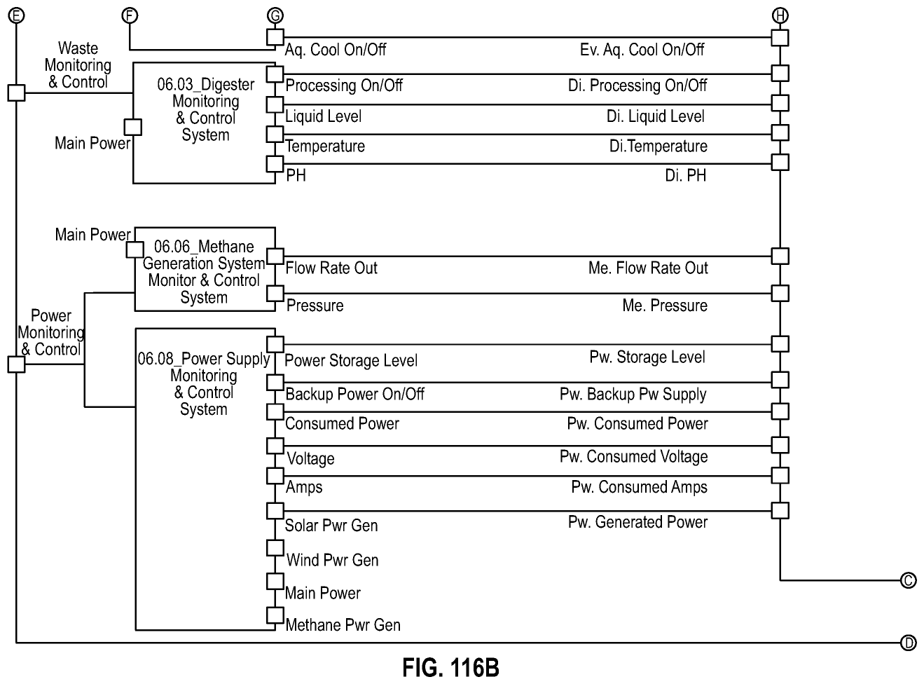

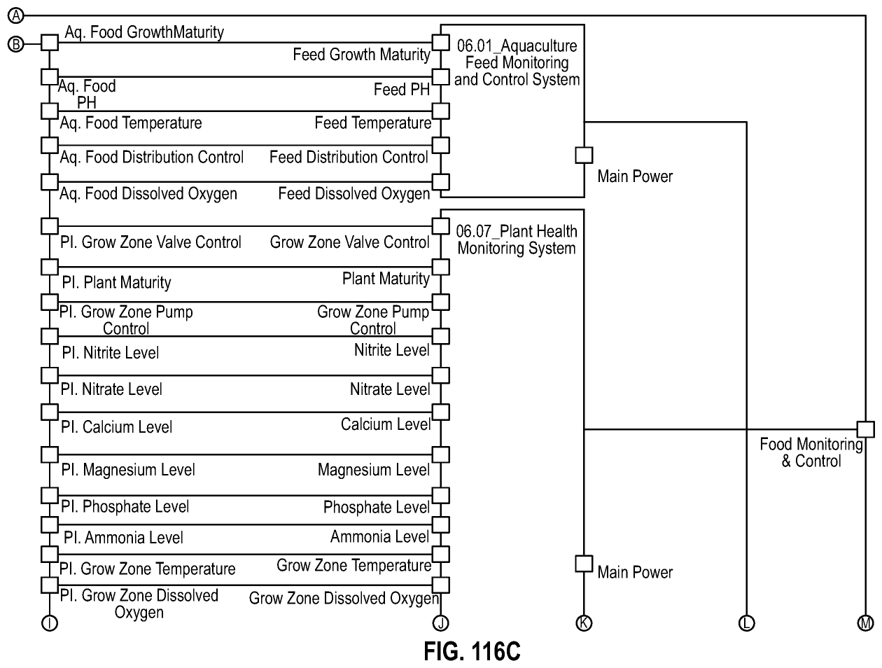

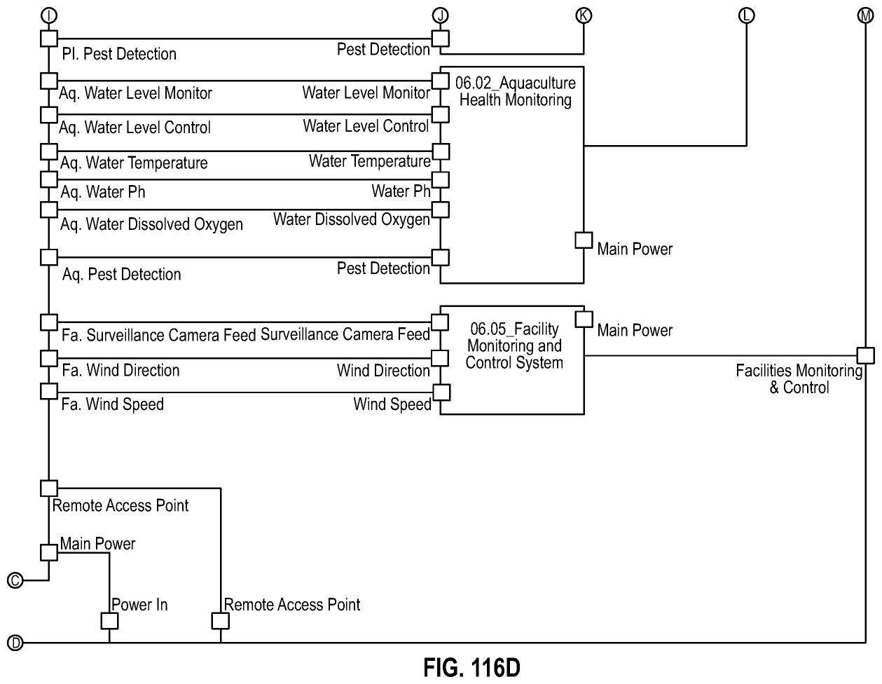

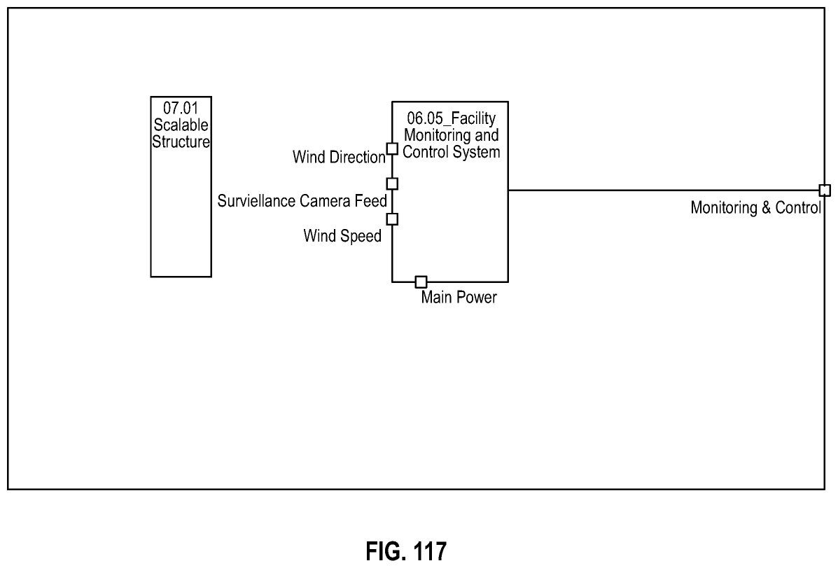

Referencing FIG. 3 (FIG. 01.01C) System Overview, the drawing illustrates the System utilizing the following external resources to operate: External Organic Waste (optional), Plant Seeds (for initial setup), Solar Radiation, Water Supply, and a Wind Supply. The interactions of each part of the system to another is shown. The System produces excess electrical power, fuel for vehicles, potable water, food (protein), and food (fresh vegetables, fruits, and nuts) in ratios measured by quantities of adults to be supported (ex. The System provides these for X adults, where X is a positive integer).

The System's integrated design allows it to minimize external inputs for initial system startup including: CO₂, Air, Plant Seeds, Water Supply, External Waste, Solar Radiation, and Wind. Due to the photosynthesis of plants in the Growing System, FIG. 02.00C, is The System can consume more CO₂ than it produces.

The Systems integrated Growing System, utilizes aquaponics and aeroponics to grow protein in the form of aquaculture, and fresh fruits, vegetables and nuts. This method of growing utilizes 90% less water than traditional agriculture and increases the output of the area used to grow by a minimum of a factor of two.

The Organic Waste Recycling System, combined with the Food Growth System, and Environmental Control System, create a bioregenerative effect when the Facility and Security System, is scaled to include human habitat. Humans exhale CO₂ which creates an input for The System, (negating the need for external CO₂ input) and consume Oxygen which is generated by the Food Growth System. Combined with the Waste Recycling System, The System can effectively recycle all organic waste (including human waste if the optional Human Waste Processing System) turning organic waste into reusable nutrients and energy.

The Organic Waste Recycling System not only supports the recycling of waste in the system but can also consume waste from outside the system. Due to the implementation of the Anaerobic Digestion process within this system, the use of the Organic Waste Recycling System, will produce the nutrients needed as an input to the Growing System, as well as produce Bio-Gas (a mixture of gases, primarily Methane) which can be burned to produce heat and electricity, as well as be compressed to supply compressed natural (bio) gas (CNG) for use outside of the system.

Utilizing its Power Generation System, The System can produce sustainable power from Solar, Wind, and recycled organic waste to sustain the various system components any excess energy not used by the system can be transported out of the system for external uses.

The integrated Pest Management System, utilizes organic, non-polluting pesticides, herbicides, and micro-nutrients to ensure food security and health.

As designed, The System, is modular, and can be scaled to deploy in any size structure capable of holding the system components shown in Figure groups: 02, 03, 04, 05, 06, and 08 to support the quantity of adults the operator specifies (a minimum of four adults).

The various system components: Figure groups 02, 03, 04, 05, 06, 08 can all be reconfigured and scaled to support various structural sizing requirements (e.g., Inside of a urban warehouse, into a shipping container, a self-standing and purpose built structure, etc).

Given the design for scalability considerations in The System, the various components: See Figure Groups 02, 03, 04, 05, 06, 08, are all scalable to support various output modifications (ex. Commercial production of fruits, vegetables, nuts, and aquaculture).

With its Environmental Control System, The System can be deployed in any various environments to provide sustainable food and energy including traditional (open land, farms, etc.) and non-traditional agricultural (urban location, warehouse, shipping container, deserts, off planet, etc.) spaces in Terrestrial (Earth based) and Non-Terrestrial (Space Station, Space Ships, Moon Base, Mars Base, Asteroid base, etc.) locations.

With its integrated Food Growing System, the system can also be scaled to grow nonfood based crops such as industrial hemp, hemp, medicinal, etc.

Referencing FIG. 4 (FIG. 01.02C) Food Growing System Overview, the figure illustrates that the food growth system utilizes plant seeds and fresh water from outside the system definition and produces vegetables, fruits, nuts, and proteins. It depends on the Waste Recycling, Power Generation, Environmental Control, and Automation systems as shown. The Food Growing System: consumes CO₂ from the Environmental Control System; provides Oxygen to the Environmental Control System; it requires an initial batch of seeds for food growth before the system becomes self-sustaining; it requires an initial water supply for system setup; it creates protein food for consumption in the form of aquaculture; it creates food in the form of vegetables, fruits, and nuts; it is monitored and controlled by the Automated Monitoring and Control System, it consumes light from the Environmental Control System; it consumes power from the Power Generation System, it utilizes pest control measures from the Pest Management System; it produces organic waste that is consumed by the Waste Recycling System, it consumes recycled nutrients from the Waste Recycling System; and it transfers heat via the Environmental Control System. Detailed interfaces for this system are shown in FIG. 13.

Referencing FIG. 5 (FIG. 01.03C) Organic Waste Recycling System Overview, the figure illustrates that the Organic Waste Recycling System can take in organic waste from outside the system to be recycled into nutrients and power for use within the system. It interfaces with the food growth, power generation, environmental control, and automation systems as shown. The Organic Waste Recycling System: produces and consume heat that is exchanged with the Environmental Control System; produces nutrients consumed by the Food Growth System; consumes organic waste from the Food Growth System, as well as from sources external to the system; consumes power from the Power Generation System; produces biogas (a mixture of gases primarily composed of Methane) for use by the Power Generation System; and is monitored and controlled by the Automated Monitoring and Control System. Detailed interfaces for this system are shown in FIG. 17 (FIG. 03.00C).

Referencing FIG. 6 (FIG. 01.04C) Pest Management System Overview, the figure illustrates that the Pest Management System takes in no external inputs and interfaces with the food growth and automation systems as shown. The Pest Management System provides pest control to the Food Growth System and is monitoring and controlled by the Automated Monitoring and Control System. Detailed interfaces for this system are shown in FIG. 48 (FIG. 04.00C).

Referencing FIG. 7 (FIG. 01.05C) Environmental Control System Overview, the figure illustrates that the Environmental Control System (FIG. 01.05C), takes in CO₂ and Air from outside the system. It interfaces with the Waste Recycling, Power Generation, Food Growth, Facilities, and Automation systems as shown. It produces potable water for use within and outside the system. The Environmental Control System: manages heat for the Food Growth System, Waste Recycling System, and Facilities and Security System; it controls the input of CO₂ into the Food Growth System; the output of Oxygen by the Food Growth System; controls the input of air from the air supply; is monitored and controlled by the Automated Monitoring and Control System; produces potable water; controls the light input to the Food Growth System, as well as the natural input of light into the system; and consumes power from the Power Generation System. Detailed interfaces for this system are shown in FIG. 05.00C.

FIG. 8 (FIG. 01.06C) Automation System Overview illustrates that the Automation System (FIG. 01.06C) takes in no external inputs and produces no outputs for use outside the system. It interfaces with all major systems as shown. Detailed interfaces for this system are shown in FIG. 06.00C.

FIG. 9 (FIG. 01.07C) Facilities System Overview illustrate that the Facilities and Security System (FIG. 01.07C), consumes light from outside of the system. It interfaces with the Environmental Control System and Automation Systems as shown. Detailed interfaces for this system are shown in FIG. 07.00C.

Referencing FIG. 10 (FIG. 01.08C) Power Generation System Overview, the figure illustrates that the Power Generation System (FIG. 01.08C), consumes solar radiation and wind from outside the system. It interfaces with all major systems as shown. The Power Generation System: consumes biogas from the Organic Waste Recycling System; provides power to the Food Growth System, Waste Recycling System, Environmental Control System, Automated Monitoring and Control System, and the Facilities and Security System; it consumes solar energy and wind; it produces compressed natural gas (CNG) and excess electrical power for use outside the system; and is monitoring and controlled by the Automated Monitoring and Control System. Detailed interfaces for this system are shown in FIG. 08.00C.

Referencing FIG. 11 (FIG. 02.00A) Food Growing System Use Cases, the figure illustrates that at the highest level the food growing system is responsible for the generation of oxygen and food.

Referencing FIG. 12 (FIG. 02.00B) Food Growing System Hierarchy Overview illustrates the food growing system composition/definition

FIG. 13 (FIG. 02.00C) Food Growing System illustrates that the Vertical Food Growing System 01 consists of: Vertical Grow Beds 02.01 to grow crops; Aquaculture tanks 02.02 to grow various species of aquaculture; an Aquaculture Feed Production System 02.03 to create food for the Aquaculture species; an Aquaculture Breeding System 02.04 to enable the sustainable reproduction of the Aquaculture species; Aquaponic Pumping System 02.05 to move water between the Tanks 02.02 and the Beds 02.01; a Aquaculture Waste Management System 02.06 to transport waste out of the Tanks 02.02; a Fresh Water Supply Pump 02.07 for initial system startup; a Germination System 02.08 to develop plant starts from seed; and a Pollination System to support the pollination of plants in the system

FIG. 14 (FIG. 02.01A) illustrates that the Grow Area comprises Aquaponic bacteria and a grow structure. These components provide necessary structure for various and diverse plant growth.

Referencing FIG. 15 (FIG. 02.01B) Grow Area Hierarchy Overview, illustrated is the Grow Area System composition/definition also subject of FIG. 02.01A

FIG. 16 (FIG. 02.01C) Grow Area System Overview illustrates interfaces (inputs and outputs) to the Grow Area System. The interfaces are shown on the border surrounding the diagram. FIG. 02.01C also highlights the interfaces of the Grow Area within the Food Growing System including selected components.

Referencing FIG. 17 (FIG. 02.02A) Aquaculture Tank Use Cases, the figure illustrates the functions of the aquaculture tank include providing nutrients for plant growth and an environment for growth of aquaculture or other species.

Referencing FIG. 18 (FIG. 02.02C) Aquaculture Tank System Overview, the figure illustrates the interfaces (inputs and outputs) to the Aquaculture Tank System are shown on the border surrounding the diagram. FIG. 02.02C highlights the interfaces of the Aquaculture Tanks within the Food Growing System, including the aquaculture food production growing system, along with the breeding system, the fresh water management system, water waste management system and pump system.

The FIG. 19 (02.03A) Aquaculture Feed Production System Use Cases illustrates that aquaculture feed production system can be modified or utilized to generate food for herbivore or carnivore consuming species.

FIG. 20 (FIG. 02.03C) Aquaculture Feed Production System Overview illustrates the interfaces (inputs and outputs) to the Aquaculture Feed Production System are shown on the border surrounding the diagram. FIG. 02.03C highlights the interfaces of the Aquaculture Feed Production System within the Food Growing System.

FIG. 21 (FIG. 02.04A) Aquaculture Breeding System Use Cases illustrates the one function is to breed aquaculture.

FIG. 22 (FIG. 02.04C) Aquaculture Breeding System Overview illustrates the Interfaces (inputs and outputs) to the Aquaculture Breeding System are shown on the border surrounding the diagram. FIG. 02.04C highlights the interfaces of the Aquaculture Breeding System within the Food Growing System.

FIG. 23 (FIG. 02.05A) Aquaponics Pump System Use Cases illustrates the function of the pump is to move and circulate water and nutrients to and among the aquaculture, e.g., aquaculture, and plants.

FIG. 24 (FIG. 02.05C) Aquaponics Pump System Interfaces (inputs and outputs) to the Aquaponics Pump System are shown on the border surrounding the diagram. FIG. 02.05C highlights the interfaces of the Aquaponics Pump System within the Food Growing System.

FIG. 25 (FIG. 02.06A) Water Waste Management System Use Cases shows the relationship between the solids filtration system and the water overflow management system.

The Aquaculture Waste Management System composition/definition is shown in FIG. 26 (FIG. 02.06B)

FIG. 27 (FIG. 02.06C) Water Waste Management System Interfaces (inputs and outputs) to the Water Waste Management System are shown on the border surrounding the diagram. FIG. 02.06C highlights the interfaces of the Water Waste Management System within the Food Growing System.

FIG. 28 (FIG. 02.07A) Fresh Water Management System Use Cases illustrates the relationship of the fresh water storage system to the fresh water pump providing water for aquaponics

The Fresh Water Management System composition/definition is shown in FIG. 29 (FIG. 02.07B).

FIG. 30 (FIG. 02.07C) Fresh Water Management System Overview illustrates the Interfaces (inputs and outputs) to the Fresh Water Management System are shown on the border surrounding the diagram. FIG. 02.07C highlights the interfaces of the Fresh Water Management System within the Food Growing System.

FIG. 31 (FIG. 02.08A) Germination System Use Cases illustrates the function of the germination system.

FIG. 32 (02.08C) Germination System illustrates the seed and power Interfaces (inputs and outputs) to the Germination System shown on the border surrounding the diagram.

FIG. 33 (02.09A) Pollination System Use Cases describes the system function.

FIG. 34 (FIG. 02.09C) Pollination System Overview illustrates the Interfaces (inputs and outputs) to the Pollination System are shown on the border surrounding the diagram. FIG. 02.09C highlights the interfaces of the Pollination System within the Food Growing System.

FIG. 35 (FIG. 03.00A). Organic Waste Recycling System Use Cases illustrates that at the highest level the Organic Waste Recycling system, the system is responsible for the processing and recycling of organic waste and the safe recycling and processing of human waste (optional).

FIG. 36 (FIG. 03.00B) Organic Waste Recycling System Hierarchy Overview illustrates the components and definition of the system to include digester pumps, anerobic digester, a digester monitoring and control system, an optional human waste processing system, and a waste processing system.

Referencing FIG. 37, the Organic Waste Recycling System (FIG. 03.00C), consists of: an Anaerobic Digester 03.01 which uses bacteria to decompose organic waste into liquid nutrients and bio-gas; a Waste Processing System 03.02 to pre-process materials going into the Digester 03.01; a Digestate Pumping System 03.03 to move digestate from the digester to the Food Production System 01.

FIG. 38 (FIG. 03.01A) Anaerobic Digester Use Cases illustrates the function of the digester to continually generate methane gas and to decompose organic waste.

FIG. 39 (03.01C) Anaerobic Digester System Overview shows the Interfaces (inputs and outputs) to the Anaerobic Digester System on the border surrounding the diagram. Heat is an input into the system and methane (biogas) is the output. Components are the anerobic digester, waste processing system, digester monitoring and control system and digester pumps.

FIG. 40 (03.02A) Waste Processing System Use Cases illustrates the organic waste may be processed from outside the system as well as waste produced outside the system.

FIG. 41 (03.02C) Waste Processing System Overview illustrates the Interfaces (inputs and outputs) to the Waste Processing System shown on the border surrounding the diagram. FIG. 03.02C highlights the interfaces of the Waste Processing System within the Organic Waste Recycling System. The inputs include organic waste and electrical power.

FIG. 42 (03.03A) Digestate Pumps Use Cases includes the digestate pumps recycling nutrients back into the system.

FIG. 43 (03.03C) Digestate Pumps System Overview illustrates the Interfaces (inputs and outputs) to the Digestate Pumps System on the border surrounding the diagram. FIG. 03.03C highlights the interfaces of the Digestate Pumps System within the Organic Waste Recycling System. The digestate pumps receives product from the digester. The outflow (digestate or nutrients) can include digestate from the optional human waste processing system.

FIG. 44 (FIG. 03.04A) Human Waste Processing System—optional Use Cases illustrates the function of the optional human waste processing system to safely process human waste.

FIG. 45 (FIG. 03.04C) Human Waste Processing System—optional illustrates the Interfaces (inputs and outputs) to the Human Waste Processing System are shown on the border surrounding the diagram. FIG. 03.04C highlights the interfaces of the Human Waste Processing System within the Organic Waste Recycling System.

FIG. 46 (04.00A) Pest Management System Use Cases illustrates that at the highest level the Pest Management System (FIG. 04.00A) is responsible for the management of pest (fungus, insects, and disease) within the organic parts of the system. Functions are to monitor plant disease, monitor animal species, e.g., aquaculture for pests, manage insect infestations and manage fungus.

FIG. 47 (04.00B) Pest Management System Hierarchy Overview composition/definition is shown and comprises a pest management monitoring and control, fungus control and insect control.

FIG. 48 (FIG. 04.00C) Pest Management System consists of: Fungus 04.01 and Insect 04.02 control mechanisms using organic and food safe methods.

Referencing FIG. 49, at the highest level the Environmental Control System (FIG. 05.00A) is responsible for controlling the environment for plants, aquaculture, and digester system. One key aspect of this system is that it can capture moisture from the air for use within and outside of the system. Functions include providing environmental control for the digester and aquaculture tanks, as well as provide clean water. The system is self-contained inasmuch as the only external resources include air, water, as well as wind, and solar energy. The system provides air circulation, recaptures evaporated water, temperature control. The system also provides monitoring and control components.

Referencing FIG. 50 (FIG. 05.00B) Environmental Control System Hierarchy Overview composition/definition is shown and comprises aquaculture environmental control system, air circulation and CO₂ introduction, water recapture and humidity control, heating and cooling, as well environmental monitoring and control system, plant environmental control system and light management system.

Referencing FIG. 51, The Environmental Control System (FIG. 05.00C), consists of: an Air Circulation and CO₂ Introduction System 05.01 which prevents stagnant air, and provides CO₂ for plants; an Aquaculture Environmental Control System 05.02 which heats and cools the Aquaculture Tanks 01.02; a Cooling System 05.03 which cools the air and controls water temperature; a Heating System 05.04 which heats the digester and the air; a Light Management System 05.05 which controls and provides the needed light for crop growth; a Plant Environmental Control System which controls the timing of artificial lighting to supplement natural lighting for crop growth; and a Water Recapture and Humidity Control System 05.07 which captures evaporated water and converts it to potable water and recycles it back into the system.

FIG. 52 (FIG. 05.01A) Air Circulation and CO₂ introduction System Use Cases functions to prevent stagnant air (air circulation) and provide CO₂ to plant species.

FIG. 53 (FIG. 05.01C) Air Circulation and CO₂ Introduction System Overview illustrates the Interfaces (inputs and outputs) to the Air Circulation and CO₂ Introduction System on the border surrounding the diagram. FIG. 05.01C highlights the interfaces of the Human Air Circulation and CO₂ Introduction System within the Environmental Control System. The system includes detection of oxygen (O₂) and carbon dioxide (CO₂), as well as on/off controls and air circulation controls. Note that CO₂ can be both added and extracted from the system.

FIG. 54 (05.02A) Aquaculture Environmental Control System Use Cases illustrates the function of the system to control the environment of the aquaculture tanks.

FIG. 55 (05.02C) Aquaculture Environmental Control System overview illustrates the Interfaces (inputs and outputs) to the Aquaculture Environmental Control System on the border surrounding the diagram. FIG. 05.02C highlights the interfaces of the Aquaculture Environmental Control System within the Environmental Control System, including heat and cooling component controls with electrical power as an input. See also FIG. 56 (FIG. 05.03A) showing the cooling system is also an input into the air circulation as well as the circulating water.

FIG. 57 (05.03C) Cooling System Overview includes the Interfaces (inputs and outputs) to the Cooling System are shown on the border surrounding the diagram. FIG. 05.03C highlights the interfaces of the Cooling System within the Environmental Control System. Note that an output of the cooling system is heat. The cooling system includes an on/off control.

FIG. 58 (FIG. 05.04A) Heating System Use Cases illustrates that the heating system provides heat to both the digester and the circulating air. Heat can also be provided to the circulating water.

FIG. 59 (FIG. 05.04C) Heating System Overview Interfaces (inputs and outputs) to the Heating System are shown on the border surrounding the diagram. FIG. 05.04C highlights the interfaces of the Heating System within the Environmental Control System.

FIG. 60 (05.05A) Light Management System Use Cases provides light for plant growth. The type, spectrum, and quantity of light required is based on the types of plants grown. In one embodiment Light Emitting Diodes (LED) were utilized to provide 30 Watts per sq ft. at a duration of 16 hours per day. Full spectrum lighting is most appropriate to ensure healthy plant growth.

FIG. 61 (05.05C) Light Management System Overview Interfaces (inputs and outputs) to the Light Management System are shown on the border surrounding the diagram. FIG. 05.05C highlights the interfaces of the Light Management System within the Environmental Control System. Functions and components include shading, light detectors and interior light level sensors and controls. Note that excess light maybe conveyed out of the system.

FIG. 62 (FIG. 05.06A) Plant Environmental Control Systems Use functions are to provide environmental conditions for plant growth.

FIG. 63 (FIG. 05.06C) Plant Environmental Control System interfaces (inputs and outputs) to the Plant Environmental Control System are shown on the border surrounding the diagram. FIG. 05.06C highlights the interfaces of the Plant Environmental Control System within the Environmental Control System.

FIG. 64 (FIG. 05.07A) Water Recapture and Humidity Control System Use Cases monitors relative humidity within the environment (which may be a closed environment), water purity and the recapture of water vapor.

FIG. 65 (FIG. 05.07B) Water Recapture and Humidity Control System Hierarchy Overview monitors and controls the water filtration system and the humidity control/water vapor recapture system.

FIG. 66 (FIG. 05.07C) Water Recapture and Humidity Control System Interfaces (inputs and outputs) to the Water Recapture and Humidity Control System are shown on the border surrounding the diagram. FIG. 05.07C highlights the interfaces of the Water Recapture and Humidity Control System within the Environmental Control System. Note that the illustrated system includes monitoring both internal and exterior humidity as well as on/off control of the water recapture. Note that potable water may be extracted from the system.

FIG. 67 (06.00A) Automated Monitoring and Control System Use Cases At the highest level the Automated Monitoring and Control System (FIG. 06.00A) is responsible a self-learning automated system, responsible for the monitoring and control of all system functions and activities. Illustrated functions and controls include remote access control and monitoring, monitoring and control of waste recycling, monitoring and control of environmental systems, monitoring plant health, monitoring animal species health, monitoring plants and animals for pests, etc., and monitor biogas creation, flow rate and pressure.

FIG. 68 (FIG. 06.00B) Automated Monitoring and Control System Hierarchy Overview The Automated Monitoring and Control System composition/definition is shown in (FIG. 06.00B). Components illustrated include the aquaculture feed monitoring and control system, facility monitoring and control system, aquaculture health monitoring, pest management, digester monitoring and control, methane (biogas) generation monitoring and control, environmental monitoring and control system, power supply monitoring and control, plant health monitoring and remote monitoring control system.

FIG. 69 (06.00C) Automated Monitoring and Control System The Automated Monitoring and Control System (FIG. 06.00C) is based on artificial intelligent and machine learning architectures which support the various component monitoring and control needs of the system (Figure groups 06.01, 06.02, 06.03, 06.04, 06.05, 06.06, 06.07, and 06.08). In addition, a Remote Monitoring and Control System 06.09 is integrated into the system such that an operator can remotely connect to the system and monitor and control it.

FIG. 71 (FIG. 06.01A) Aquaculture Feed Monitoring and Control System Use monitors and controls feed production system.

FIG. 72 (06.01C) Aquaculture Feed Monitoring and Control System Overview Interfaces (inputs and outputs) to the Aquaculture Feed Monitoring and Control System are shown on the border surrounding the diagram. FIG. 06.01C highlights the interfaces of the Aquaculture Feed Monitoring and Control System within the Automated Monitoring and Control System. Monitoring includes feed dissolved oxygen, feed temperature, feed pH, feed growth maturity, and feed distribution control. The system works in conjunction with the remote monitoring and control system.

FIG. 72A (FIG. 06.02A) Aquaculture Health Monitoring includes monitoring of animal, e.g., aquaculture health.

FIG. 73 (FIG. 06.02C) Aquaculture Health Monitoring System Overview illustrates Interfaces (inputs and outputs) to the Aquaculture Health Monitoring and Control shown on the border surrounding the diagram. FIG. 06.02C highlights the interfaces of the Aquaculture Health Monitoring and Control System within the Automated Monitoring and Control System. Variables monitored include water temperature, water level, dissolved oxygen and water pH. The system may operate in conjunction with the feed monitoring and control.

FIG. 74 (06.03A) Digester Monitoring and Control System Use Cases includes monitoring of the waste recycling system.

FIG. 75 (FIG. 06.03C) Digester Monitoring and Control System Overview Interfaces (inputs and outputs) to the Digester Monitoring and Control System are shown on the border surrounding the diagram. FIG. 06.03C highlights the interfaces of the Digester Monitoring and Control System within the Automated Monitoring and Control System. The system works in conjunction with the remote monitoring and control system. Variable monitored include pH, temperature, water level and on/off control of digester processing.

FIG. 76 (FIG. 06.04A) Environmental Monitoring and Control System Use Cases include monitoring of the environmental system.

FIG. 77 (FIG. 06.04C) Environmental Monitoring and Control System Overview illustrates Interfaces (inputs and outputs) to the Environmental Monitoring and Control System on the border surrounding the diagram. FIG. 06.04C highlights the interfaces of the Environmental Monitoring and Control System within the Automated Monitoring and Control System. Variable monitored include outside humidity, inside environment humidity, water feed control, oxygen level, carbon dioxide level, shading control, grow zone Photosynthetically Active Radiation (PAR), inside light level, outside light level, grow light on/off control, interior air temperature, outside air temperature, on/off control for humidity, outside temperature, on/off control for air circulation, heat and cooling on/off controls, CO₂ input/output controls, water temperature cooling control.

FIG. 78 (FIG. 06.05A) Facility Monitoring and Control System Use Cases includes monitoring exterior wind speed and direction, roof load and monitor control system physical and electronic access.

FIG. 79 (FIG. 06.05C) Facility Monitoring and Control System Overview illustrates interfaces (inputs and outputs) to the Facility Monitoring and Control System. The interfaces are shown on the border surrounding the diagram. FIG. 06.05C highlights the interfaces of the Facility Monitoring and Control System within the Automated Monitoring and Control System. Inputs are facility monitoring and control and electrical power. Components can include surveillance camera fee, wind speed and wind direction.

FIG. 80 (FIG. 06.06A) Methane Generation System Monitor and Control System Use Cases include monitoring biogas creation, flow rate and pressure for safety.

FIG. 81 (FIG. 06.06C) Methane Generation System Monitoring and Control System Overview illustrates interfaces (inputs and outputs) to the Methane Generation Monitoring and Control System. The interfaces are shown on the border surrounding the diagram. FIG. 06.06C highlights the interfaces of the Methane Generation Monitoring and Control System within the Automated Monitoring and Control System. Variable monitored are flow rate and pressure. Inputs are power monitoring and control data and electrical power.

FIG. 82 (06.07A) Plant Health Monitoring System Use Cases for monitoring plant health.

FIG. 83 (FIG. 06.07C) Plant Health Monitoring System Overview illustrates interfaces (inputs and outputs) to the Plant Health Monitoring and Control System. The interfaces are shown on the border surrounding the diagram. FIG. 06.07C highlights the interfaces of the Plant Health Monitoring and Control System within the Automated Monitoring and Control System. Variable subject of monitoring and control include grow zone control valve, dissolved oxygen, temperature, ammonia level, phosphate level, magnesium level, calcium level, nitrate and nitrile level, pump control and plant height monitoring.

FIG. 84 (FIG. 06.08A) Power Supply Monitoring and Control System Use Cases include biogas power generation, wind power generation and solar power generation.

FIG. 85 (FIG. 06.08C) Power Supply Monitoring and Control System Overview illustrates Interfaces (inputs and outputs) to the Power Supply Monitoring and Control System. The interfaces are shown on the border surrounding the diagram. FIG. 06.08C highlights the interfaces of the Power Supply Monitoring and Control System within the Automated Monitoring and Control System. Variables monitored may include methane (biogas) power generation, wind power generation, solar power generation, electrical amps and voltage, consumed power, backup power on/off control and power storage level.

FIG. 86 (FIG. 06.09A) Remote Monitoring and Control System Use Cases include monitoring of variable that may include monitoring system performances, self learning (machine learning), operability of actuators from remote locations, automatic monitoring and control settings based upon plant behavior and operability of sensors form remote locations.

FIG. 87 (FIG. 06.09B) Remote Monitoring and Control System Hierarchy Overview includes plant specific application, watchdog (a software application that constantly monitors the system and notifies the operator of an issue, or automatically takes action to stop and undesired outcome e.g. turning off a valve to prevent water loss), sensor and control unit, remote access system.

FIG. 88 (FIG. 06.09C) Remote Monitoring and Control System Overview illustrates interfaces (inputs and outputs) to the Remote Monitoring and Control System. The interfaces are shown on the border surrounding the diagram. FIG. 06.09C highlights the interfaces of the Remote Monitoring and Control System within the Automated Monitoring and Control System.

FIG. 89 (06.10A) Pest management Monitoring and Control Use Cases includes monitoring for pests, insects and plant disease.

FIG. 90 (FIG. 06.10C) Pest Management Monitoring and Control System Overview illustrates interfaces (inputs and outputs) to the Pest Management Monitoring and Control System. The interfaces are shown on the border surrounding the diagram. FIG. 06.10C highlights the interfaces of the Pest Management Monitoring and Control System within the Automated Monitoring and Control System. Data is inputted in to the remote monitoring and control system from the pest management monitoring and control.

FIG. 91 (FIG. 07.00A) Facilities & Security System Use Cases at the highest level the Facilities and Security System (FIG. 07.00A) is responsible for keeping the contents of the overall system as safe and clean as possible as well as to ensuring the physical security of the system.

Referencing FIG. 92, The Facilities and Security System composition/definition is shown in FIG. 07.00B. Reference is also made to FIG. 07.01A.

Referencing FIG. 93, the Facilities and Security System (FIG. 07.00C) is designed to support a scalable structure which is responsible for: protecting The System from moisture (rain, ground) intrusion, adjusting for sun seasonal position changes, maximizing the use of natural light, protecting the System from heat loss/gain, protecting the System from particulate (snow, dust, etc.) loading, protects the System from wind, protects contents/occupants from radiation, protects from ground based pest and dirt/contamination, keeps the contents of the system as clean as possible, and is easily deployable by four adults with no technical knowledge.

FIG. 94 (FIG. 07.01A) Scalable Insulated Structure Use Cases illustrates structural variables including content cleanliness, protection from ground contamination and moisture, adjustment for seasonal changes in sun position, radiation protection, protection from environment (wind, rain, snow, etc.), ease of deployment, heat insulation, and system operation monitors and controls.

Referencing at FIG. 95, at the highest level the Power Generation System (FIG. 08.00A) is responsible for all power generation for the system as well as fuel production for use outside of the system.

The Power Generation System composition/definition is shown in FIG. 96 (08.00B).

FIG. 97 (FIG. 08.00C) Power Generation System consists of: a Methane Power Generation System 03.01 which converts bio-gas into electricity; a Methane to Vehicle Fuel Processing System 03.02 which compresses the bio-gas into a compressed form for use in vehicles converted to run on compressed natural gas (CNG); a Solar Power Generation System 03.03 which converts solar radiation into electricity; a Wind Power Generation System 03.04 which converts kinetic energy from wind into energy; a Power Conditioning, Distribution, and Storage System 03.05 which ensures the appropriate voltage, frequency, distribution of electrical power throughout the system and also provides power backup in case primary power goes down; and a Methane Storage System 03.06 which processes, cleans, and stores bio-gas before it is utilized.

FIG. 98 (FIG. 08.01A) Methane Power Generation System Use Cases defines that the methane gas generation may be continuous.

FIG. 99 (FIG. 08.01C) Methane Power Generation System Overview illustrates the Interfaces (inputs and outputs) to the Methane Power Generation System. The interface of the input of methane (biogas) is shown on the border surrounding the diagram. FIG. 08.01C highlights the interfaces of the Methane Power Generation System within the Power Generation System.

FIG. 100 (08.02A) Methane to Vehicle Fuel Processing System illustrates an optional use.

FIG. 101 (FIG. 08.02C) Methane to Vehicle Fuel Processing System Overview Interfaces (inputs and outputs) to the Methane to Vehicle Fuel Processing System are shown on the border surrounding the diagram. FIG. 08.02C highlights the interface (output) of the Methane to Vehicle Fuel Processing System within the Power Generation System

FIG. 102 (08.03A) Solar Power Generation System Use Cases illustrates the generation of solar energy.

FIG. 103 (FIG. 08.03C) Solar Power Generation System Overview Interfaces (inputs and outputs) to the Solar Power Generation System are shown on the border surrounding the diagram. FIG. 08.03C highlights the interfaces of the Solar Power Generation System within the Power Generation System.

FIG. 104 (08.04A) Wind Power Generation System Use Cases illustrates the optional generation of wind energy as part of the system subject of this disclosure.

FIG. 105 (FIG. 08.04C) Wind Power Generation System Overview illustrates the interfaces (inputs and outputs) to the Wind Power Generation System. The input of wind energy is shown on the border surrounding the diagram. FIG. 08.04C highlights the interfaces of the Wind Power Generation System within the Power Generation System.

FIG. 106 (FIG. 08.05A) Power Conditioning, Distribution, & Storage System Use Cases illustrates the functions to include management of power distribution, provision of backup energy source, energy storage and the conditioning or regulating of energy quantity/properties for consumption.

FIG. 107 (FIG. 08.05C) Power Conditioning, Distribution, & Storage System Overview illustrates the interfaces (inputs and outputs) to the Power Conditioning, Distribution, and Storage System. The interfaces are shown on the border surrounding the diagram. FIG. 08.05C highlights the interfaces of the Power Conditioning, Distribution, and Storage System within the Power Generation System are shown to be the input and output of energy.

FIG. 108 (08.06A) Methane Storage and Cleaning System Use Cases illustrates the storage of energy for use when other primary sources are not available.

FIG. 109 (FIG. 08.06C) Methane Storage and Cleaning System Overview illustrates interfaces (inputs and outputs) to the Methane Storage and Cleaning System. The interfaces are shown on the border surrounding the diagram and includes the input of biogas. FIG. 08.06C highlights the interfaces of the Methane Storage and Cleaning System within the Power Generation System.

It will be appreciated that the system described in this disclosure may consume more CO₂ than it produces. This can have environmental benefit as well as make the system integral to closed systems that can support human life.

The System (FIG. 110), may comprise a food growing sub-system (FIGS. 111A & 111B), an organic waste recycling sub-system (FIG. 112), a power generation sub-system (FIG. 113), a pest management sub-system (FIG. 114), an environmental control sub-system (FIG. 115), an automated monitoring and control sub-system (FIG. 116), and a facilities and security sub-system (FIG. 117).

The system may utilize the following external resources to operate: external organic waste (optional), plant seeds (for initial setup), solar radiation, water supply, and a wind supply. The system produces excess electrical power, fuel for vehicles, potable water, food (protein), and food (fresh vegetables, fruits, and nuts) in ratios measured by quantities of adults to be supported (e.g., the system provides these for X adults, where X is a positive integer).

The food growing sub-system (FIGS. 111A & 111B), consumes CO₂ and provides O₂ to the environmental control sub-system (FIG. 115). The food growing sub-system requires an initial batch of seeds for food growth before the system becomes self-sustaining. This sub-system also requires an initial water supply for setup. The food growing sub-system creates protein food for consumption in the form of aquaculture such as food in the form of vegetables, fruits, and nuts. The food growing sub-system is monitored and controlled by the automated monitoring and control sub-system (FIG. 116) and it consumes light from the environmental control sub-system (FIG. 115). The food growing sub-system also consumes power from the power generation sub-system (FIG. 113) and it may utilize pest control measures from the pest management sub-system (FIG. 13). This sub-system also produces organic waste that is consumed by the waste recycling sub-system (FIG. 112), consumes recycled nutrients from the waste recycling sub-system (FIGS. 111A & 111B); and it transfers heat via the environmental control sub-system (FIG. 115).

The organic waste recycling sub-system (FIG. 112) produces and consumes heat that is exchanged with the environmental control sub-system (FIG. 115); produces nutrients consumed by and consumes organic waste from the food growth sub-system (FIGS. 111A & 111B); as well as from sources external to the system; consumes power from the power generation sub-system (FIG. 113); produces biogas (a mixture of gases primarily composed of methane) for use by the power generation sub-system (FIG. 113); and is monitored and controlled by the automated monitoring and control sub-system (FIG. 116).

The power generation sub-system (FIG. 113): consumes biogas from the organic waste recycling sub-system (FIG. 112); provides power to the food growth sub-system (FIGS. 111A & 111B), the waste recycling sub-system (FIG. 112), the environmental control sub-system (FIG. 6), automated monitoring and control sub-system (FIG. 116), and the facilities and security sub-system (FIG. 117); it consumes solar energy and wind; it produces compressed natural gas (CNG) and excess electrical power for use outside the system; and is monitored and controlled by the automated monitoring and control sub-system (FIG. 116).

The pest management sub-system (FIG. 114) provides pest control to the food growth sub-system (FIGS. 111A & 111B) and is monitoring and controlled by the automated monitoring and control sub-system FIG. 116).

The environmental control sub-system (FIG. 115): manages heat for the food growth sub-system (FIGS. 111A & 111B), waste recycling sub-system (FIG. 112), and facilities and security sub-system FIG. 117). It may also control the input of CO₂ into the food growth sub-system (FIGS. 111A & 111B); the output of O₂ by the food growth sub-system (FIGS. 111A & 111B); controls the input of air from the air supply; is monitored and controlled by the automated monitoring and control sub-system (FIG. 116); produces potable water; controls the light input to the food growth sub-system (FIGS. 111A & 111B) as well as the natural input of light into the system; and consumes power from the power generation sub-system (FIG. 113).

The automated monitoring and control sub-system may monitor all other sub-systems: (FIGS. 111A & 111B through 117).

The facilities and security sub-system protects all sub-systems: (FIGS. 111A & 111B through 116).

The food growing sub-system (FIGS. 111A & 111B) may comprise various components, including but not limited to grow beds 01.01 to grow crops; aquaculture tanks 01.02 to grow various species of aquaculture; an aquaculture feed production component 01.03 to create food for the aquaculture species; an aquaculture breeding component 01.04 to enable the sustainable reproduction of the aquaculture species; aquaponic pumping component(s) 01.05 to move water between the tanks 01.02 and the beds 01.01; an aquaculture waste management component 01.06 to transport waste out of the tanks 01.02; a fresh water supply pump 01.07 for initial system startup; a germination component 01.08 to develop plant starts from seed; and a pollination component to support the pollination of plants in the system.

The organic waste recycling sub-system (FIG. 112), may comprise an anaerobic digester 02.01 which uses bacteria to decompose organic waste into liquid nutrients and bio-gas; a waste processing component 02.02 to pre-process materials going into the digester 02.01; a digestate pumping component 02.03 to move digestate from the digester to the food production sub-system (FIG. 2).

The power generation sub-system (FIG. 113), may comprise a methane power generation component 03.01 which converts bio-gas into electricity; a methane to vehicle fuel processing component 03.02 which compresses the bio-gas into a compressed form for use in vehicles converted to run on compressed natural gas (CNG); a solar power generation component 03.03 which converts solar radiation into electricity; a wind power generation component 03.04 which converts kinetic energy from wind into energy; a power conditioning, distribution and storage component 03.05 which ensures the appropriate voltage, frequency, distribution of electrical power throughout the system and also provides power backup in case primary power goes down; and a methane storage component 03.06 which processes, cleans, and stores bio-gas before it is utilized.

The Pest Management sub-system 04, may comprise fungus 04.01, insect 04.02, and mold 04.03 control mechanisms using organic and food safe methods.

The environmental control sub-system (FIG. 115), may comprise an air circulation and CO₂ introduction component 05.01 which prevents stagnant air, and provides CO₂ for plants; an aquaculture environmental control component 05.02 which heats and cools the aquaculture tanks 01.02; a cooling component 05.03 which cools the air and controls water temperature; a heating component 05.04 which heats the digester and the air; a light management component 05.05 which controls and provides the needed light for crop growth; a plant environmental control component which controls the timing of artificial lighting (optional) to supplement natural lighting for crop growth; and a water recapture and humidity control component 05.07 which captures evaporated water and converts it to potable water and recycles it back into the system.

The automated monitoring and control sub-system (FIG. 116) is based on artificial intelligent and machine learning architectures which support the various component monitoring and control needs of the components 06.01, 06.02, 06.03, 06.04, 06.05, 06.06, 06.07, and 06.08. In addition, a remote monitoring and control component 06.09 is integrated into the system such that an operator can remotely connect to the system and monitor and control it. In one embodiment, this may comprise software utilized as an app for smart device (e.g., iPhone or iPad).

The facilities and security sub-system (FIG. 117) is designed to support a scalable structure which this sub-system is responsible for: protecting the system (FIG. 110) including sub-systems (FIGS. 111A & 111B through 116) from moisture intrusion (rain, or ground-water), adjusting for sun seasonal position changes, maximizing the use of natural light, protecting the system from heat loss/gain, protecting the system from particulate loading (snow, dust, etc.), protects the system from wind, protects contents/occupants from radiation, protects from ground based pest and dirt/contamination, keeps the sub-systems and components of the system as clean as possible, and is easily deployable by four adults with no technical knowledge.

The system's integrated design allows it to minimize external inputs for initial system startup including: O₂, CO₂, air, plant seeds, water supply, external waste, solar radiation, and wind. Due to the photosynthesis of plants in the growing sub-system, (FIGS. 111A & 111B), the system can consume more CO₂ than it produces. It can also produce O₂. It can also produce food or nutrients for human consumption.

The system's integrated growing sub-system, (FIGS. 111A & 111B), utilizes aquaponics to grow protein in the form of aquaculture, and fresh fruits, vegetables and nuts. This method of growing utilizes 90% less water than traditional agriculture and increases the output of the area used to grow by a minimum of a factor of two.

The organic waste recycling sub-system (FIG. 112), combined with the food growth sub-system (FIGS. 111A & 111B), and environmental control sub-system (FIG. 115), create a bioregenerative effect when the facility and security sub-system (FIG. 117), is scaled to include human habitat. Humans exhale CO₂ which creates an input for the system (FIG. 110), (negating the need for external CO₂ input) and consume oxygen which is generated by the food growth sub-system (FIGS. 111A & 111B). Therefore in a system utilized to sustain human occupation, it will be appreciated that the system should generate approximately 170% of needed O₂ for human occupants and consume approximately 275% of the CO₂ produced by the human occupants. Combined with the waste recycling sub-system (FIG. 112), the system can effectively recycle all organic waste (including human waste if utilizing the optional Human Waste Processing component 02.04) turning organic waste into reusable nutrients and energy. Reference is made to the presentation of Wheeler, R. M. (NASA) entitled “Development of Bioregenerative Life Support for Longer Missions: When can Plants Begin to Contribute to Atmospheric Management, 2015.

The organic waste recycling sub-system (FIG. 112), not only supports the recycling of waste in the system but can also consume waste from outside the system. Due to the implementation of the anaerobic digestion process/component within this sub-system, the use of the organic waste recycling sub-system (FIG. 112), will produce the nutrients needed as an input to the growing sub-system (FIGS. 111A & 111B), as well as produce Bio-Gas (a mixture of gases, primarily methane) which can be burned to produce heat and electricity, as well as be compressed to supply compressed natural (bio) gas (CNG) for use outside of the system.

Utilizing its power generation sub-system (FIG. 113), the system can produce sustainable power from solar, wind, and recycled organic waste to sustain the various components of the sub-systems and any excess energy not used by the system can be transported out of the system for external uses.

The integrated pest management sub-system (FIG. 114), utilizes organic, non-polluting pesticides, herbicides, and micro-nutrients to ensure food security and health.

As designed, the system (FIG. 110) is modular, and can be scaled to deploy in any size structure capable of holding the system components shown in FIGS. 111A through 118 to support the quantity of adults the operator specifies. In one embodiment, support of four adults may be the basic system capacity. This capacity is scalable.

The various system sub-systems (FIGS. 111A through 118) can all be reconfigured and scaled to support various structural sizing requirements (ex. inside of a urban warehouse, into a shipping container, a self-standing and purpose built structure, series of modular/scalable units each “self sufficient” or independently operable, etc).

Given the design for scalability considerations in the system, the various sub-systems: (FIGS. 111A through 118) are all scalable to support various output modifications (e.g., commercial production of fruits, vegetables, nuts, and aquaculture).

In a preferred embodiment, the animal species utilized may be aquaculture. A single aquaculture species may be utilized depending upon the operating conditions, e.g., water temperature, pH or food source. In other embodiments, multiple aquaculture species may be utilized dependent upon diet, food consumption, breeding characteristics, waste production and food harvesting production.

The aquaculture may be grown in one or more aquaculture tanks (hereinafter “tanks”). The tank dimensions may be in part determined by the characteristics of the aquaculture specie(s) selected.

The tank may also be used for growing aquatic plants that may be consumed by the aquaculture. One example is duck weed, either Lemna mino, an algae like growth that floats on the water surface or Potamogeton pectinatus, a water borne submerged plant. (Potamogeton pectinatus has filamentous leaves and hard bony fruit relished by ducks.)

In an embodiment, water may circulate between the aquaculture tank 01.02 and a separate tank 01.01 (growth tank) utilized for the hydroponic growing of plants.

The aquaculture produce organic waste. The waste may be pumped 01.05 in the water stream to mineralization tank 01.06 (aquaculture waste management component) for decomposition and transformation into plant nutrients. This water stream, now containing plant nutrients, continues to an inlet into the hydroponic plant growth tank, i.e., food growing sub-system. The water circulates at a controllable rate through the plant roots. As specified elsewhere, the plant roots may be supported by inert material such as perlite.

The water of the aquaculture tank will also contain Ammonia exhaled by aquaculture. This Ammonia laden water will be conveyed to the plant roots within the hydroponic tank 01.01 where bacteria will break the Ammonia down into Nitrites and Nitrates, of which the plants will consume. The plants will be exposed to light containing radiation of suitable wave lengths to allow photosynthesis, thereby producing O₂.

The water of the hydroponic tank, now containing decreased concentration of Ammonia and increased concentrations of 02 will be returned to the aquaculture tank 01.02. It will be appreciated that the high concentration of dissolved 02 will support aquaculture respiration.

In addition to the system described in FIGS. 1 through 109 above, the Applicant has built and operated an embodiment of this system in an 80 ft long x 40 ft wide x 22 ft tall structure. All aspects of this submission were demonstrated. This system is described in FIGS. 110 through 117 discussed below. This system has been operated for over 18 months generating $13,000 in plant food sales at 20% capacity. At maximum capacity this system could provide calories for 16 people per day.

Examples of food grown include multiple varieties of lettuce, peppers, beans, broccoli, cauliflower, green onions, carrots, garlic, Kiwi, cantaloupe, watermelons, strawberries, Walla Walla sweet onions, potatoes, corn, and various herbs.

In one embodiment of the disclosure, 4 tanks were utilized for aquaculture production comprising the total capacity of 160 gallons (1200 cu ft/7.48 cu ft) and each tank having dimensions of 3 ft. depth, 2 ft. width, and 50 ft length was coupled with 18 grow bed utilized for hydroponics comprising a total capacity of 115 gallons, (864 cu. ft./7.48 cu. ft.) each being 1 ft. depth, 4 ft. width and 12 ft. length. Necessary piping was utilized to allow water circulation between the two tanks. Pumps were utilized to produce a circulating water flow of 1000 gallons per hour (gph) for each aquaculture tank. Water temperature was maintained at approximately 60° F.

In this disclosed embodiment, the animal source was aquaculture (rainbow trout). The plant grown in the hydroponic tank were lettuce, cauliflower, broccoli, potatoes, corn, basil, sage, green onions, garlic, watermelon, cantaloupe, bananas, grapefruit, kiwi and kale.

Water circulated between the aquaculture and hydroponic tanks. Waste was accumulated in an anaerobic digester having a volume of 353.15 ft³. The digester temperature range was between 70° F. to 98°. The waste was composted and transformed into nutrients. The nutrients were introduced into the water stream and circulated into the hydroponic tank. Temperature of the digester was also monitored in combination with temperature sensors, controller and at least a heating element. Reference is made to FIG. 112.

The waste digester had a capacity of approximately 353.15 ft³.

Additionally, the pH of the water was also maintained within a determined range of 7 and 8 pH.

It will be appreciated that some or all of the power required to operate the system may be generated utilizing wind or solar power. Such power sources may be appropriately sized for the power requirements of the tank pump(s), digester, heaters, lights, etc. Power may be stored in batteries. Power may also be furnished from methane gas (CH₄) produced from the operation of the waste digester described above. Reference is made to FIG. 113.

It will also be appreciated that the ambient air temperature and humidity for the plants must also be monitored and controlled. Ambient air temperature was maintained within a range of 66° F. and 89° F. Humidity was maintained in a range of 50 and 80 percent. It will be appreciated that these parameters may vary with the type of plants grown.

Air circulation is also important to plant growth and pollination. Air circulation is also monitored and controlled. In the system subject of this disclosure, fans were utilized in an enclosure of approximately 70,400 cubic feet. The air circulation system was 23,000 CFM.

The aquaculture tank can be located within an enclosure separate from the hydroponic tank, provided water circulation is maintained.

The waste from the aquaculture tank can be combined with waste from other sources. In one example, plant waste created from the plant harvesting process, e.g., leaves or stalks, may be composted.

The animals of the aquaculture tank can be periodically harvested. Increase in the quantity of the monitored aquaculture waste maybe used to determine if the quantity of mature aquaculture will allow controlled harvesting.

The disclosure teaches that a combination of aquaculture (or land based animal husbandry) with hydroponic agriculture may be used in a self-sustaining equilibrium. It will be appreciated that the composition of waste may varying with the animal species. Also the nutrient demands per sq. ft. may vary with the plant species. The nutrient demands of the animal/waste producers will also vary with species.

The illustrated above, the system of the disclosure may be sized or dimensioned to produce the necessary power to operate the system components as well as a number of human dependents.

The system is scalable such that the various sub-system components may be increased in size to support larger numbers of human dependents. This support may be food and power (electricity and fuel) needs from the system.

In one embodiment, the ratio of Grow Area Power (lighting) needed (in KwHr) to the grow area needed (ft²) is governed by the equation P_{R}=0.4172 where P_{R} is the ratio of power needed to grow area needed. This value is also impacted by the mixture of fruits, vegetables, and proteins in the system and as such the standard deviation from this value is governed by the equation S_{d}=0.0703 where S_{d} is the standard deviation.

This disclosure also teaches the interrelationship of the area or size of the animal component and the plant growth component. In one embodiment, the volume of the aquaculture tank needed (ft³) is governed by the equation V=541.13x where x equals the number of adults the system is required to support and V is the volume of the aquaculture tanks needed.

The volume of the Grow Area needed (ft³) is governed by the equation V_{go}=1976.7x where x equals the number of adults the system is required to support and V_{go} is the grow area needed. This value is also impacted by the mixture of fruits, vegetables, and proteins in the system due to the fact that each fruit, vegetable, and protein has varying row area spacing, maturation times (which impact total area needed to harvest desired quantities per day) and nutrient requirements and as such the standard deviation from this value is governed by the equation S_{d}=5740.6x where x is the quantity of adults and S_{d} is the standard deviation.

It should be noted that the volume of the aquaculture tank is a function of aquaculture health, more than a relationship to total grow area. Total depth is variable based on the species and mature size of the aquaculture species chosen.

The ratio between aquaculture and grow area volume (ft³) is governed by the equation Vᵣ=0.3059 where Vᵣ is the ratio between aquaculture and grow area volumes. This value is also impacted by the mixture of fruits, vegetables, and proteins in the system and as such the standard deviation of the ratio of aquaculture and grow area from this value is 0.1132.

The ratio between aquaculture tank surface area (ft²) and grow container surface area (ft²) is governed by the equation Aᵣ=0.42 where Aᵣ is the ratio aquaculture tank surface area and grow container surface area. This value is also impacted by the mixture of fruits, vegetables, and proteins in the system and as such the standard deviation from this value is 0.078. The absolute size of the aquaculture and grow area tanks is varied based on the number of humans that may depend upon the system for O₂, food and water, as well as the variety (species and quantity) of vegetables, fruits, and proteins sources chosen.

In an embodiment, the system may recycle organic waste generated by the system and organic waste from outsidethe system, including dependent humans, back into the system (waste negative).

In one embodiment of the disclosure, an aquaculture tank utilized for aquaculture production comprising the capacity of 1296 ft³ and having dimensions of 3 ft depth, 2 ft width, and 12 ft length can be coupled with a tank utilized for hydroponics (volume of grow area) comprising a capacity of 864 ft³, 1.8 ft depth, 4 ft width and 12 ft length. It should be appreciated that the size relationship (surface area) of the total aquaculture tank surface area to the total surface area of the hydroponic tanks (actual value of the embodiment was 0.5) was in line with the sizing equations ratio (0.38 min, 0.50 max) range stated above (Aᵣ). Necessary piping is utilized to allow water circulation between the aquaculture and hydroponic tank (grow area) systems. Pumps are utilized to produce a circulating water flow rate throughout the system (ft³/hr) governed by the equation Wfr=541.13x where x equals the quantity of adults the system is required to support and W is the water flow rate.

In this disclosed embodiment, the animal source of waste (converted to nutrients) was aquaculture. In the embodiment, the species of aquaculture was Rainbow Trout. The source of nutrients for the aquaculture was organic aquaculture food with appropriate micronutrients to enable system operations. The plants that were grown in the hydroponic tanks were: lettuce, kale, kiwi, strawberry, bush beans, garlic, watermelon, cantaloupe, potatoes, lavender, basil, thyme, sage, parsley, chives, dill, chamomile, cilantro, broccoli, cauliflower, green onions, carrots, sweet onions, beets, and corn.

Water circulated between the aquaculture and hydroponic tanks. Waste may be accumulated in an anaerobic digester. The waste is anaerobically decomposed by micro-bacteria and transformed into nutrients. Anaerobic digestion is a natural process by which various types of microorganisms (bacteria) break down organic matter into a nutrient rich liquid called digestate and methane gas. The digestor may utilize Mesophilic digestion. Mesophilic digestion is defined as digestion taking place by Mesophile Bacterial organisms, these organisms are defined as organisms that live in the temperature range of 95° F.−104° F. (35-40° C.). The nutrients are introduced into the water stream and circulated into the hydroponic tank. Temperature of the digester may also be monitored in combination with temperature sensors, controller and at least a heating element. Digester temperature is maintained within a range of 95° F. to 104° F.

The waste digester had a capacity of approximately 353.15 ft³. Mesophilic digestion requires solids to be in the system between 30 and 60 days to completely break down. The system utilizes a continuous loading anaerobic digester. From this instantiation, the relationship of adults to digester volume needed (ft³) is governed by the equation y=116.98x+22.67 where x equals the number of adults the system is required to support, and y is the volume of the digester needed. This value is also impacted by the mixture of fruits, vegetables, and proteins in the system and as such the standard deviation (S_{d}) from this value is governed by the equation S_{d}=59.013x−35.17 where x is the quantity of adults.

The system also comprises water temperature sensors. The sensors are in communication with a control device such as a CPU. The CPU could activate either one or more water heaters or chillers as necessary to maintain a constant temperature range. Temperature range for the system is defined by the types of plants being grown. This value varies between 60° F. and up to 90° F. depending on plant species. The high and low value temperatures are also set by the species of aquaculture chosen. Some aquaculture can sustain temperatures at the low end of the range (60° F.) whereas others would die at this same temperature. In the disclosed embodiment, 70° F. average temperature was maintained which allows for the growth of a majority of the popular food plant species.

Additionally, the pH level required in the system is directly dependent upon the species of aquaculture, the water temperature, and the variety of plants required however the nominal range will exist between 5.8 and 6.3 on the pH scale. This subsystem again utilized sensors in communication with a control component. The subsystem control could control the addition of acid or alkaline buffer material into the water.

Water level in each tank was also monitored and controlled in combination with water level components and water inflow and outflow components/valves.

The equilibrium system of this disclosure requires that the total power needed to operate the system (kWhr) per day be governed by the equation Pₜₜᵢ=293.85x+1.15 where x equals the quantity of adults the system is required to support and Pₜₜᵢ is the power needed to operate the system. This value is also impacted by the mixture of fruits, vegetables, and proteins in the system and as such the standard deviation from this value is governed by the equation S_{d}=830.11x−0.95 where x is the quantity of adults and S_{d} is the standard deviation of the total power requirement.

The voltage and amperes demands of the system were also monitored by sensors. The sensors were in communication with a controller and the power output of the power supply was appropriately adjusted. It will be appreciated that some or all of this power may be generated utilizing wind or solar power. Such power sources may be appropriately sized for the power requirements of the tank pump(s), digester, heaters, lights, etc. Power may be stored in batteries. Power may also be furnished from methane gas (CH₄) produced from the operation of the waste digester described above. Reference is made to FIG. 113.

The system may also utilize sensors to detect the presence of such fungus, mold and pests that may harm the health of the nutrient source, e.g., aquaculture, or plants. The Genesis system utilizes visual detection of fungus, mold, and plant disease and overall health/maturity. This visual detection is enabled by utilizing a trained artificial intelligence which uses image comparison against known issues to identify plant health. Reference is made to FIG. 114.

It will also be appreciated that the ambient air temperature and humidity for the plants must also be monitored and controlled. In the system subject of this disclosure air temperature was maintained in a range of 65° F. to 80° F. Humidity was maintained in a range of 50-60 percent. It will be appreciated that these parameters may vary with the type of plants grown.

Air circulation is also important to plant growth and pollination. Air circulation is also monitored and controlled. In the system subject of this disclosure, horizontal airflow, created by fans, in the system is based on total ground area using the equation (total ground area)×(2 ft³/min)=fan cfm (cubic feet per minute). The air circulation system may utilize air intakes and exhaust.

The water entering the plant growth system (hydroponic tank) was monitored for a variety of substances, including temperature, pH, dissolved CO₂ and O₂ concentrations, water flow rate, nutrient concentration, dissolved nitrites, nitrates, calcium, magnesium, phosphate, and ammonia. Suggested concentrations are:

| | | Common range | |
|---|---|---|---|
| Element | Nutrient | (ppm = mg/l) | |
| Nitrogen | Nitrate (NO3−), | 100-250 | ppm |
| | Ammonium (NH4+) | | |
| Phosphorus | Dihydrogen phosphate (H2PO4−) | 30-50 | ppm |
| | Phosphate (PO43−) | | |
| | Monohydrogen phosphate (HPO42−) | | |
| Potassium | Potassium (K+) | 100-300 | ppm |
| Calcium | Calcium (Ca2+) | 80-140 | ppm |
| Magnesium | Magnesium (Mg2+) | 30-70 | ppm |
| Sulfur | Sulfate (SO42−) | 50-120 | ppm |
| Iron | Ferrous ion (Fe2+) | 1-5 | ppm |
| | Ferric ion (Fe3+) | | |
| Copper | Copper (Cu2+) | 0.04-0.2 | ppm |
| Manganese | Manganese (Mn2+) | 0.5-1.0 | ppm |
| Zinc | Zinc (Zn2+) | 0.3-0.6 | ppm |
| Molybdenum | Molybdate (MoO42−) | 0.04-0.08 | ppm |
| Boron | Boric acid (H3BO3) | 0.2-0.5 | ppm |
| | Borate (H2BO3−) | | |
| Chloride | Chloride (Cl−) | <75 | ppm |

| | | |
|---|---|---|
| Sodium | Sodium (Na+) | <50 ppm TOXIC |
| | | to plants |

Plant types are based on the human diet required. The key relationship in selecting plants that must be adhered to is the temperature required of the plants . . . this sets the temperature of the aquaculture tanks, for rainbow trout this range was 45° F.-70° F. The pH level required in the system is directly dependent upon the species of aquaculture, the water temperature, and the variety of plants required however the nominal range will exist between 5.8 and 6.3 on the pH scale. The aquaculture tank can be located within an enclosure separate from the hydroponic tank, provided water circulation is maintained.

The waste from the aquaculture tank can be combined with waste from other sources. In one example, plant waste created from the plant harvesting process, e.g., leaves or stalks, may be composted.

The animals of the aquaculture tank can be periodically harvested. Increase in the quantity of the monitored aquaculture waste maybe used to determine if the quantity of mature aquaculture will allow controlled harvesting.

The disclosure teaches that a combination of aquaculture (or land based animal husbandry) with hydroponic agriculture may be used in a self-sustaining equilibrium. Total input of organic waste needed is dependent on wastes composition and specifically the amount of proteins and carbohydrates remaining in the waste material. The total weight of digester material needed to operate the system (Ib) per day is governed by the equation Wtmaₜ=24.37x+4.72 where x equals the quantity of adults the system is required to support and Wtmoₜ is the weight of the material needed. This value is also impacted by the mixture of fruits, vegetables, and proteins in the system and as such the standard deviation from this value is governed by the equation S_{d}=12.29x-7.33 where x is the quantity of adults and S_{d} is the standard deviation of the weight of material. It will be appreciated that the composition of waste may varying with the animal species. Also, the nutrient demands per ft². may vary with the plant species. The nutrient demands of the animal/waste producers will also vary with species.

It is suggested that aquaculture waste can be utilized to meet all input requirements of the digester once the quantity of aquaculture (measured by fish waste weight in pounds per day) is sufficient to do so. This equilibrium point is governed by the equation Wtₐ=0.1173 where Wtₐ is the quantity of aquaculture waste pounds per day. It can be appreciated that the total quantity of aquaculture in the system to produce the needed waste, establishing equilibrium, is variable dependent upon fish type, size, and maturity.

The applicant has prepared the following table as a guide for sizing the components of the disclosure.

| | Digester | Grow Tank | Grow | Aquaculture | Aquaculture |
|---|---|---|---|---|---|
| Qty of | Volume | Volume | Tank Area | tank volume | Tank Area |
| Adults | (ft\hat{ }3) | (ft\hat{ }3) | (ft\hat{ }2) | (ft\hat{ }3) | (ft\hat{ }2) |
| 2 | 257 ± 83 | 3953 ± 1149 | 1358 ± 303 | 1082 ± 150 | 541 ± 75 |
| 4 | 491 ± 201 | 7906 ± 2298 | 2717 ± 606 | 2165 ± 300 | 1082 ± 150 |
| 16 | 1894 ± 909 | 31627 ± 9194 | 10867 ± 2422 | 8658 ± 600 | 4329 ± 600 |
| 32 | 3766 ± 1853 | 63254 ± 18387 | 21733 ± 4844 | 17316 ± 1200 | 8658 ± 1200 |
| 64 | 7509 ± 3742 | 126509 ± 36774 | 46466 ± 9688 | 34632 ± 2400 | 17316 ± 2400 |

In an additional embodiment of this disclosure, the disclosure also includes utilization of dual pods, accessed by two vestibules (interconnection between pods and an access port). The dual pod system has an approximate 630 sq. ft. footprint and approximately 950 sq. ft of grow area. The system is configured to grow approximately 1 pound of produce per 1 sq. ft. The pod components utilize the system (described above) and may provide at least the majority of required power, and achieves substantial waste recycling. The dual pod system may be dimensioned to supply 4,400 calories for two adults (2,200 calories per adult per day). This produce may be consumed or sold commercially. The system allows crop diversity and an aquaculture protein food source. The system is designed to grow food sources without herbicides or pesticides. The system is expandable and scalable.

The dual pod system is also configured to generate electrical power utilizing solar and wind power. It may also utilize biogas from waste recycling. It also may harvest water from ambient air (estimated 4 gallons per day) and provides up to 3000 gallons of fresh water storage.

This specification is to be construed as illustrative only and is for the purpose of teaching those skilled in the art the manner of carrying out the disclosure. It is to be understood that the forms of the disclosure herein shown and described are to be taken as the presently preferred embodiments. As already stated, various changes may be made in the shape, size and arrangement of components or adjustments made in the steps of the method without departing from the scope of this disclosure. For example, equivalent elements may be substituted for those illustrated and described herein and certain features of the disclosure maybe utilized independently of the use of other features, all as would be apparent to one skilled in the art after having the benefit of this description of the disclosure.

While specific embodiments have been illustrated and described, numerous modifications are possible without departing from the spirit of the disclosure, and the scope of protection is only limited by the scope of the accompanying claims.

1-20. (canceled)

21. A self-contained system having at least one enclosure for growing food and generating energy comprising:
(a) one or more enclosures;
(b) at least one first tank within the enclosure structured for hydroponic growth of plants;
(c) at least one second tank within the enclosure structured for growth of aquatic animals and containing reproducing plant or algae;
(d) an anerobic digester structured to transform organic waste by-products collected from the second tank into nutrients that can be conveyed to the first tank;
(e) a piping and pump component structured to convey and circulate water among the second tank, the digester, and the first tank;
(f) one or more aquatic animals within the second tank wherein the animals produce a sufficient quantity of animal waste that can be transformed into a sufficient quantity of water conveyable nutrients to allow plant growth within the first tank;
(g) a quantity of plants in the first tank to cleanse the water of nitrogen and ammonia to be convey to the second tank; and
(h) wherein the quantity of nutrients a produced by the animals of the second tank to grow the plants of the first tank is in equilibrium of the nitrogen needed by the plants of the first tank.

22. The self-contained system of claim 21 further comprising:
(a) sensors in the first and second tank to monitor and control the water levels in each tank and components and valves to allow addition or removal of water from each tank;
(b) sensors and components to measure and control the temperature of the water; and
(c) sensors and components to measure and control the quantity of dissolved oxygen within the water.

23. The self-contained system of claim 22 further comprising sensors and components to measure and control the humidity, temperature, and quantity of oxygen and carbon dioxide of the ambient air within the enclosure.

24. The self-contained system of claim 21 further comprising a structure to collect and store methane gas produced by the anerobic transformation of organic waste by-products into nutrients.

25. The self-contained system of claim 21 wherein the plants of the first tank produce sufficient dissolved oxygen to support the aquatic animals of the second tank.

26. The self-contained system of claim 21 further comprising components to detect the presence of pests wherein components are comprised of a visual monitoring sensor (e.g. video camera) and an Artificial Intelligence that is trained in pest detection.

27. The self-contained system of claim 21 further comprising a sensor and control component to monitor and control the pH of the water.

28. The self-contained system of claim 21 further comprising one or more sensors to monitor the water concentration of at least one substance selected from a group comprising nitrogen, phosphorus, potassium, calcium, magnesium, sulfur, iron, copper, manganese, zinc, molybdenum, boron chloride, and sodium.

29. The self-contained system of claim 28 further comprising one or more control components to control the water concentration of at least one substance selected from a group comprising nitrogen, phosphorus, potassium, calcium, magnesium, sulfur, iron, copper, manganese, zinc, molybdenum, boron chloride, and sodium.

30. The self-contained system of claim 21 further comprising an electrical power supply structured to utilize electrical power generated by at least one of the group comprising solar generated electricity, wind turbine generated electricity, or biogas generated electricity.

31. The self-contained system of claim 30 further comprising one or more batteries for the storage of solar or wind turbine generated electrical power.

32. The self-contained system of claim 21 wherein the digester can receive and process human waste.

33. The self-contained system of claim 32 further comprising a component of the digester for the heating of water.

34. A self-contained food producing equilibrium system comprising: one or more enclosures containing a plurality of water tanks and an anerobic waste digestor wherein water circulates among the tanks and digestor; at least one tank contains living aquatic animals and at least one other tank contains growing plants; the digestor receives organic waste and processes the waste to create nutrients for growing plants also conveyed to the plants via the circulating water; the quantity of waste from the aquatic animals processed into nutrients is sufficient to support a quantity of plants that produce oxygen dissolved into the water sufficient to support the aquatic animals; the plants further cleanse the water of nitrogen and ammonia conveyed to the aquatic animals; and the quantity of nutrients produced by the aquatic animals is in equilibrium with the nitrogen needed by the plants.

35. The self-contained food producing equilibrium system of claim 24 further comprising
(a) at least one first tank structured for hydroponic growth of plants; and
(b) at least one second tank structured for growth of aquatic animals and containing reproducing plant or algae as nutrients for the aquatic animals.

36. The self-contained system of claim 24 further comprising:
(a) sensors in the first and second tank to monitor and control the water levels in each tank and components and valves to allow addition or removal of water from each tank;
(b) sensors and components to measure and control the temperature of the water; and
(c) sensors and components to measure and control the quantity of dissolved oxygen and carbon dioxide within the water.

37. The self-contained system of claim 24 further comprising sensors and components to measure and control the humidity, temperature, and quantity of oxygen and carbon dioxide of the ambient air within the enclosure.

38. The self-contained system of claim 24 further comprising a structure to collect and store methane gas produced by the anerobic transformation of animal waste by-products into nutrients.

39. A method to grow food comprising:
(a) growing plants in a first tank using hydro or aeroponic techniques;
(b) growing aquatic animals in a second tank;
(c) circulating water from the first tank wherein the roots of the plants are within the water through to the second tank wherein the circulating water contains the living aquatic animals;
(d) conveying dissolved oxygen contained within the circulating water conveyed to the second tank wherein the dissolved oxygen is at least partially consumed by the aquatic animals;
(e) further circulating the water from the second tank and wherein the water now contains dissolved carbon dioxide and waste from the aquatic animals through an anerobic digester;
(f) the plants further cleansing the water of nitrogen and ammonia conveyed to the aquatic animals;
(g) maintaining an equilibrium of the quantity of nutrients produced by the aquatic animals with the nitrogen needed by the plants; and
(h) converting the waste in the digester to a dissolved nutrient suitable for the plants within the first tank.

40. The method of claim 39 further comprising generating methane gas from the conversion of waste in the digester.

41. The self-contained system of claim 21 further comprising a structured capacity of oxygen generation and carbon dioxide absorption to support at least one additional living invertebrate.

42. The self-contained system of claim 41 wherein the invertebrate is human.
